(19) United States
(12) Patent Application Publication
(10) Pub. No.: US 2011/0145345 A1
(43) Pub. Date: Jun. 16, 2011

(54) METHODS, SYSTEMS,AND COMPUTER PROGRAM PRODUCTS FOR RETRIEVING A FILE OF MACHINE READABLE DATA

(76) Inventor: John Anthony Wysham, Vienna, VA (US)

(21) Appl. No.: 12/867,825

(22) PCT Filed: Feb. 23, 2009
(86) PCT No.: PCT/US2009/001129

§ 371 Date: Aug. 16, 2010

Related U.S. Application Data
(60) Provisional application No. 61/064,236, filed on Feb. 22, 2008.
(60) Provisional application No. 61/032,587, filed on Feb. 29, 2008.
(60) Provisional application No. 61/045,271, filed on Apr. 15, 2008.
(60) Provisional application No. 61/091,347, filed on Aug. 23, 2008.
(60) Provisional application No. 61/147,122, filed on Jan. 25, 2009.

(51) Int. Cl. G06F 15/16

(52) U.S. Cl. 709/206

(57) ABSTRACT

A user, wishing to retrieve a file of machine-readable data from a remote machine-readable data storage device, transmits a first e-mail message from a local station to a remote station via a packet switched network. The first e-mail message includes a first machine-readable instruction and a first machine-readable retrieval criterion. The remote station receives the first email message from the packet switched network. The remote station parses the first e-mail message to determine if it includes the first machine-readable instruction and the first machine-readable retrieval criterion. The remote station executes the first machine-readable instruction to transmit a second e-mail message from the remote station to the local station. The second e-mail message includes the file as an attachment. The local station receives the second e-mail message from the packet switched network.

### COPYRIGHT NOTICE

A portion of the disclosure of this patent application contains material (code listings) to which the claim of copyright protection is made. The copyright owner has no objection to the facsimile reproduction by any person of the patent application or its disclosure, as it appears in the files or records of patent offices in which this patent application is filed, but reserves all other rights whatsoever. © 2009 John Anthony Wysham.

### BACKGROUND OF THE INVENTION

1. Field of the Invention

Embodiments of the present invention relate to methods, systems, and computer program products for retrieving a file of machine-readable data.

2. Related Art

As more and more information has come to be organized in files stored in machine-readable data storage devices, technology has evolved to provide greater means of access to such files. Of particular concern is the situation in which a user at a local station wishes to access a file stored in a remote machine-readable data storage device. In response to this concern, services such as GoToMyPC®, Virtual Network Computing, BeAnywhere™, PcAnywhere™, LogMeIn™, WallCooler VPN, I'm InTouch™, eBLVD®, BeamYourScreen, PCMobilizr, Netviewer, and WebEx™ have been developed. However, these services are characterized by a need to establish a continuous connection, often for a relatively long period of time, between an electronic processor at the local station and an electronic processor associated with the remote machine-readable data storage device. Such a connection can be difficult to maintain, often can be costly, and runs the risk that intruders can access the file at a local or the remote machine-readable data storage device during the time of the connection. What are needed are methods, systems, and computer program products for accessing a file of machine-readable data in which the connection between the electronic processor at the local station and the electronic processor associated with the remote machine-readable data storage device is established for a relatively short period of time and that can automatically restore the connection if an interruption occurs.

### SUMMARY OF THE INVENTION

In an embodiment, the present invention comprises methods, systems, and computer program products for storing and retrieving a file of machine-readable data and for editing file identifying information. A user, wishing to retrieve a file of machine-readable data from a remote machine-readable data storage device, transmits a first e-mail message from a local station to a remote station via a packet switched network. The first e-mail message includes a first machine-readable instruction and a first machine-readable retrieval criterion. The remote station receives the first e-mail message from the packet switched network. The remote station parses the first e-mail message to determine if it includes, in the header or the body of the first e-mail message or as an attachment of the first e-mail message, the first machine-readable instruction and the first machine-readable retrieval criterion. The remote station executes the first machine-readable instruction to transmit a second e-mail message from the remote station to the local station. The second e-mail message includes the file as an attachment. The local station receives the second e-mail message from the packet switched network.

In an embodiment, the present invention recognizes that the user may, in order to retrieve the file from the remote machine-readable data storage device, need to retrieve information that will assist the user in identifying the file. For example, the user may not recall the name of the file, but recall that it is associated with a certain category. In this embodiment, the user begins by transmitting a third e-mail message from the local station to the remote station via the packet switched network. The third e-mail message includes a second machine-readable instruction and a second machine-readable retrieval criterion. The remote station receives the third e-mail message from the packet switched network. The remote station parses the third e-mail message to determine if it includes, in the header or the body of the third e-mail message or as an attachment of the third e-mail message, the second machine-readable instruction and the second machine-readable retrieval criterion. The remote station executes the second machine-readable instruction to transmit a fourth e-mail message from the remote station to the local station. The fourth e-mail message includes, in the header or the body of the fourth e-mail message or as an attachment of the fourth e-mail message, file identifying information. The file identifying information includes machine-readable data representative of a category associated with the file, a type of the file, a classification of the file, a size of the file, a date of an edit made to the file, an indication of a time when the file is to be retrieved, an identity of an individual who is to receive the file, other retrieval criteria, or any combination of the foregoing. The local station receives the fourth e-mail message from the packet switched network. Accessing the file identifying information, the user can identify the file for retrieval and can transmit the first e-mail message as described above.

Additional features and advantages of the present invention, as well as the structure and operation of various embodiments of the present invention, are described in detail below with reference to the accompanying drawings.

### BRIEF DESCRIPTION OF THE FIGURES

The accompanying drawings, which are incorporated herein and form part of the specification, illustrate the present invention and, together with the description, further serve to explain the principles of the invention and to enable a person skilled in the pertinent art to make and use the invention.

FIG. 1 depicts an overview of various embodiments of the invention.

FIG. 2 illustrates, in greater detail, the relationship between the Item table 202, the Classification table 118, and a data item 112 located in a storage 114.

FIG. 3 is a flow chart depicting various embodiments of the invention for characterizing a data item and manipulating the data item through its Characterization.

FIG. 4 illustrates an embodiment showing a screen shot of an Item table.

FIG. 5 illustrates an embodiment showing a screen shot of a classification table.

FIG. 6 illustrates an embodiment showing a screen shot of a resulting recordset.

FIG. 7 illustrates an embodiment showing a screen shot of a drop down menu showing various criteria available within a classification table.

FIG. 8 illustrates an embodiment showing a screen shot of the Getfile form when it is empty, before the Getfile logic is activated.

FIG. 9 illustrates an embodiment showing a screen shot of a Getfile form.

FIG. 10 illustrates an embodiment showing a screen shot of the result of multiple data items being selected and the appropriate associated viewing application being opened for each data item and displaying each data item sequentially on the computer system.

FIG. 11 illustrates an example of an Item table.

FIG. 12 illustrates an example of a Classification table.

FIG. 13 illustrates an example of a resulting recordset when a select query is run against the Item table using criteria drawn from the Classification table.

FIG. 14 illustrates an example of one of the dropdown boxes open, showing various criteria available.

FIG. 15 illustrates an example of a resulting Classification table with a classification, A/Airlines/United, removed.

FIG. 16 illustrates an example of a GetFiles form.

FIG. 17 illustrates a screen shot of an example of a table including a shellset.

FIG. 18 illustrates a screen shot of an example of a filter table.

FIG. 19 illustrates an example of a Filter form.

FIG. 20 illustrates an example of a Master form.

FIG. 21 illustrates an embodiment of a system 2100 for retrieving a file from a remote machine-readable data storage device.

FIG. 22 illustrates a flow chart of an embodiment of a method 2200 for retrieving a file from a remote machine-readable data storage device.

FIG. 23 illustrates a flow chart of an embodiment of a method 2300 for retrieving a file from a remote machine-readable data storage device.

FIG. 24 illustrates a flow chart of an embodiment of a method 2400 for retrieving file identifying information.

FIG. 25 illustrates a flow chart of an embodiment of a method 2500 for producing the file identifying information.

FIG. 26 illustrates a flow chart of an embodiment of a method 2600 for parsing a field of the first table.

FIG. 27 illustrates a flow chart of an embodiment of a method 2700 for retrieving a file from a remote machine-readable data storage device.

FIG. 28 illustrates a flow chart of an embodiment of a method 2800 for retrieving file identifying information.

FIG. 29 is a block diagram of an example computer system 2900 that can support an embodiment of the present invention.

The features and advantages of the present invention will become more apparent from the detailed description set forth below when taken in conjunction with the drawings.

### DETAILED DESCRIPTION OF THE PREFERRED EMBODIMENTS

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the present invention can be of significant utility.

Various aspects of the illustrative embodiments are described using terms commonly employed by those skilled in the art to convey the substance of their work to others skilled in the art. However, it will be apparent to those skilled in the art that alternate embodiments may be practiced with only some of the described aspects. For purposes of explanation specific numbers, materials, and configurations are set forth in order to provide a thorough understanding of the illustrative embodiments. However it will be apparent to one skilled in the art that alternate embodiments may be practiced without the specific details. In other examples, well-known features are omitted or simplified in order not to obscure the illustrative embodiments.

Further, various operations are described as multiple discrete operations, in turn, in a manner that is most helpful in understanding the illustrative embodiments; however the order of description should not be construed as to imply that these operations are necessarily order dependent. In particular, these operations need not be performed in the order of presentation. This is particularly true of whether a first e-mail message is sent first or a third e-mail message is sent first, as described above.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

### Data Item Retrieval Method and Apparatus I

Illustrative embodiments of the present invention include, but are not limited to, methods and apparatuses for facilitating, by a computer system, specifying and associatively storing a locator for a data item stored in a storage location, and a characterization of the data item. The locator is a link that identifies the storage location. In various embodiments, the characterization system can be used much like file folders to group data items.

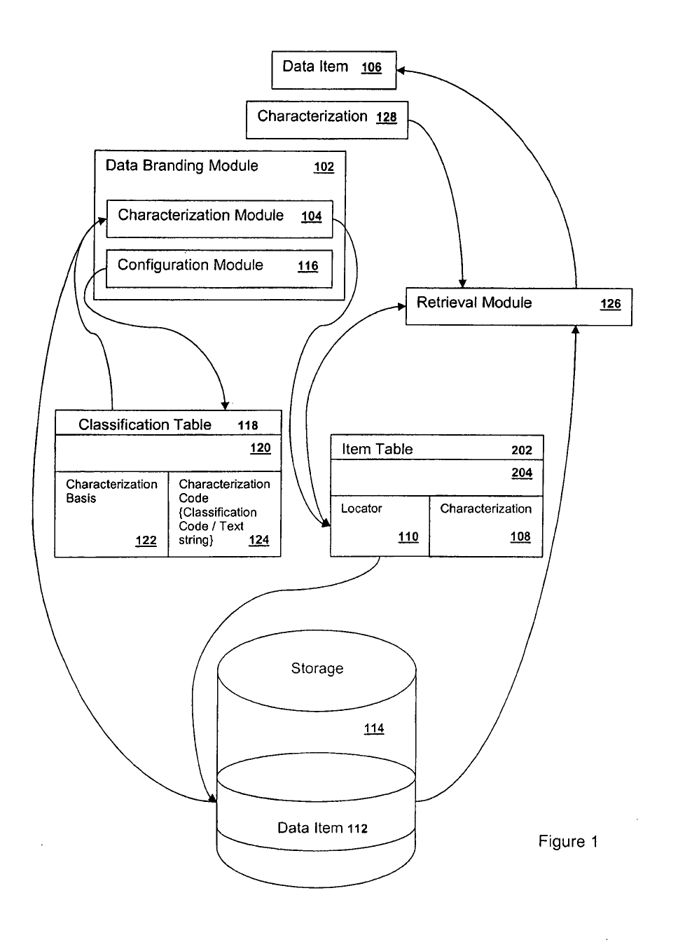

FIG. 1 depicts an overview of various embodiments of the invention. As illustrated, a computing environment can contain a number of data items stored at various storage locations, including e.g. data item 112 stored at storage 114. A data item 112 can be in the form of a data file, a multi-media file, or any other file type. The logic of the computing environment can at least be in part as a result of using a Data Branding module 102. The Data Branding module 102 can, when the data item 112 is selected, perform operations associated with the data item 112 using sub modules of the Data Branding Module 102. Once a data item 106 is selected for inclusion into the Data Branding system, the Characterization module 104 is executed allowing a Characterization 108 to be associated with a Locator 110 of the data item 106. The Characterization 108 can be made up of one or more Classification codes and/or Text strings that can be added by the user or a third party. The Locator 110 is a hyperlink. It can be a physical address, a path, or a link to other similar entities associated with the data item 112. In some embodiments the Locator 110 can be a uniform resource locator (URL) of the data item 112. In other words, the physical storage location of the data item 112 within a storage 114 is known by the data branding module 102 through the Characterization 108 associated with the Locator 110. The storage locations can be local to the computer system or can be accessible via a network and need not to be known by the computer user. For the illustrated embodiments, Locators 110 and the associated Characterizations 108 for various branded data items 112 are associatively stored in Item Table 202. In alternate embodiments, other associative manner of storing Locators 110 and the associated Characterizations 108 can be practiced instead.

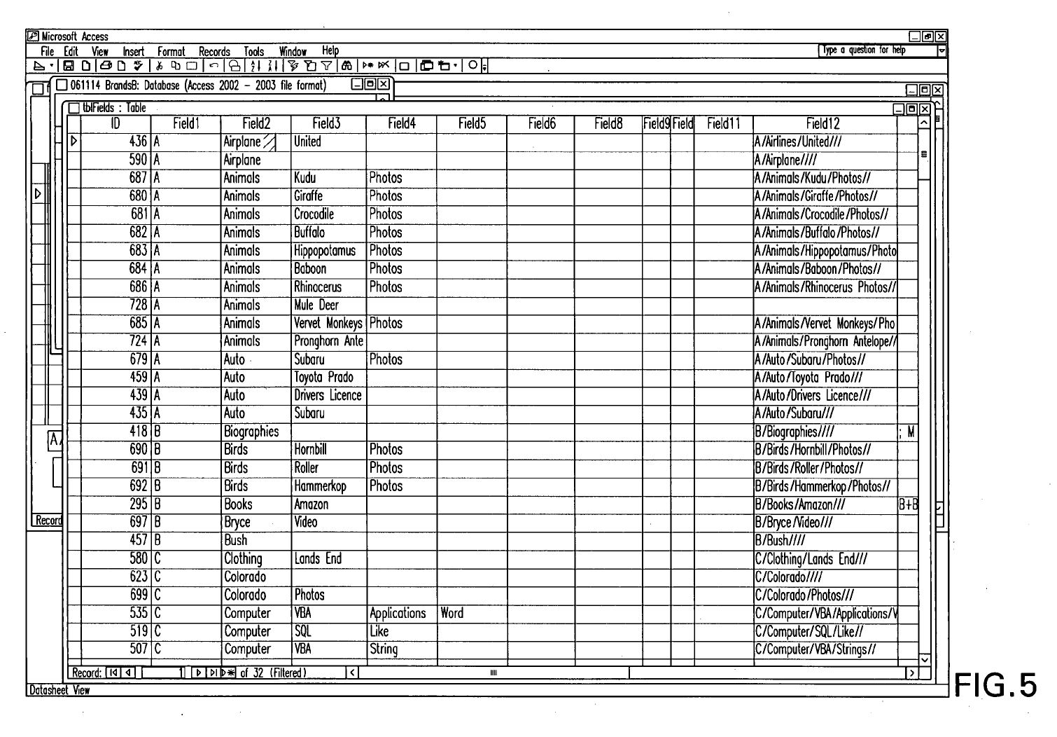

Additionally, for the illustrated embodiments, the configuration module 116 is configured to enable creation of a Classification table 118 and the Characterizations stored therein, if they are not in existence. When adding a Characterization to the Classification table 118, a row 120 can be created in the table, where Characterization 108 comprising a Classification code and/or a Text string can be added. Characterization 122 is a parsed version of Characterization 108, with separate sections (delimited by “/”) of Characterization 108 each placed in individual columns (see FIG. 5). The Characterization module 104 brands data items 112 with Characterization 108. Multiple Characterization 108 brands can be branded into the characterization column of each data item 112, giving a data item multiple characterizations. This enables the user to retrieve data item 112 under various characterizations (see Retrieval module 126 below), and has the same effect as if multiple copies of data item 112 had been made for different characterizations—the same locator 110 is used for all characterizations of data item 112. Characterizations 108 are associated with Locators 110 for data items in Item table 202 and arranged in a manner that can be more efficient or intuitive for retrieval to the computer system user. For the illustrated embodiments, Retrieval module 126 is provided to facilitate retrieval of data items by selecting those with particular brandings or Characterizations 108. Working via Characterization 108, the Retrieval module 126 can select data item 112 bearing Characterization 108 and can retrieve the data item 112 from the storage 114 for the computer user, using the corresponding Locator 110 obtained from Item Table 202. Alternatively, the Retrieval module 126 can retrieve data item 112 using a different Characterization 108 associated with Locator 110. Retrieval module 126 can be set so that it not only retrieves all data items 112 with a particular Characterization 108, but upon retrieving them it automatically opens an application associated with the data item 112, following the hyperlink in each Locator 110 for each data item 112, allowing immediate display or execution of the data item 112. In alternate embodiments, Retrieval module 126 can also be a part of the data Branding module 102.

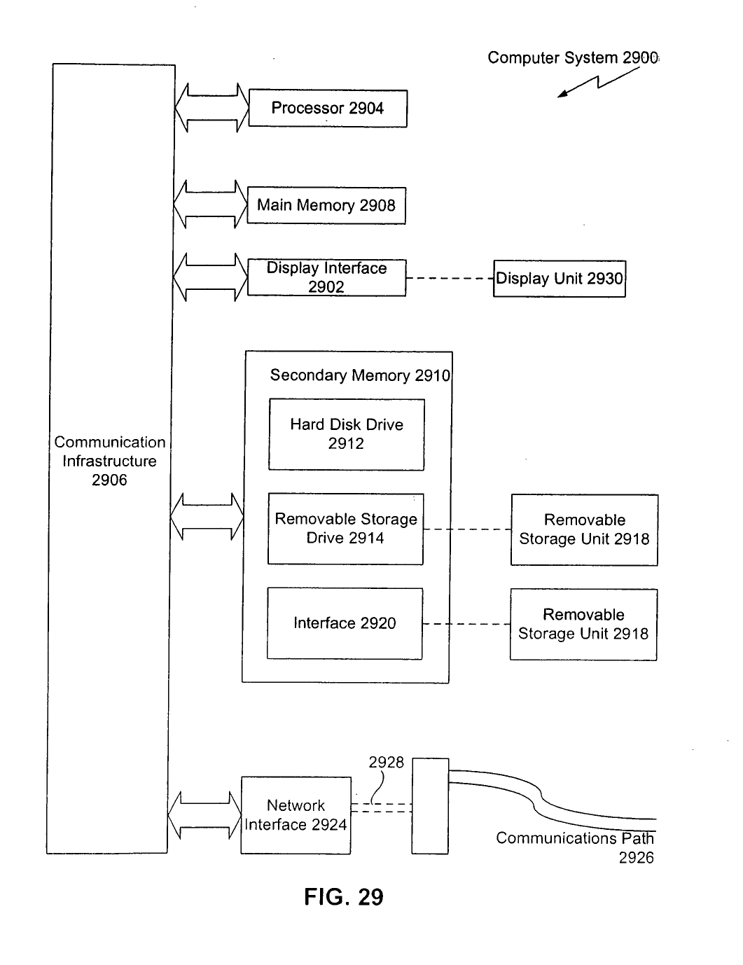

In various embodiments, the computing environment described above can comprise one or more of any single- or multi-processor or processor core central processing unit (CPU) computing system. The computing environment can be or include a personal computer (PC), a workstation, a server, a router, a mainframe, a modular computer within a blade server or high-density server, a personal digital assistant (PDA), an entertainment center, a set-top box, a media player, or a mobile device. The computing environment can also be distributed over a cluster of computer systems, in a client-server relationship or in a peer-to-peer relationship, through one or more local area networks, and/or wire area networks. Each computing system of the computing environment can be capable of operating a plurality of operating systems (OS) in a plurality of virtual machines using virtualization technologies. An exemplary processor core computing system of the computing environment is illustrated by FIG. 29, and is described in greater detail below. Hereinafter, including in the claims, processor and processor core shall be used interchangeably, with each term including the other.

In embodiments where the computing environment is comprised of two or more computing systems, the computing systems can be connected by a networking fabric and can each include all or portions of at least one Data branding module 102, Characterization module 104, Configuration module 116, Retrieval module 126, Classification table 118, and Item table 202. The networking fabric connecting the computing systems can be any sort of networking fabric known in the art, such as one or more of a local area network (LAN), a wide area network (WAN), and the Internet. The computing systems can further use any communication protocol known in the art, such as the Hypertext Transfer Protocol (HTTP), and any transport protocol known in the art, such as the Transmission Control Protocol/Internet Protocol (TCP/IP) suite of protocols.

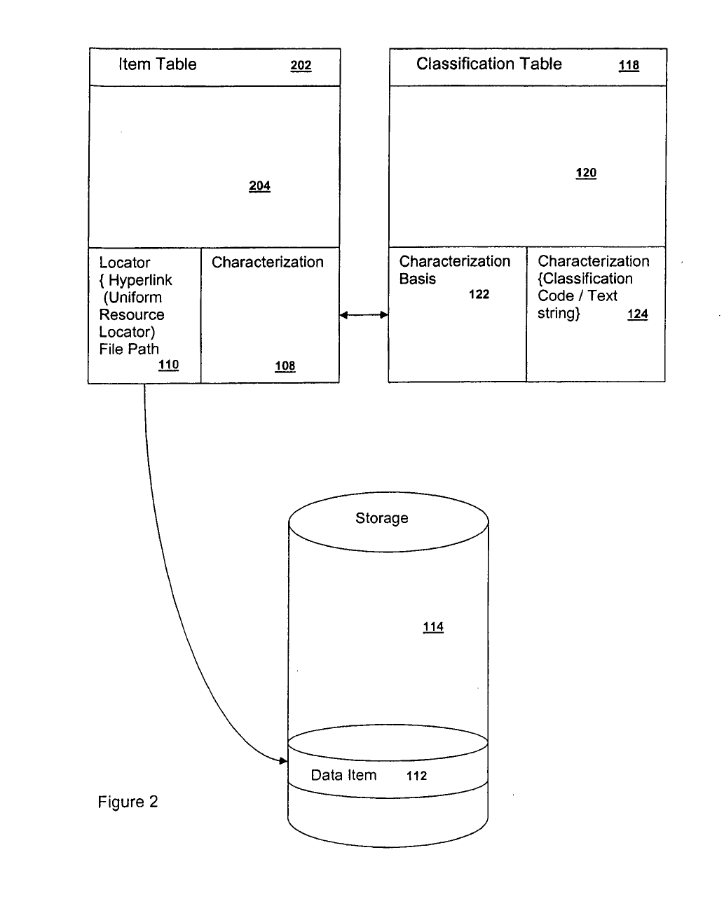

FIG. 2 illustrates, in greater detail, the relationship between the Item table 202, the Classification table 118, and a data item 112 located in a storage 114. In this embodiment, the Item table 202 is made up of rows and columns 204, each row containing one data item 112. Each row includes a Characterization 108 associated with the locator 110 of the data item 112, and the associated Locator 110 provides the means to locate data item 112 stored in storage 114. The means to locate the data item 112 shown can be a Uniform Resource Locator (URL) or the file path, each identifying the physical location of the data item 112. A hyperlink is associated with Locator 110, allowing the data item to be selected and in some embodiments the retrieval of the data item can be executed by selecting Locator 110 with a mouse, keyboard or similar selection device. By selecting Locator 110 to retrieve data item 112, the application associated with the file type can open data item 112 allowing the data item to be immediately executed or displayed in a native application. An example can be viewing image data items immediately in a viewer application with one operation.

A plurality of data items of different file types can be selected and opened sequentially with their associated applications, allowing for groups of associated data items to be manipulated. The classification table 118 in this embodiment can be made up of rows and columns 120. Each row can be made up of columns which as a group form Characterization basis 122, along with a single column in which the previous columns are concatenated, which is the previously mentioned Characterization 108 code and/or Text string. Characterization basis 122 can be user defined or supplied by a third party. Characterization basis 122 is a parsed version of Characterization 108, allowing the user to selectively choose a hierarchy of characterizations as he/she narrows the selection and approaches the particular Characterization 108 for each data item 112 (or broadens the selection away from the particular Characterization 108 for each data item 112). Hierarchical selections provide an efficient and intuitive means to view groupings of data items 112. In any case, grouping data items 112 by selecting for a particular Characterization 108 brand or by parsing of Characterizations 108 (e.g. Characterization basis 122) allows for operations to be carried out on the group of data items sequentially. For example, once a group of items has been identified, the items can be printed in groups, attached as e-mail attachments, opened in groups if photographs, opened in groups if web site addresses, activated (played) in sequence if music files, or manipulated by some other means on the computer system.

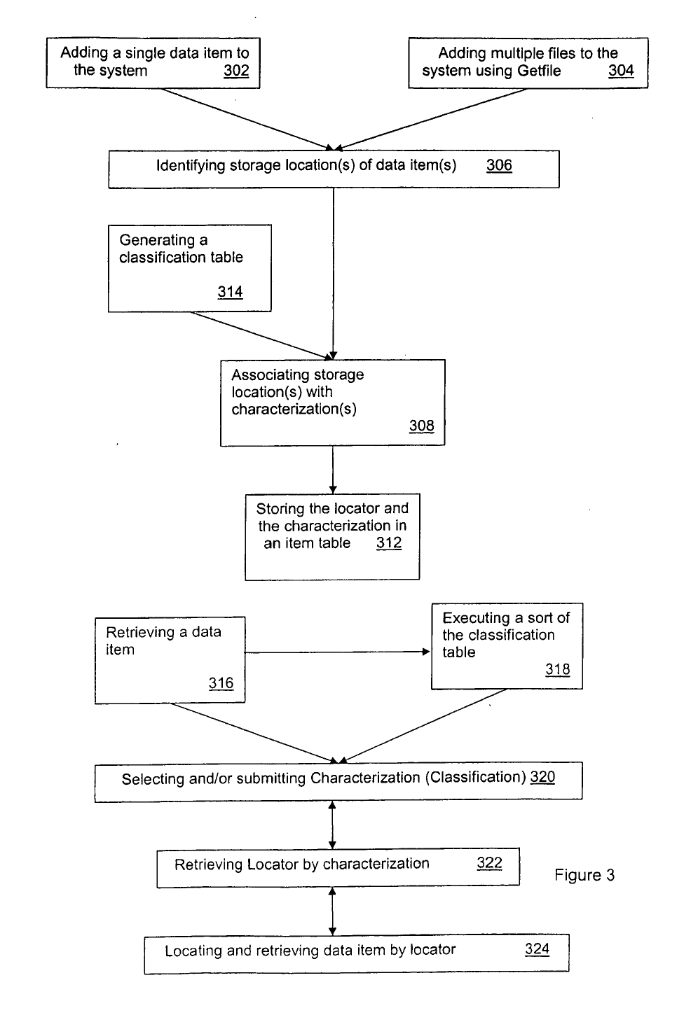

FIG. 3 is a flow chart depicting various embodiments of the invention for characterizing a data item and manipulating the data item through its Characterization. As illustrated, a computing environment can receive or contain a data item located within the storage of the computer system. A data item can be added as single data item to the system using method 302 or by adding multiple data items to the system using Getfile method 304. The term “method” as used herein is to be read as it is understood by those of ordinary skill in the art of object oriented programming; however the invention is not limited to an object oriented implementation.

The Getfile method 304 is similar to a batch operation where multiple data items can be selected from Storage 114 and their Locator 110 values added to the Item table 202 as a batch, with their Locators 110 linking them back to actual data items in Storage 114. This embodiment can also allow the association of third party text string descriptions and classification codes to be added as Characterization basis 122 column entries to Classification table 118. In this way, music data items can be imported and stored in Storage 114; their Locators 110 imported into the Item table 202; then classification codes and text strings identifying, among other things, title, artist, composer, genre, track length, year of production, country of origin, and so forth assigned to the Characterization basis 122 in the Classification table 118. In various embodiments, the data item can be located in any physical storage location, local or remote, known or unknown to the user. The data item Locator is a hyperlink to a file path, a uniform resource locator or other means to locate the physical location of the data item, and is associated with the Characterization of the data item because both locator and characterization are column entries for each data item row in an Item table 202. The association allows the Characterization always to be associated with the physical location of the data item regardless of the physical location of the storage location. A Classification code and or Text string describing the data item can be supplied by a third party as noted above, or user defined. In this embodiment the user can edit the Classification code and/or Text string, the language being completely freeform, and so allowing the user to use terminology and codes that are most efficient and intuitive to each situation.

The Classification table can be generated separately from the Item table. The generated Classification table can contain rows and columns, each row containing a number of Characterization basis and a corresponding Classification code and or Text string. Drop down menus on the Item table 202, which are linked to the Classification table 118, are then employed to display Characterization basis 122 entries so that they can be collectively branded as Characterizations 108 onto a row of the Item table 202 in the relevant column. Since each row has a data item locator in it, the Characterizations 108 become linked to the locator once they are branded into their column in the row. The result is stored within an Item table 312, the Item table being made up of rows and each row containing the locator and characterization basis for one data item. The rows representing the data items can be arranged in any order using the characterization.

Sorting and grouping of data items can be carried out on the Item table, allowing for fast, efficient, intuitive navigation and retrieval of data items 316. Retrieval of a data item 316 can be by selection of a Characterization 320, which can be associated with a Locator. The Locator can contain the physical address of the data item, allowing the selected item to be opened. For this embodiment, the data item can be opened with its associated application. The Classification and or Text string details of a data item can be edited, allowing a user to modify these terms, and allows for future efficiencies to be built into the Classification table. A data item can be located by retrieving the Locator by Characterization 322 if all or part of the Characterization is known. Once the appropriate locator has been found through its association with the Characterization, a data item can be located and/or retrieved by the Locator 324. Data items can be searched for using all or part of the Classification code and or Text string; this allows a user to find a data item based on any known recorded characteristic of the data item. Also, this allows the user to retrieve data items as hierarchical sets of related groupings, as the Characterization 108 value is parsed into smaller units. Further, as already mentioned earlier, since each data item can be multi-branded with multiple Characterizations 108, the user has multiple terms to retrieve a particular data item, making for very fast and easy retrieval. Further still, any number of useful characterizations can be branded into the characterization column (multiple characterizations, as already mentioned), including ones such as “to do” or “follow up”, thereby effectively tagging data items for follow up action in addition to their existing characterizations.

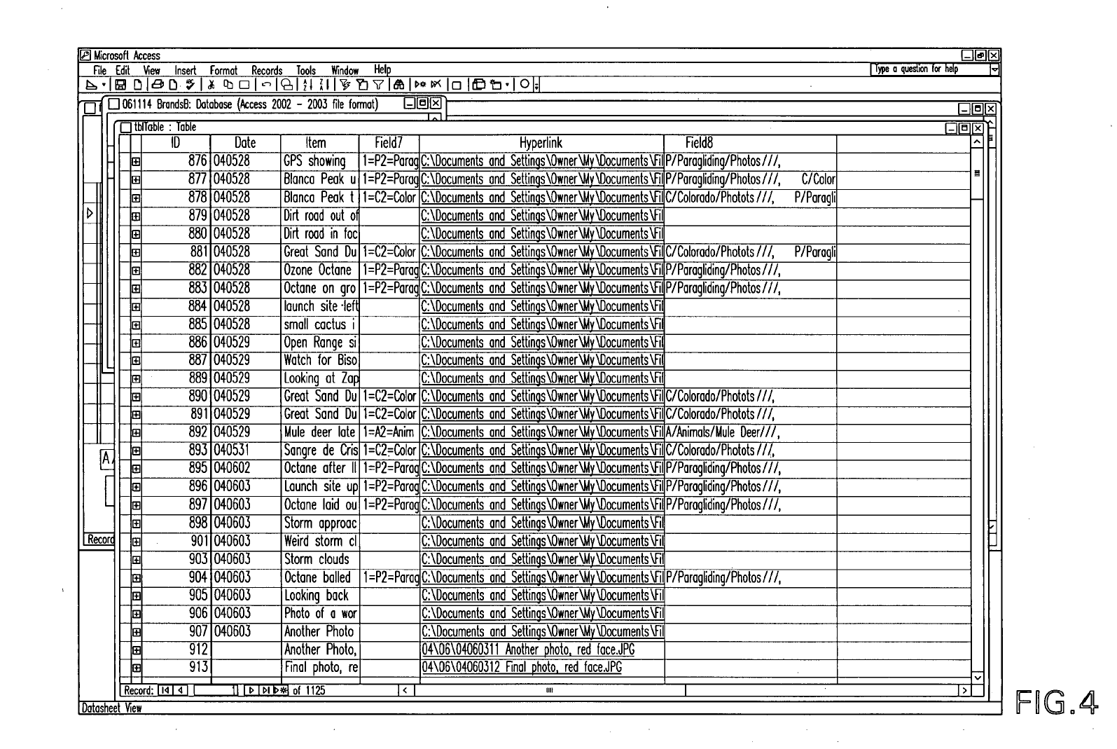

FIG. 4 illustrates an embodiment showing a screen shot of an Item table. Each row of the table contains information specific to one data item. The hyperlink column contains a hyperlink which is the data item Locator, the full file path to the data item. It is not necessary to display the full path to the data item, merely that the full path be called when the hyperlink is activated, and this is shown in this figure. By selecting the hyperlink the user is selecting the data item represented by the row in the table. The column headed Field 8 on the far right of the table represents a column containing Characterization 108 information. In this example classification codes and text strings are shown.

FIG. 5 illustrates an embodiment showing a screen shot of a classification table. Each row of the classification table contains information specific to one data item. The columns headed Field 2, Field 3, Field 4, and Field 5 contain classification data for the data items contained in the table. The Characterization 108 for each data item is contained in Field 12 of the table. The table demonstrates a classification table sorted on Field 2, with the data item possibly representing a United Airlines ticket. The 3^{rd} to 9^{th} rows give an example of a grouping of data items; the example shows animal photos, including information about the specific animal contained in each photo.

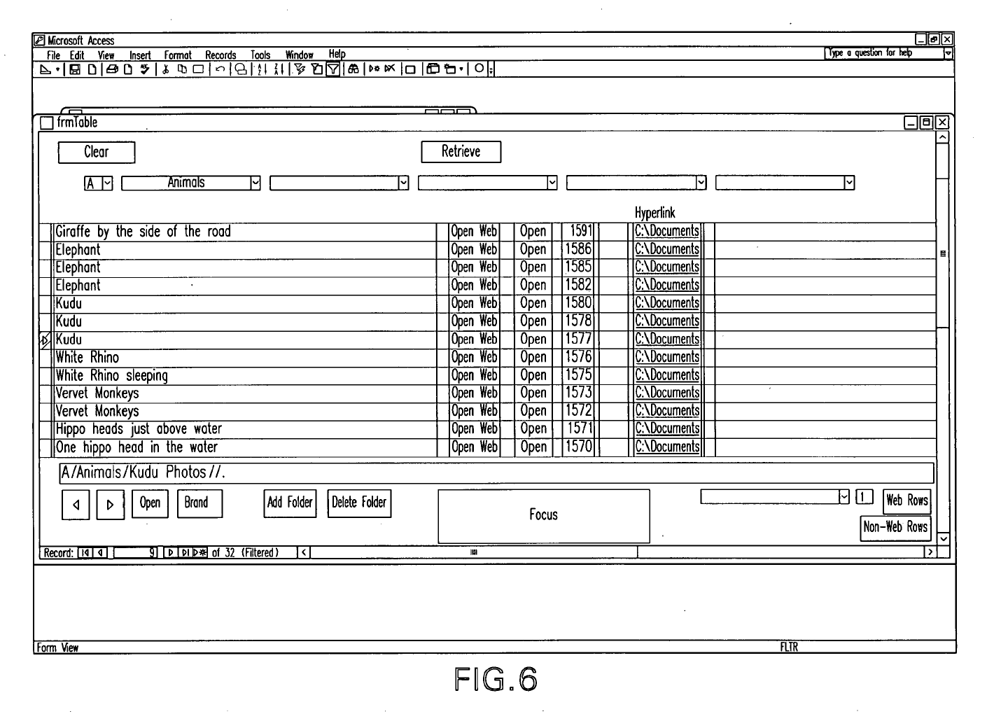

FIG. 6 illustrates an embodiment showing a screen shot of a resulting recordset. A subset of the classification table containing a common classification, each row representing one data item. The table shows all data items with an animal classification, as indicated by the drop down menu entries “A, Animals” under the “clear” button. This can allow all of the data items with the animal classification to be manipulated by the user in one operation.

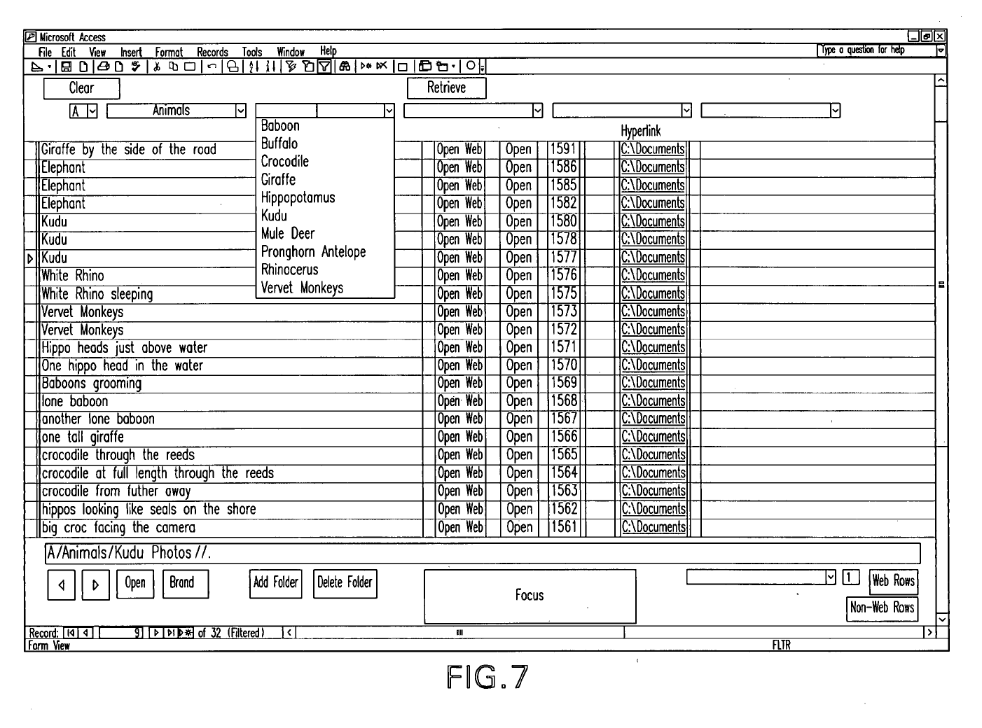

FIG. 7 illustrates an embodiment showing a screen shot of a drop down menu showing various criteria available within a classification table. The drop down menu contains classifications that can be added to the data items in the table. By selecting a data item represented in one of the rows, then selecting classifications from the appropriate drop down menus, and then selecting the branding button, the classifications are added to the data item, creating the data item's Characterization 108.

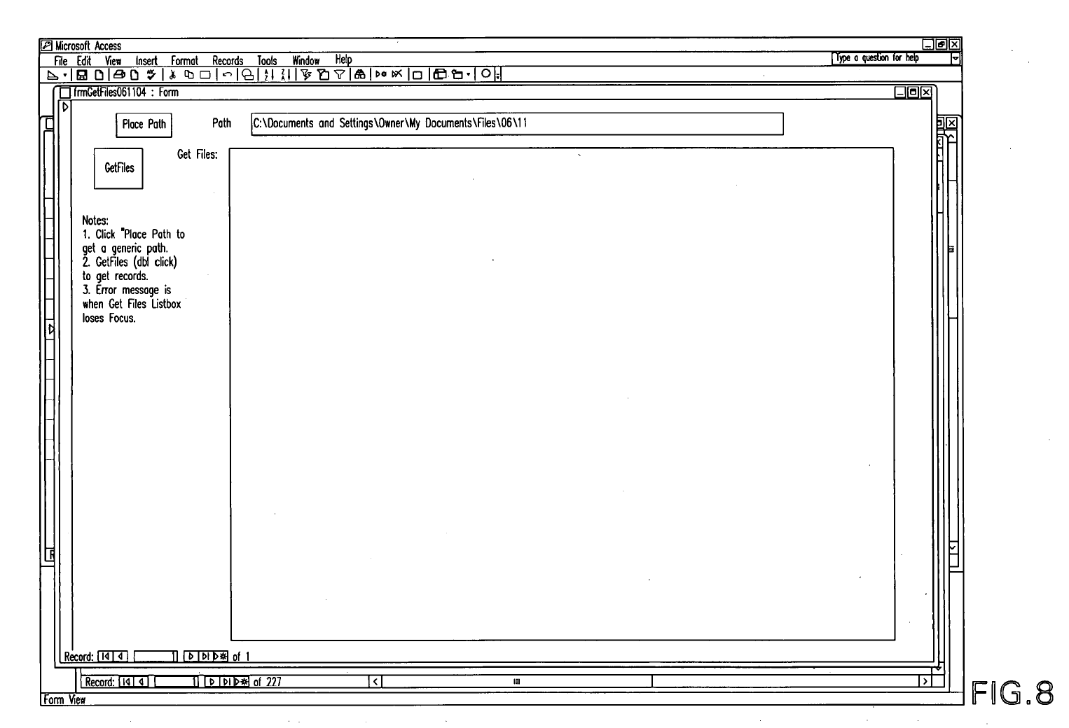

FIG. 8 illustrates an embodiment showing a screen shot of the Getfile form when it is empty, before the Getfile logic is activated. The Path field at the top of the form indicates where the user can enter the file folder location for files he wants entered into the system.

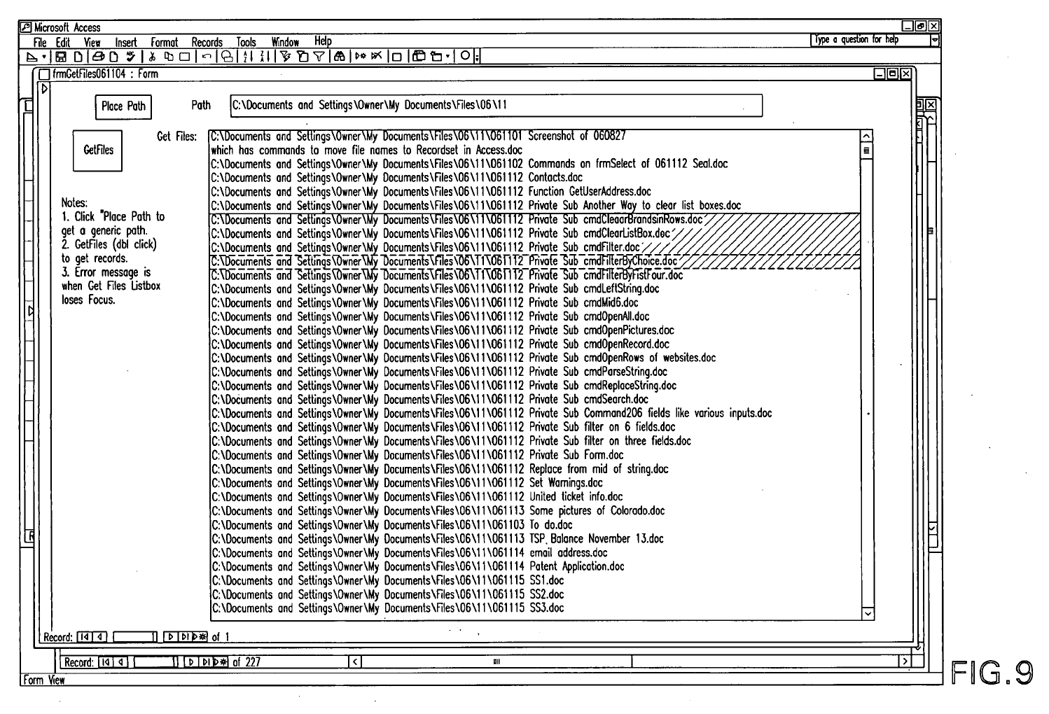

FIG. 9 illustrates an embodiment showing a screen shot of a Getfile form. All of the data items in a specific location or folder are shown listed in the table, each row representing one data item. From the data items shown, a subgroup is selected to be uploaded into the Item table. Each data item in the group selected has a Characterization and a Locator associated with it in one operation similar to a batch operation, as it is uploaded into the Item table. The user can then brand a Characterization 108 into the row for each uploaded item in the Item table, using drop down menus as already described.

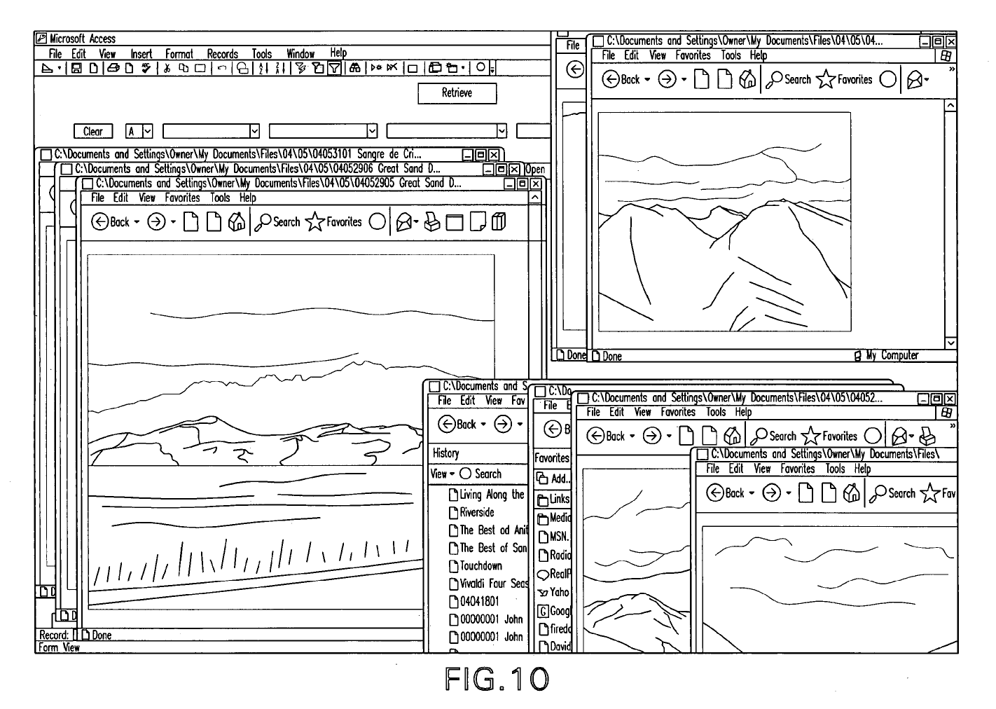

FIG. 10 illustrates an embodiment showing a screen shot of the result of multiple data items being selected and the appropriate associated viewing application being opened for each data item and displaying each data item sequentially on the computer system. This is done because the program performs a “do loop” routine, moving down through rows and opening each photograph via the hyperlink (locator 110) field for each row.

### “Databrand”

Overview: in a software embodiment of the invention, the use of traditional file folders is replaced with a method of organization referred to herein as “databrands.” Data is collected in recordsets, which are produced by running queries against a table. The folder path information is “attached” to the data—as if the folder names were “branded” onto the data. This is so because both the databrands and the data (in hyperlink form) are stored in separate fields in one unique record. Records that are databranded then can be manipulated in a wide variety of very useful ways. For example, they can carry multi-databrands (in effect be filed in several folders). They also can be processed (opened) as a group, in sequence—enabling group taskings, such as mailing groups of e-mails or opening groups of websites, etc. There are many other uses describe below.

### Outline of Databrand Programs:

Databrand software, realized, for example and not by way of limitation, in Microsoft Office Access 2003, comprises five main elements. These are: the data themselves, two tables, the resulting recordset, and programs on the GetFiles form.

Data: the data comprises files in directories and folders in a computer drive, for example. The data can be in one folder inside one directory on one drive. Alternatively, the data can also be scattered in different directories and in different folders in these directories or located in different drives. The files can be documents, photo files, music files, spreadsheets, e-mails, adobe acrobat files, and more.

Tables: there are two tables: an Item table, which contains a hyperlink field linking each entry to a specific data file, and a Classification table, which holds the criteria for locating items in the Item table. Both tables hold a databrand field, too.

Recordset: this is the resulting grouping of records, displayed when queries are run against the Item table using criteria drawn from the Classification table. Alternatively, a recordset can be generated based on queries run against the Classification table, a useful way to quickly find criteria from the Classification table for use on the Item table.

GetFiles Programs: these are programs that enable the user to import full path names into the hyperlink field of each record. These programs, then, effectively load the data into the Databrand database.

### Functioning of the Databrand Database

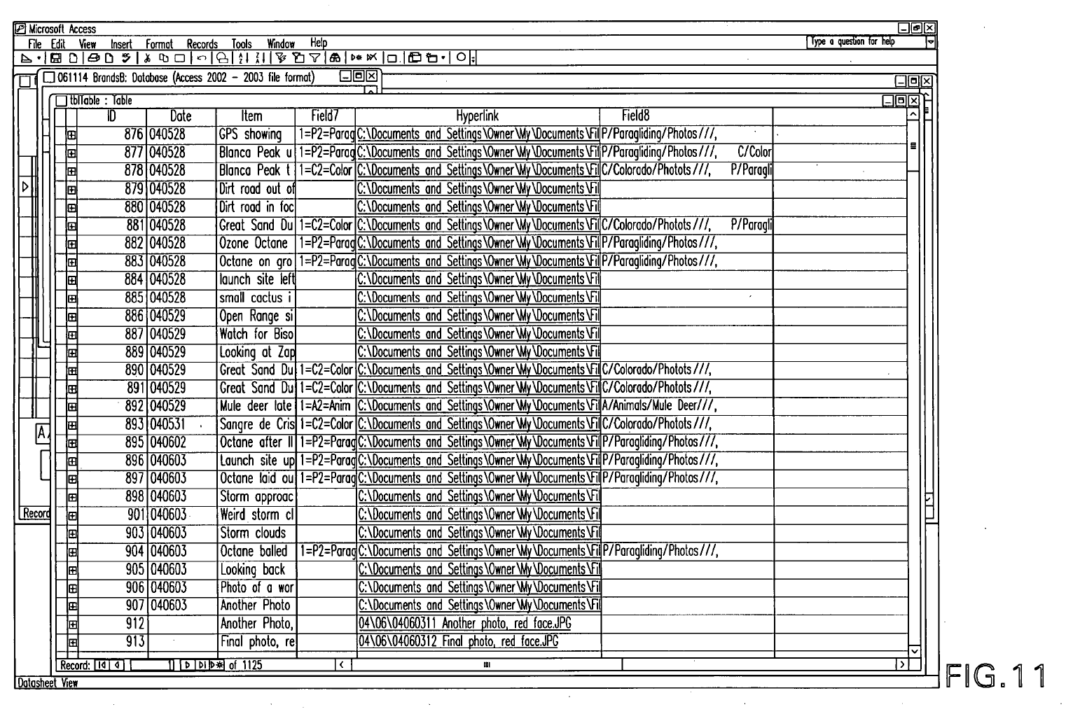

FIG. 11 illustrates an example of an Item table. Among the features included in this table are the hyperlink field and, what is referred to here as the “databrand” field. Each record (row) in the table includes the hyperlink field. This field contains the path to the data item and, when clicked, opens the data item. This arrangement enables the user to locate the data item even if the records, when called up in a recordset, are sorted or rearranged in any way. To repeat, the hyperlink enables the user to access the data item under different locations in the recordset, without the data item moving. The path to the data item in the hyperlink should not be changed for this to function.

The binding of the data item to the record via the hyperlink field allows a record to be manipulated as part of a recordset rather than manipulating a data item (or file) on its own. Once the data item is bound to the record via the hyperlink field, the record represents the data item and can be processed as if one were processing the data item.

The “databrand” field identifies the classification of the record in the same way that a file folder path is used conventionally to identify the location of a file. When queries are run against this field, those records whose databrand field matches the query are returned. The result is that queries for a specific databrand return a group of records identical to what one can find by opening a folder for these records (or files) in a conventional filing system. This feature turns the conventional filing system on its head. Rather than placing data items or records in specific file folders, file folder criteria are “branded” onto the records and used to find files or data items regardless of their location. As explained below, this arrangement allows the finding and manipulation of data items to be performed more easily on “databranded” files than on files merely stored in folders.

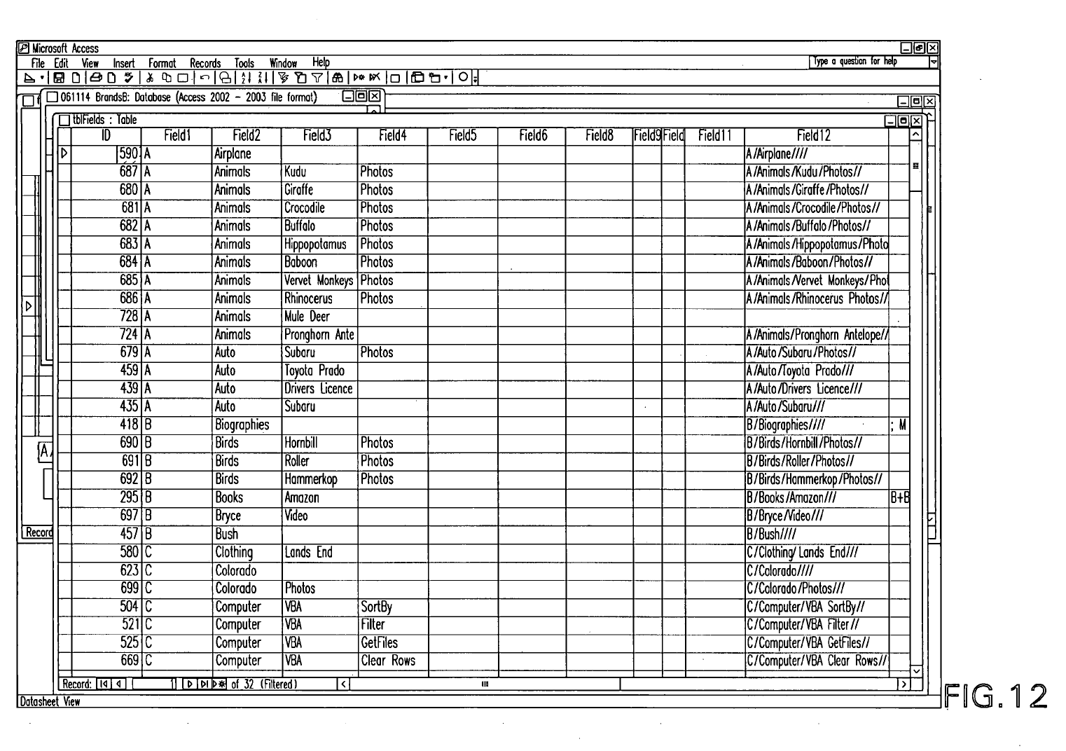

FIG. 12 illustrates an example of a Classification table. There is one classification for each row. The columns for each row are fields indicating various logical levels to each classification—identical to the file folder and sub folder system in conventional filing system. Thus, reading across the first row, one can see, for example, “A” “Airlines” “United” in the first three columns. This classification can be used for a data item (a ticket receipt, for example) of a United ticket. The “databrand” field, described above, holds the entire classification designation that is branded into the databrand field in the Item table.

FIG. 13 illustrates an example of a resulting recordset when a select query is run against the Item table using criteria drawn from the Classification table. The recordset is shown on the Databrand form, with six dropdown boxes, for example, in the top area and resulting records in rows in the bottom area.

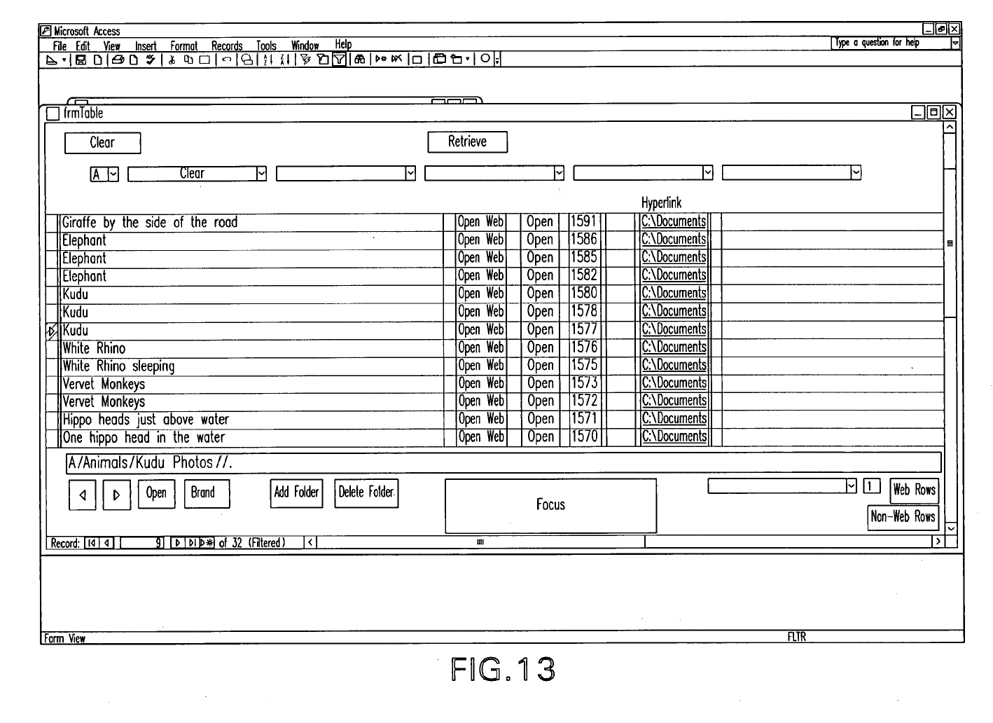

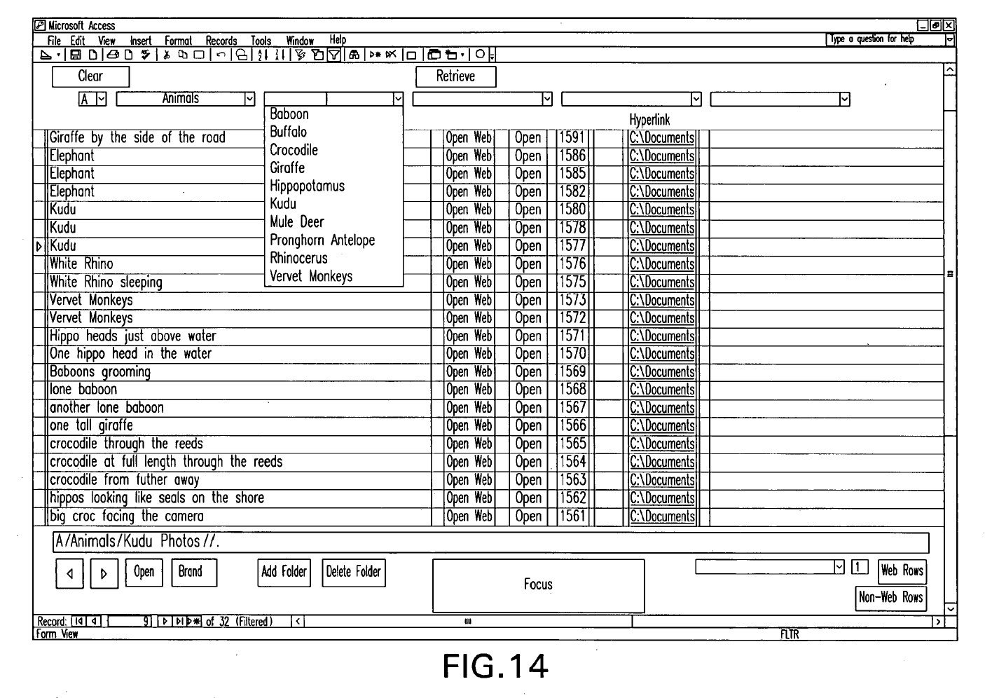

FIG. 14 illustrates an example of one of the dropdown boxes open, showing various criteria available. Also illustrated in FIG. 14 is, for example, the “Brand” button. When this button is clicked, the classification criteria is copied from each dropdown combo box, collected and separated by “/” marks, and then branded into the databrand field for each record. This is how one brands each record.

At the bottom of FIG. 14 is, for example, an “Add Folder” button and a “Delete Folder” button. Clicking on the former adds a folder based on the classification criteria copied from the combo boxes at the top of the form. Clicking on the latter, the Delete Folder button, deletes the folder based on classification criteria in the combo boxes.

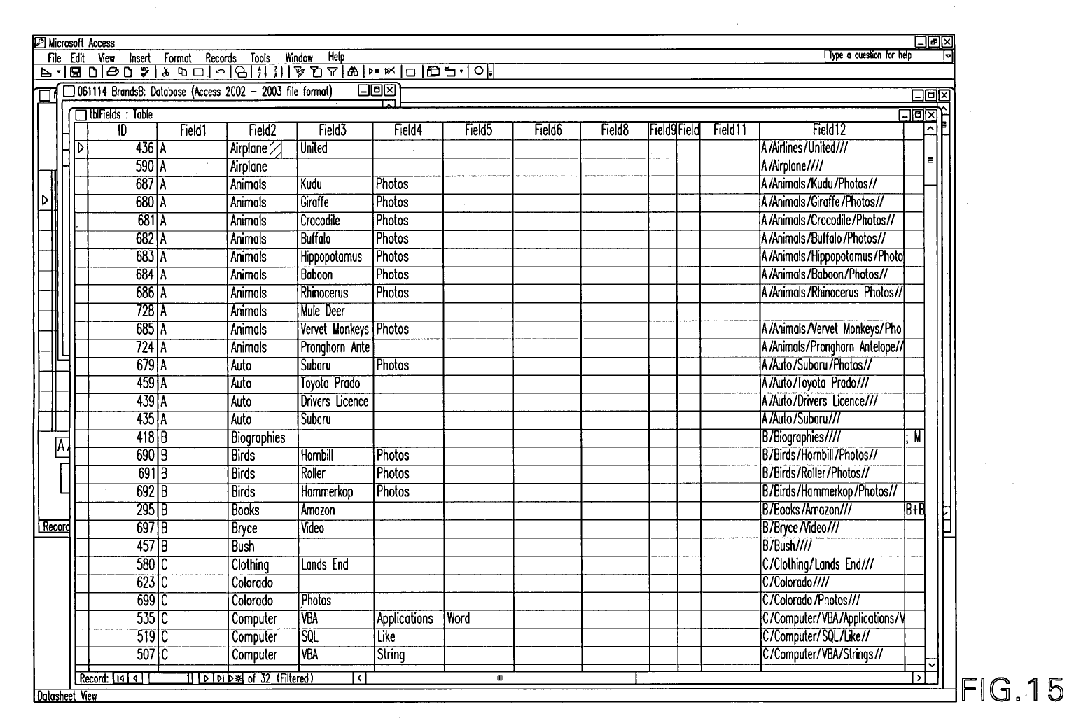

FIG. 12 illustrates an example of the Classification table with A/Airlines/United in the top row. FIG. 15 illustrates an example of a resulting Classification table with a classification, A/Airlines/United, removed.

Entering Data into the Item Table:

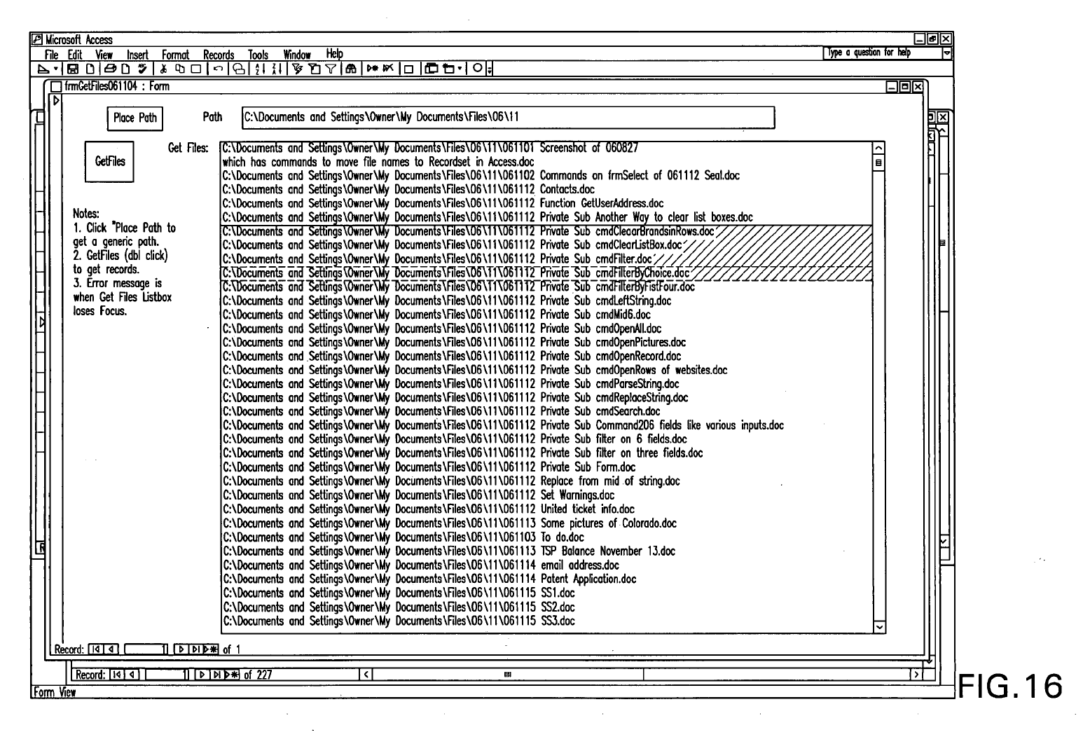

There are several ways to do this. One is to open the Databrand form, click on the hyperlink field and then find the data item in its particular folder and add it. FIG. 16 illustrates an example of a GetFiles form. The GetFiles Form provides a rapid way of getting files and inserting them into the Item table. When the top button is clicked, the full path names of files in the chosen folder are added to the Listbox in the center of the form. The user then selects which of the items in the Listbox he wants added to the table. When focus moves off the List box, the selected items are inserted into the Item table, with the file path names inserted into the hyperlink field. In this manner, up to 200 files at a time, for example, can be inserted with several clicks.

Preferably, one file folder is assigned as the primary location for files to be uploaded into the Databrand database. For example, in November 2006, the inventor designated C:\Documents\0611 as the primary folder and to which has been transferred Adobe Acrobat files, Word doc files, spreadsheet files, and photo and video files. The run commands on the GetFiles form are used to upload data items into the database. Alternatively, files can be placed in a folder, for example a “My Music” folder, and uploaded from there. This is accomplished by changing the path address in the top of the GetFiles Form to the “My Music” folder, etc.

This, then, is how one builds the databrand database.

The usefulness of this sort of database is as follows:

(1) Items or files no longer need to be put in separate folders to classify them. Instead, they can reside in one folder or directory and are classified or grouped according to the “databrands” that are given them. This makes it simpler for the user at the beginning, when creating files, because as files are created they are saved in one location. Additionally, having the files in one folder or directory increases the speed at which files are processed.

(2) There is no longer any need to duplicate files or photos or other documents, as one had to do when one wanted multiple copies in different folders. Instead, multiple databrands can be attached to an item, effectively identifying it as belonging to multiple classes. To be more explicit, in the conventional folder system, if one wanted Folder B to hold a copy of a file in Folder A, one can have to make a physical copy of the file and transfer this copy to Folder B. Under the “databrand” system, making another copy of the file is not necessary. Instead, the same file is databranded again, according to the identity of the B folder. This represents a significant savings in disk space since multiple copies of files, photos, etc. need not exist. Additionally, since each record has a field listing the databrands attached to each file, one can immediately see the different categories or “folders” the user is employing in managing the file. This means, then, that the user knows immediately the various “places” or categories that the file is “filed” under—eliminating much of the time-wasting effort of searching for copies. Rather, a user can databrand something with multiple databrands as a way to ensure he/she can rapidly retrieve it.

(3) Manipulating files or items becomes much easier, since each item is attached to an individual record of a recordset. Files or items can be processed in sequence, using do-loop routines to process from record to record in a recordset. For example, multiple photos can be opened automatically as the program moves from one record to the next. Or multiple websites can be opened. Or multiple documents can be sent to the printer and printed. Or multiple items can be e-mailed to others, one after the other, with one command. Moreover, since the items are part of records in a recordset, they can be sorted by any of the record's fields (or any added fields), as necessary.

(4) A music file record, for example, can be opened from the database, while at the same time the user can browse the Internet by opening another record, while writing an e-mail in a third record.

(5) Since databrands can be text strings, string searches can be employed to locate or manipulate files. This makes for very rapid retrieval. Provided that an imported table matches the system, other category systems can be imported to databrand their information onto records. Thus, one can, for example, take a series of animal pictures but use a purchased classification system to classify them. Or match music with a classification system of composers, purchased from the outside.

(6) By adding, for example, a “to do” databrand to data, the user can locate items that need his or her attention. This is more efficient than the traditional method of writing down the name of the item on a “to do” list and then later referring to the list to find the item.

(7) Using the combo boxes at the top (the “Retrieve” button can retrieve records based on the entries in the combo boxes), one can retrieve, for example, alternately: (a) records that have “music” in one of the classification fields, or (b) records that have “music” and “classical” in the classification fields, or (c) records that have “music” and “classical” and “Beethoven” in the classification fields. Duplicating this sort of filtering of records in a conventional filing system is more difficult.

(8) Adding and deleting file folders is much easier than in the conventional system.

(9) The database functions with two tables.

(10) Queries can be run against the Classification table to find the exact classification designation one wants to run as a query against the Item table. This makes this system very focused and specific.

### “LOST” Processing

LOST stands for “Locked, Ordered Shell and Table,” a phrase that captures the main features of this type of file processing. LOST (and its predecessor Databrand) use a novel way to organize and retrieve files, based on shells, categories and a filter.

The components of LOST are described in detail below.

The “Shell” is a term that is used for “data item 106” in Databrand. “Shell” is similar to what is termed a “tuple” in SQL and a “record” in Windows Access. However in one respect it violates a key principle of SQL; this is that one or more of its fields often contains more than just one value. (In SQL, tables must be “normalized”, a process that, among other things, results in each tuple's field having one and only one value.) This is essentially in reference to the “category” field (called the “characterization 108” field in Databrand), where at times several “classifications” or “brands”, which below are referred to as “categories”, are placed.

A group of related shells, say those returned when a query is run, is called a “shellset”. In this sense, LOST parallels Access, where a group of records is called a “recordset”. The shellset of all shells is called the “Master shellset” or “Master”, and is referred to as the “Item Table” in Databrand.

The hyperlink field in the shell (“locator 110” field in Databrand) links the shell to a specific file—it links the fields in a particular row to that specific file. The linked tuple fields—file size, file name, file type, file modification date, etc.—form exterior attributes of the file, but say very little about its inner contents, whether it be a picture file, a music file, a word document file, or something else. In this manner, the tuple with its respective fields linked via the hyperlink to a file forms a “shell” of the file. This is the derivation of the term “shell”.

The “Table” referred to in the acronym LOST is the familiar classification table described above under Databrand. However, as shown below, in LOST this table, called a “Filter Table” or “Filter”, takes on very useful additional functions.

The combination of the Master Shellset, the Filter Table, and the associated queries are referred to as a “Filebase”, rather than a “database”. Filebase is the term used because the basic unit of information in the collection is a file.

“Ordered” refers to the categories stamped into the category field. They define the shellset that is retrieved (to use a particular file). The categories follow a pattern of increasing specificity in the Filter Table, enabling the user to retrieve shells as sets, sub-sets, sub-sub-sets, and so on. Further, categories can be assigned that not only locate or describe the file, but also denote the need for some action to be taken, such as “to do” or “follow-up”. In an embodiment, a button on a form labeled “To Do” allows a user to call up shells that have files requiring attention.

“Locked” refers to two aspects of the Master Shellset in LOST. The first is that the ID field of the Master Shellset is what in SQL is known as the “primary key” field. Primary key fields are fields that carry unique values across all records in the recordset or table. That is, there are no duplicate values of a particular shell's primary field in other shells in the recordset or table. In this sense the shell is “locked” to a particular ID value (e.g., a particular number). The second aspect is that the value in the ID field is repeated in the first part of the file name, a part of the file name referred to as a “Coordinate”, and included in the hyperlink field, and repeated in a designated “coordinate” field in the shell. This is done so that the shell is “locked” to the file, as described below, in a way even more fundamental than via a hyperlink. (This is referred to as locking or “coordinating” the file.) A file's shell is associated or “locked” or “coordinated” to the file itself; hence, the innovation of giving the first part of the file name the same value as the shell's ID field and coordinate field.

To repeat, in an embodiment, two conditions of the “locked” aspect of LOST are require to be true. First, it is true that the path given in the hyperlink field is the correct path for the associated file. Second, it is true that the first section of the file name in the hyperlink field, the coordinate, is identical with the value in the associated shell's ID field. The desire for the first condition is so that the shell is truly linked to its file. The desire for the second condition arises if, for some reason, the files somehow become separated from their associated shells (say, when the files are copied and given to someone without the associated shells). To join the files and their associated shells, a program can be run against the file names, splitting out the coordinate and putting this number into a field designated as the primary key field of a new table. This table then can be combined with the shellset for the files, relating both by making the shellset for the files use its coordinate field as its primary key field, as well. The result is a shellset that has hyperlinks showing the first part of the file name (its coordinate) matching the ID field and the coordinate field.

The following are new programs developed in LOST, which represent improvements over the programs developed for Databrand.

(1) Programs that download e-mails automatically into the LOST filebase. Programs that select multiple files and send them out as multiple e-mail messages automatically. Programs that select sets of e-mails to be displayed, based on categories or file attributes. Also, programs that rapidly download e-mail attachments (and in some cases open the attachments, too) into the LOST filebase and upload e-mail attachments. Additionally, programs that allow the user to compose e-mails while in the LOST filebase.

(2) Programs that enable the user to quickly create “playlists” for music files. It should be mentioned here that LOST enables users to organize a music filebase passively, that is by assigning fields to any of the file attributes that come with the file—composer, length, artist, etc. (These attributes that come with a file, the file's properties, can be viewed in Microsoft using the advanced summary page.) With LOST, music vendors can add additional attributes to music files so that listeners can organize their files with any of these attributes as well.

(3) “Warehouse”, a program that loads non-e-mail messages in the Master Shellset—jpg photo files, music files, Word documents, Excel spreadsheets, pdf format files, or other types of files that can be activated by a hyperlink. Warehouse (and programs downloading e-mails and “folder converter”—see below) ensures that each file is identified by an ID value, by size, and by date (fields that are automatically filled when files are loaded), even if the user does not give the file a particular name. This makes saving files more secure, more efficient.

(4) Word and Excel icons: behind these icons, which appear on the Master Shellset form, are programs that open a new Word document or Excel spreadsheet with a click. After the user is finished working on the item, he merely closes it and it is automatically dropped in the Master Shellset, each item linked via a hyperlink to its respective shell, and saved as in (3) above.

(5) “Folder Converter”, a program that converts a folder tree of files (a folder tree is a folder with a set of sub-folders, themselves having sets of sub-folders, etc) into categorized shells in the Master Shellset, which are linked to files by their respective hyperlinks. This program comes in several varieties. One moves all the files out of their folders into LOST's common directory (or folder), copying the folder names as categories in the category field. Another version leaves the files in their folders, while copying the folder names as categories into the shell category field. A third version makes copies of the files in folders and places these copies in the common directory, again copying the folder names as categories in the category field.

(6) “Transfer Files”, a program that enables a user to transfer a set of files along with the files' respective shellset to another filebase.

(7) “Create Filter Table”, a program that runs off of a shellset to create a corresponding filter table.

(8) “Storage”, a program that divides the collection of files into storage folders, each holding a set number of files. This program makes handling files (for example, handling files through Microsoft by clicking on the C directory, then clicking on underlying folders to expose files) more user friendly, because folders that contain thousands of files can be broken down automatically using “Storage” into folders that contain a more manageable number—such as 500 files each. A related program, “Delete”, removes unwanted files from the Master Shellset to another “delete” shellset and then gives the user the option to delete them from the computer altogether by deleting them from the “delete” shellset. This program can be used very efficiently to eliminate the clutter of unused files, more efficiently than the current folder system which requires folders to be opened and the contents examined.

LOST programming also helps with copying files. In LOST the shells of files are tagged before the copying occurs, again without the need to open and close folders. Then with one click the files are copied. LOST programming can be used to print multiple documents or files, too.

(9) “Remote”, a program that allows the user to retrieve files remotely from his home computer. The program exploits the strengths of LOST—that files can be found quickly and accurately. The process is as follows: (a) the user sends a message to his home computer (or office computer, for that matter), requesting a copy of the filebase Filter, which the computer sends back as a report; (b) next, he sends the remote computer the ID value of the category (row) in Filter of interest to him, which the computer uses to query the filebase and return that shellset of files, by sending the home computer a number, which, in response, the computer sends him as a report the shellset corresponding to that row or category; and (c) next, the user then, looking over the shellset report, identifies the file or file he wants and sends this number (or these numbers) to the computer, whereupon the computer sends him back an e-mail with the files attached. It should be added that Remote can be modified so that instead of the files being e-mailed, they are activated remotely to perform some task—turn on music, turn on lights, activate a burglar alarm, turn on a water sprinkler system, and the like.

Other Improvements:

The Filter Table is an improved version of the Classification Table in Databrand for the following reason: the Filter Table contains a field for file extensions. This is helpful because one can work from just one Filter Table that contains the categories used by the files, but nonetheless use categories related to certain file types. Another way of saying this is that when one views e-mail messages (a file type that carries the “msg” extension), one sees categories the user has placed on e-mail messages when clicking on the dropdown boxes and is not distracted by categories placed on other types of messages.

In Access, forms can be designed so that only files with a given extension are viewed. Further, by having an extension field in the Filter Table, the dropdown boxes in the form can be programmed to only reveal those categories relevant to certain file types. In an embodiment, there is a form that: (a) displays certain types of files and (b) displays categories carried by a particular type of file.

Different form designs can then be employed to highlight features of different shellsets, displaying particular file attributes in particular fields. For example, an e-mail form can, for example, display the following useful fields: sender, receiver, subject, date, size. A music form can, for example, have the following fields: title, composer, artist, and length. A photo form can, for example, use these fields: title, location, date. And thus one Filter Table can serve as the basis for a multiplicity of forms.

The Filter Table can contain any number of additional useful fields—say, the names of particular users who jointly use the Filter Table in a local area network (or access a website). This arrangement can enable a database manager to select particular Filter Table categories for particular users based on the presence (or absence) of their name in the Filter Table name field. Such a table is particularly useful in a setting where particular types of information (for example, information that can be retrieved via a particular category) are available only to some users and not to others.

Further, the Filter Table can have a “date/time” field, too, for each category (each row). This way the user can use his memory of WHEN he categorized a bunch of files as a way of finding them.

Advantages of New Programs:

(1) Programs that work with e-mail messages: some of these programs transfer e-mail into the Master shellset with one click or, alternatively (depending on the user's choice), the transfer can occur whenever new e-mail arrives or whenever the user sends out new e-mail messages. Once in the filebase, one advantage is that e-mail can be organized in categories, using the category field. This type of organization is far better than the folder method because multiple categories can be placed in the category field, thus effectively placing the e-mail in multiple folders without having to physically copy the e-mail into other folders and making it much easier to retrieve a given file because it has been filed under a variety of categories. Another advantage is that the user can query e-mails so that only certain types of e-mails are displayed: for example, only e-mails from a particular sender, only e-mails with a particular subject, only e-mails sent on a particular date, and so on. Outlook 2007 has this feature, but Outlook 2003 does not. Additionally, one can compose e-mails from the LOST filebase.

Attachments: another very useful aspect of using LOST with e-mails has to do with attachments. First, they are downloaded faster than they can be downloaded in Outlook. LOST can be programmed so that with one click attachments in a group of e-mail messages are: (a) downloaded into the Master Shellset one by one and left unopened or (b) downloaded and, if desired, opened one by one. This happens much more quickly than in Outlook because the user can select a group of e-mail messages from which to download attachments and then the process of downloading the attachments occurs with one click. In Outlook, attachments must be first opened individually and then saved to be downloaded apart from the e-mail container. Further, in the case of photo files, once e-mails with attachments have been selected, the attachment photo files are downloaded and opened much more quickly in LOST than can be done by manually clicking on attachments and opening them using Outlook.

In some cases the user opens an e-mail and wants the attachments in just that e-mail downloaded (rather than the attachments in a group of selected e-mails). In LOST there is a button so that just those attachments in an opened e-mail are downloaded (and opened, if desired) into the Master Shellset.

Second, files can be uploaded much more quickly as attachments to a new e-mail than they can in Outlook. The process is more efficient than in Outlook because in Outlook the user must upload attachment files from one folder before opening up another folder and uploading files from there, whereas in LOST the user can check checkboxes for certain shells in one shellset, then move to another shellset and check checkboxes there, etc. and, in an embodiment, only when finished does he/she hit the upload button once to load the selected files.

(2) Programs that work with music files: on the music file form, there is a button which, when clicked, plays selected music files (those music file shells that have their checkbox checked) one-by-one in sequence. When doing so, the user is prompted to see if he/she can like to name the particular playlist or selection of music files. Once named, the same selection can be retrieved using the name chosen. Further, additional features can be added so that the music files in a playlist can be re-ordered and then that modification saved under a new playlist name. Thus, with LOST there is a very straightforward way to select tunes to play in sequence and, secondly, the selection of tunes can be named and retrieved again from then onward.

Further, it should be mentioned that LOST enables users to access music files remotely, using a version of the Remote program. This remote capability means that LOST can be used by a DJ, for example, standing on the dance floor to check the acoustics and to communicate with the computer running the music selections in another room.

Another feature of programs with music files is multiple message downloads. Using LOST, one can click on a participating website (for example, if Borders uses LOST), then click to open an album, then click on individual songs, and do the same with other albums. Then click on a button that can automatically send each music file as a single attachment in an e-mail message (alternatively, an e-mail message can include multiple attachments up to a certain limit) to a chosen e-mail address. This way music files can be downloaded via e-mail to e-mail addresses. Further, using LOST, a user can check off a group of music files and then send them as a bunch of e-mail messages to, say, an IPOD-like computer in his car, thereby loading music files. Further still, using LOST, one can send, along with the music messages, a message containing the category information so that the music files can be properly categorized. With LOST, users can have an e-mail address for regular e-mail and another e-mail address for receiving messages with music. This way, only the music e-mail address, and not their regular address, is tied up during the download process.

(3) Warehouse: warehouse is a program that uploads into the Master Shellset all non-e-mail messages from a directory called “warehouse”. For example, Word, Excel, and a scanner driver can be programmed so that the default directory for any saved document or file is “warehouse”. This means that work in Word, Excel, or in scanning documents is initially saved in the warehouse folder. With a click of the Warehouse button in LOST, these files are moved to the LOST directory and their respective shells are loaded to the Master Shellset. The advantage of this program is that the user of Word, Excel, and the scanner (and other programs, too) does not have to worry about where to save individual files or even whether to give them names. Using program default folder settings and the Warehouse button, his/her work can be automatically placed in the LOST directory and in the LOST Master Shellset, with each file given a unique, sequenced ID number. If the file has a name, this name can appear in the Master Shellset's Item field. If not, one can be added. He/she can still categorize the file using the category field. However, the user does not need to worry if he/she forgets to do so, since the file and shell are properly loaded in the LOST directory and in the Master Shellset and can be found later even if it has not been categorized. (The file shell can display the file's name, creation date, size and ID number automatically.)

(4) Folder Converter: the folder converter program enables a user to convert files organized in folders into files organized by categories in the category field. Folder Converter is designed, also, to move the files out of their folders and place them in the LOST folder or directory. In an embodiment, Folder Converter can operate so that files are not moved, but rather are copied. Alternatively, LOST can run on files left in their original folders, with the path of each folder forming the categories used by LOST.

(5) Remote: LOST's remote program can add considerable functionality to Blackberry devices (or an IPOD-like device), whether to retrieve files or to remotely activate the computer to perform other tasks. In an embodiment to guard against viruses or intruders, LOST can be configured so that a user can hook up his/her Blackberry to the computer for a brief moment to download a new, randomly generated, password onto the Blackberry which both the computer and the Blackberry recognize. This ensures that the computer only responds to messages sent by that Blackberry. As further protection, another password can be used to use Remote with the Blackberry. This guards against the possibility of someone else trying to use the Blackberry to access the user's computer. Also, via the hookup to the computer, the Filter can be downloaded on the Blackberry to aid in or eliminate the first step of the process outlined above.

In another embodiment, Remote can be used with voice recognition software. LOST makes this very easy, because once the Filter is loaded into the Blackberry, the next two steps involve passing numbers to the computer to reach any file. The Filter and the Master Shellset can be loaded into the Blackberry each time the Blackberry is connected to the home computer. This means that the user can then have at his fingertips the information he needs to find any file on his home computer and ask for it via just one e-mail request. Using a unique number (or a set of unique numbers if he wanted more than one file), he can have the file(s) sent to him. (Additionally, the Filter and Master Shellset can be retrieved to the Blackberry via a unique number.) For this reason, in an embodiment, the incorporated voice recognition software needs only to be able to recognize numbers or digits and does not need to be very sophisticated.

(6) LAN E-mailing: LOST makes it very easy to e-mail others over a local area network without using actual e-mail messages. Users can put the name of the recipient in a shell field. The recipient can then click on a button (alternatively, a program can periodically click the button or otherwise cause the routine to be executed) to run a query (which can contain his name) against the shared filebase and the shell having his name is returned. He then can view the hyperlinked file (e.g., the “e-mail message” “sent” to him). He can then reply by writing a new document (which can automatically be attached to a shell) and then putting in the sender's name so that the sender can get it when his program ran a query on the shared filebase. Such a system can be linked to the outside Internet so that users can also send e-mails outside the system. The connection point to the Internet can be guarded by virus protection software, which guards the whole LAN.

(7) Working with Web Applications and Websites: LOST processing makes organizing personal e-mails on Hotmail, Yahoo and Gmail sites much easier than this is done currently. Gmail has started enabling users to tag their e-mails as well as putting them in folders. LOST processing takes this process one step further by adding a category field to the e-mail list and a Filter table. Used in combination with dropdown boxes on the page as in a typical LOST form, e-mails can be “tagged” and thereby effectively “filed in folders” as well. As explained above, the Filter table can contain a field denoting the file type, which users can then use to view certain types of files—documents, spreadsheets, music files, e-mails, etc. Further, the Filter can also contain a field holding the user's ID (or the user's password). Thus, when the user queried the site he/she can view those e-mails and attachments belonging to him/her, and thus a Master Filter can be used for a site. (In an alternative embodiment, a single Filter can be used for a collection of users.) The “folder converter” program can be used with Web Applications to fully turn folders into categories and a master folder.

Websites currently in use appear at most to use non-categorized tags and folders to organize links to other sites or pages. Instead, LOST can be used, complete with dropdown boxes on the webpage, to more effectively organize links to other sites and pages using LOST categories and LOST's Filter system. With LOST, sites can be designed to enable users to assign their own categories to a site filter table, much like the shared filter table described in the paragraph above. If desired, the site owners can provide this feature for a fee. Thus, for example, BBC World News can have dropdown boxes enabling: (a) nonpaying users to view links and webpages passively organized by categories assigned by BBC and (b) paying users to view links and webpages actively organized in the manner of their choosing. Folder Converter can be employed by the web designers to convert folders into categories.

LOST enables users to open shells in a shellset in sequence with one click. Users with LOST can organize favorite websites in their individual LOST filebase by copying website addresses into the hyperlink field. Then, when browsing favorite news sites, for example, by one click on a button termed “news”, for example, the users can open up multiple websites in succession for viewing. This rapid opening of websites particularly pays off where links to the Internet run very slowly such that users click to open one site, wait for it to open, then close it to open another and again wait. Moreover, websites with LOST installed can offer this same capability to users viewing that particular website—meaning, viewers of the website can click on a number of links on the website and then press a button on the website to have them opened automatically.

(8) LOST can also be used for organizing and retrieving any collection or group of files, including GIS files.

(9) “Command Sentences”: another feature of LOST exploits the sequential command aspect of moving from record to record (shell to shell) in a shellset to connect “commands”. The result, then, is that by using LOST the user can type in a “command sentence” to his desktop computer—or send the same “command sentence” to a remote computer—to make the computer carry out a series of command tasks. This works is as follows. A form is loaded in LOST (call it a “command form”), with a “command” word—say, “refresh”—put in a field of a shell in the form. The command word is linked to a VBA command. Other shells are added, each with a command word or command phrase in the same field of each shell. Thus, for example, the shells with the following command words or phrases in them (one word or phrase per shell) can be produced: “select shellset X”, “check all”, “load as e-mails”, “send to X”. Then, the user can construct a sentence as follows: “select shellset X, check all, load as e-mails, send to X”. He can then press a button and the computer can then check off the shells with the respective words or phrases in the order of the sentence, then process them sequentially and thereby execute a series of commands. Alternatively, in a voice recognition embodiment, voice commands, rather than typed commands, can be used. Additionally, as noted above, command sentences can also be sent to remote computers so that they perform a series of actions.

### Data Item Retrieval Method and Apparatus II

Illustrative embodiments of the present invention include but are not limited to methods and apparatuses for organizing and retrieving files or data items based on shells, categories and filters.

The term “LOST” (which stands for “Locked, Ordered Shell and Table”), as used herein, refers to techniques for organizing and retrieving files or data items based on shells, categories and filters.

The term “shell”, as used herein, refers to a tuple of values, such as size, location, file extension, etc. which can be used to characterize a file or data item.

The term “master shellset”, as used herein, refers to a shellset of all known shells.

The term “filebase”, as used herein, refers to the combination of a master shellset, a filter table, and the associated queries.

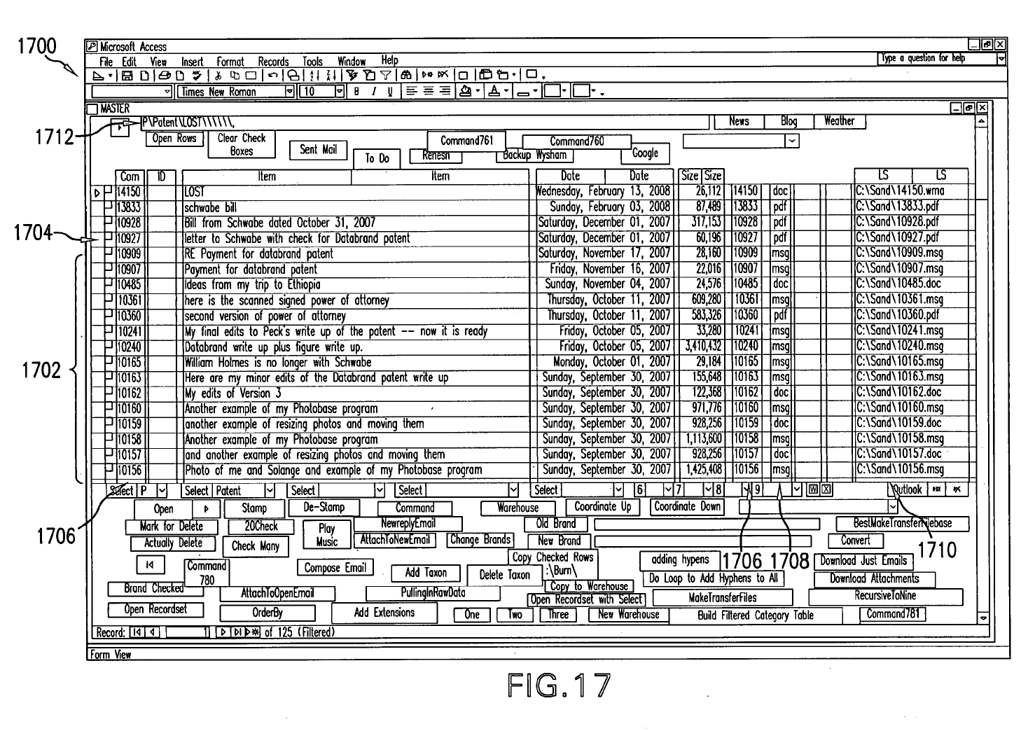

FIG. 17 illustrates a screen shot of an example of a table including a shellset. As illustrated, a LOST interface 1700 can provide a user with a shellset 1702 including a plurality of shells 1704, the shells describing files or data items. As further shown, each shell can include a number of fields, such as a coordinate field 1706, a file extension field 1708, and a hyperlink/location field 1710. In various embodiments, the LOST interface 1700 can provide a user with numerous mechanisms for organizing and retrieving files/data items based on shells 1704 and their contents. The hyperlink field 1710 in a shell 1704 can link the shell 1704, and thus its other fields, to a specific file.

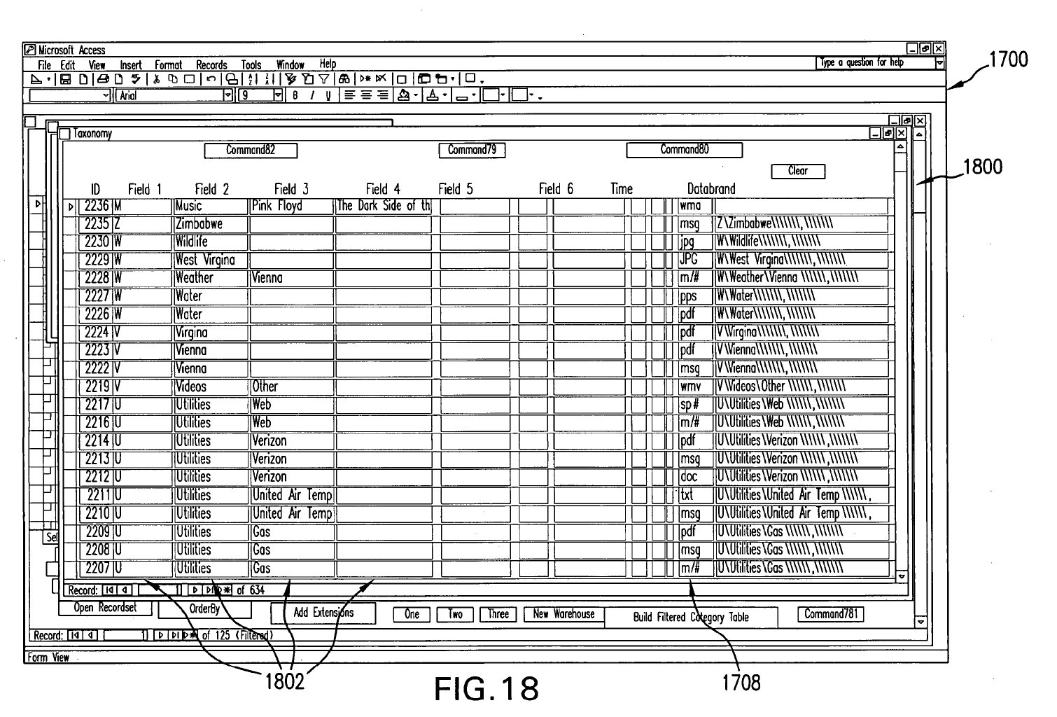

FIG. 18 illustrates a screen shot of an example of a filter table. As shown, LOST interface 1700 can further provide a user with a Filter Table 1800. The Filter Table 1800 can include multiple category fields 1800 for each shell 1704, as well as other fields, such as file extension field 1708 to describe the shell 1704. In various embodiments, the categories and/or file extensions can be used to filter the shells 1704 shown in Filter Table 1800.

In various embodiments, a shell 1704 can be similar to what is termed a “tuple” in SQL and a “record” in Windows Access. Shells, however, can differ from SQL in at least one respect: one or more of a shell 1704's fields often contains more than just one value. In SQL tables must be “normalized”, a process that, among other things, results in each tuple's field having one and only one value. In LOST, however, a shell 1704 can include a “category” field where at times several “classifications” or “brands” (i.e., categories) are placed.

In some embodiments a group of related shells 1704 (for example, those shells 1704 returned when a query is run) can comprise a shellset 1702. Such a shellset 1702 can be similar to the “recordset” of MS Access, which comprises a group of records.

In various embodiments, multiple categories are stamped into the category field(s) 1802 (see FIG. 18). The categories can define the shellset 1702 that can be retrieved (in order to use a particular file). Also, the categories follow a pattern of increasing specificity, as shown in the Filter Table 1800 in FIG. 18, enabling the user to retrieve shells 1704 as sets, sub-sets, sub-sub-sets, and so on. Further, categories can be assigned that not only locate or describe the file, but also denote the need for some action to be taken, such as “to do” or “followup”. A user might have a button on a form labeled “To Do”, by which he can instantly call up all shells 1704 that describe files requiring attention.

As is further shown, each shell can include an ID field 1706 of the Master Shellset. The ID field 1706 can carry a value that is unique across all shells 1704 in a shellset 1702 or in the Master Shellset. That is, there can be no duplicate values of a particular shell 1704's ID field 1706 in any other shell 1704 in the Master Shellset. In some embodiments, the value in the ID field 1706 is repeated in the first part of the file name shown in hyperlink field 1710 (hereinafter referred as a “coordinate”, the value of the ID field 1706 being repeated in coordinate field 1706). By including the ID field 1706 value in the file name, the shell 104 becomes effectively “locked” to the file.

In some embodiments, this shell-to-file-name “locking” aspect of LOST can require that two conditions are true. First, it must be true that the path given in the hyperlink field 1710 is the correct path for the associated file. Second, it must be true that the first section of the file name in the hyperlink field 1710 (i.e., the coordinate) is identical with the value in the associated shell 1704's ID field 1706. The need for the second condition can arise if, for some reason, the files somehow become separated from their associated shells 1704 (say, when the files are copied and given to someone without the associated shells 1704). To join the files and their associated shells 1704, logic of LOST can process the file names, splitting out the coordinate and putting this number into a field designated as the “primary key” field (a SQL term) of a new table. This table then can be combined with the shellset 1702 for the files, relating both by making the shellset 102 for the files use its coordinate field 1706 as its “primary key” field as well. The result can be a shellset 1702 that has hyperlinks showing the first part of the file name (its coordinate) matching the ID field 1706 and the coordinate field 1706.

In various embodiments, LOST can include logic that downloads e-mails automatically into the LOST filebase. In some embodiments, the logic can select multiple files and send them out as multiple e-mail messages automatically. Such logic can further select sets of e-mails to be displayed, based on categories or file attributes. Also, such logic can rapidly download e-mail attachments (and in some cases open the attachments, too) into the LOST filebase and upload e-mail attachments. Such logic can allow the user to compose e-mails while in the LOST filebase.

In some embodiments, logic of LOST can transfer e-mail into the Master Shellset with one click or, alternatively (depending on the user's choice), the transfer can occur whenever new e-mail arrives or whenever the user sends out new e-mail messages. Once in the filebase, one advantage is that e-mail can be organized in categories, using the category field(s) 1802. This type of organization is far better than the well-known folder method because multiple categories can be placed in the category field, thus effectively placing the e-mail in multiple folders without having to physically copy the e-mail into other folders and making it much easier to retrieve a given file because it has been filed under a variety of categories. Another advantage is that the user can query e-mails so that only certain types of e-mails are displayed: for example, only e-mails from a particular sender, only e-mails with a particular subject, only e-mails sent on a particular date, and so on.

Also, as mentioned, logic of LOST can rapidly download e-mail attachments. LOST can be programmed so that with one click attachments in a group of e-mail messages are: (1) downloaded into the Master Shellset one by one and left unopened or (2) in the case of photo files, downloaded and, if desired, opened one by one. This happens quickly because the user can select a group of e-mail messages from which to download attachments and then the process of downloading the attachments can occur with one click. Further, in the case of photo files, once e-mails with attachments have been selected, the attachment photo files can be downloaded and opened much more quickly in LOST than can ever be done by manually clicking on attachments and opening them.

In many cases the user opens an e-mail and wants the attachments in just that e-mail downloaded (rather than the attachments in a group of selected e-mails). LOST interface 1700 provides a button so that just those attachments in an opened e-mail are downloaded (and opened, if desired) into the Master Shellset.

In various embodiment, files can be uploaded much more quickly as attachments to a new e-mail. The process is efficient because, in LOST, the user can check boxes for certain shells 1704 in one shellset 1702, then move to another shellset 1702 and check boxes there, etc., and when finished does he/she hit the upload button to load the files.

In some embodiments, LOST can include logic that enables the user to quickly create “playlists” for music files. In one embodiment, LOST can enable users to organize a music filebase passively, that is, by assigning fields to any/all of the file attributes that come with the file—composer, length, artist, etc. (To see attributes that come with a file, one can, for example, examine a file's properties in Microsoft, using the advanced summary page). In a further embodiment, such logic can enable music vendors to add additional attributes to music files, knowing that by using LOST, listeners can organize their files with any or all of these attributes.

In various embodiments, on a music file form, there is a button which, when clicked, can play selected music files (i.e., those music file shells 104 that have their checkbox checked) one-by-one in sequence. When doing so, the user can be prompted to see if he/she can like to name the particular playlist or selection of music files. Once named, the same selection can be retrieved using the name chosen. Further, additional features can be added so that the music files in a playlist can be re-ordered and then that modification saved under a new playlist name. Thus, with LOST there is a very straightforward way to select tunes to play in sequence. Also, the selection of tunes can be named and retrieved again from then onward.

In some embodiments, logic of LOST can enable a user to click on a participating website (for example, if Borders uses LOST), then click to open an album, then click on individual songs, and do the same with other albums. The logic can then enable the user to click on a button that can automatically send each music file as a single attachment in an e-mail message (or, in one embodiment, the e-mail can hold multiple attachments) to a chosen e-mail address. Thus, music files can be downloaded via e-mail to e-mail addresses. Further, using LOST, a user can check off a group of music files and then send them as a bunch of e-mail messages to, say, an IPOD-like computer in his car, thereby loading music files. Further still, using LOST, a user can send along with the music messages a message containing the category information so that the music files can be properly categorized. With LOST, users can, for example, have an e-mail address for regular e-mail and another e-mail address that they can want to use for receiving messages with music. This way, they can use only the music e-mail address and not their regular address during the download process.

In various embodiments, LOST can include warehousing logic that loads non-e-mail messages into the Master Shellset—for example, jpg photo files, music files, Word documents, Excel spreadsheets, pdf format files, a file that can be activated by a hyperlink. Such warehousing logic can ensure that each file is identified by an ID value, by size, and by date (fields that are automatically filled when files are loaded), even if the user does not give the file a particular name. This can make saving files more secure, more efficient.

In various embodiments, the warehousing logic can upload into the Master Shellset all non-e-mail messages from a directory called “warehouse”. In one embodiment, “warehouse” can be a default directory for other programs. With a click of a Warehouse button in LOST interface 1700, these files can be moved to the LOST directory and their respective shells 1704 can be loaded to the Master Shellset. The advantage of this program is that the user does not have to worry about where to save individual files or even whether, initially anyway, to give them names. Using program default folder settings and the Warehouse button, all of his/her work can automatically be placed in the LOST directory and in the LOST Master Shellset, with each file given a unique, sequenced ID number. Should the file have a name, this name can appear in Master Shellset's Item field. If not, one can be added. Of course, he/she can still want to categorize the file using the category field. However, the user need not worry if he/she forgets to do so, since the file and shell 1704 is properly loaded in the LOST directory and in the Master Shellset and can be found later even if it has not been categorized (the file shell 104 can display the file's name, creation date, size and ID number automatically).

In various embodiments, Word and Excel icons, which can appear on the LOST interface 1700, are associated with logic that can open a new Word document or Excel spreadsheet with a mouse-click. After the user is finished working on the item, he can merely close it and it can be automatically dropped in the Master Shellset 1702, each item linked via a hyperlink to its respective shell, and saved as in the paragraph above.

In various embodiments, LOST can include folder conversion logic that can convert a folder tree of files (a folder tree is a folder with a set of sub-folders, themselves having sets of sub-folders, etc) into categorized shells 1704 in the Master Shellset, which can be linked to files by their respective hyperlinks. In one embodiment, such conversion logic can move the files out of their folders into LOST's common directory (or folder), copying the folder names as categories in the category field. In another embodiment, such conversion logic can leave the files in their folders, while copying the folder names as categories into the shell category field. In yet another embodiment, such conversion logic can make copies of the files in folders and place these copies in the common directory, again copying the folder names as categories in the category field.

In some embodiments, the folder conversion logic can enable a user to convert files organized in folders into files organized by categories in the category field 1802. The folder conversion logic is designed, also, to move the files out of their folders and place them together in the LOST folder or directory. However, the folder conversion logic can be modified so that files are not moved, but rather are copied. Or, in one embodiment, LOST can run on files left in their original folders, with the path of each folder forming the categories used by LOST.

In some embodiments, LOST can include file transfer logic that enables a user to transfer a set of files along with the files' respective shells 1704 to another filebase.

In various embodiments, LOST can include filter table creation logic that runs off of a shellset 1702 to create a corresponding filter table 1800 for the shellset 1702.

In some embodiments, LOST can include storage logic that divides the collection of files into storage folders, each holding a set number of files. Such logic can make handling files more user friendly, because folders that contain thousands of files can be broken down automatically using the storage logic into folders that contain a more manageable number—such as 500 files each. Also related LOST can include related deletion logic that removes unwanted files from the Master Shellset to another “delete” shellset and then gives the user the option to delete them from the computer altogether by deleting them from the “delete” shellset. This logic can be used very efficiently to eliminate the clutter of unused files, more efficiently than the current folder system which requires folders to be opened and the contents examined.

In some embodiments, logic of LOST can help with copying files as well. In LOST the shells 1704 of files can be tagged before the copying occurs, again without the need to open and close folders. Then with one click the files can be copied. Further, LOST can be used to print multiple documents or files as well.

In various embodiments, LOST can include logic that allows the user to retrieve files remotely from his home computer. The process can be as follows: (1) The user can send a message to his home computer (or office computer, for that matter), requesting a copy of a Filter Table 1800, which the computer can send back as a report. (2) Next, he can send the remote computer the ID value of the category (row) in the Filter Table 1800 to him, which the computer can use to query the Filter Table 1800 and return a shellset 1702 of files by sending the home computer a number. In response, the computer can send him, as a report, the shellset 1702 corresponding to that row or category. (3) The next step the user can look over the shellset 1702 report, identify the file or files he wants and send this number (or these numbers) to the computer, whereupon the computer can send him back an e-mail with the files attached. Such logic can be modified so that, instead of the files being e-mailed, they are activated remotely to perform some task—turn on music, turn on lights, activate a burglar alarm, turn on a water sprinkler system, etc.

In various embodiments, LOST's remote access logic can add considerable functionality to PDA devices, such as Blackberry or other smartphone devices, whether to retrieve files or to remotely activate the computer to perform other tasks. To guard against viruses or intruders, a program can be written that can rely on the user hooking up his/her Blackberry to the computer for a brief moment to download a new, randomly generated, password onto the Blackberry which both the computer and the Blackberry can recognize. This can ensure that the computer can only respond to messages sent by that Blackberry. As further protection, the program can be modified so that the user can still be obliged to enter another password to use the remote access logic with the Blackberry. This can guard against the possibility of someone else trying to use the Blackberry to access the user's computer. Also, via the hookup to the computer, the Filter Table 1800 can be immediately downloaded on the Blackberry, making the first step of the process outlined above unnecessary.

In one embodiment, the remote access logic can include voice recognition software. LOST makes this very easy, because once the Filter Table 1800 is loaded into the Blackberry, the next two steps can involve passing numbers to the computer to reach any file. (In another embodiment, the Filter Table 1800 or Master Shellset can be retrieved to the Blackberry via a unique number, too). The Filter Table 1800 and the Master Shellset can be loaded into the Blackberry each time the Blackberry was connected to the home computer. This means that the user can then have at his fingertips the information he needed to find any file on his home computer and ask for it via just one e-mail request. Using a unique number (or a set of unique numbers if he wanted more than one file), he can have the file(s) sent to him. Such voice recognition software would only have to recognize numbers or digits.

In various embodiments, the Filter Table 1800 can contain a number of category fields 1802 and a field for file extensions 1708. By including the extension field 1708, the Filter Table 1800 can contain the categories used by the files, but nonetheless use only categories related to certain file types. When a user views e-mail messages (a file type that carries the “msg” extension), the user can only see categories the user has placed on e-mail messages when clicking on the dropdown boxes and not be distracted by categories placed on other types of messages. Further, by having an extension field 1708 in the Filter Table 1800, the dropdown boxes in the form offered by LOST interface 1700 can be programmed to only reveal those categories relevant to certain file types.

In various embodiments, different form designs can then be employed to highlight features of different shellsets 1702, displaying particular file attributes in particular fields. For example, an e-mail form can be built that displays the following useful fields: sender, receiver, subject, date, size. A music form might have the following fields: title, composer, artist, and length. A photo form might use these fields: title, location, date. And thus one Filter Table 1800 can serve as the basis for a multiplicity of forms.

The Filter Table 1800 can contain any number of additional useful fields—say, the names of particular users who jointly use the Filter Table 1800 in a local area network (or access a website—see below). This arrangement can enable a database manager to select particular Filter Table 1800 categories for particular users based on the presence (or absence) of their name in the Filter Table 1800 name field.

In various embodiments, LOST can make it very easy to e-mail others over a local area network without using actual e-mail messages. Users can put in the name of the recipient in a shell 1704 field. The recipient can then have to click on a LOST interface 1700 button (and this button can be clicked automatically by a program, say every five seconds) to run a query (which can contain his name) against the shared filebase that can return the shell 1704 having his name, and he/she then can view the hyperlinked file. The recipient can then reply by writing up a new document (which can automatically be attached to a shell 1704) and then putting in the original sender's name so that the sender can get it when his program ran a query on the shared filebase. Such a system can be linked to the outside Internet so that users can still send e-mails outside the system. The one connection point to the Internet can be guarded by virus protection software, which can guard the whole LAN. Such a LAN can be accessed remotely by users with LOST technology, too.

In some embodiments, LOST processing can make organizing personal e-mails on various web mail services, such as Hotmail, Yahoo and Gmail sites, much easier than done currently. For example, Gmail, enables users to tag their e-mails as well as putting them in folders. LOST processing can take this process one step further by adding a category field to the e-mail list and the Filter Table 1800. Used in combination with dropdown boxes on the page as in a typical LOST form, e-mails can be “tagged” and thereby effectively “filed in folders” as well. As explained above, the Filter Table 1800 can contain a field denoting the file type, which users can then use to view only certain types of files—documents, spreadsheets, music files, e-mails, etc. Further, the Filter Table 1800 can also contain a field holding the user's ID (the user's password, perhaps). Thus, when the user queried the site, he/she can only view those e-mails and attachments belonging to him/her, and thus only one Master Filter would be needed for the whole site (also, if this proved unworkable because of the huge number of users, the site designers can assign one Filter Table 1800 to only a proportion of users). The above-mentioned folder conversion logic can be used with web applications to fully turn folders into categories and one master folder or to partially do so, leaving files in their folders.

Websites currently in use appear at most to use non-categorized tags and folders to organize links to other sites or pages. In various embodiments, LOST can be used instead, complete with dropdown boxes on the webpage, to more effectively organize links to other sites and pages using LOST categories and LOST's filter system. Further, sites can be designed enabling users to assign their own categories to a site filter table, much like the shared filter table 1800 described in the paragraphs above. Thus, for example, BBC World News can have dropdown boxes at the bottom enabling: (1) nonpaying users to view links and web pages passively organized by categories assigned by BBC and (2) paying users to view links and web pages actively organized in the manner of their choosing. Again, folder conversion logic of LOST can be employed by the web designers to convert folders into categories.

In some embodiments, LOST can enable users to open shells 1704 in a shellset 1702 in sequence with one click. Users with LOST can organize favorite websites in their individual LOST filebase by copying website addresses into the hyperlink field 1710. Then, when browsing favorite news sites, for example, by one click on a button termed “news”, the users can open up multiple websites in succession for viewing. This rapid opening of websites can particularly pay off where links to the Internet run very slowly, and users click to open one site, wait for it to open, then close it and open another, again waiting. Moreover, websites with LOST installed can offer this same capability to users viewing that particular website—meaning, viewers of the website can be able to click on a number of links on the website and then press a button on the website to have them opened automatically.

In some embodiments, LOST can be used for organizing and retrieving any collection or group of files, including GIS files.

In various embodiments, LOST can provide a user with a command interface into which the user can enter command sentences. Such a mechanism can exploit the sequential command aspect of moving from shell 1704 to shell 1704 in a shellset 1702 to connect “commands”. The result, then, can be that by using LOST, the user can type in a “command sentence” to his desktop computer—or send the same “command sentence” to a remote computer—to make the computer carry out a series of command tasks. In some embodiments, a command interface/form can first be loaded in LOST with a chosen “command” word—say, “refresh”—put in a chosen field of a new shell 1704 in the new form. The command word can be linked to a logical expression, such as a VBA command. Other shells 1704 can then be added, each with a command word or command phrase in the same chosen field of each shell 1704. Thus, one might have shells 1704 with the following command words or phrases in them (one word or phrase per shell)—“select shellset X”, “check all”, “load as e-mails”, “send to X”. Then, the user can construct a sentence as follows: “select shellset x, check all, load as e-mails, send to X”. He can then press a button and the computer can then check off the shells 104 with the respective words or phrases in the order of the sentence, then process them sequentially and thereby execute a series of commands. In advanced computers voice recognition can be used rather than typed commands.

### Two Methods of File Retrieval and Manipulation: “Relay” and “Monitor”

Most filing systems are organized by a hierarchy of folders, an aspect of which is referred to in computer science as a “path”. The file name is at the end of the file path. This sort of folder filing system can be represented by two spreadsheets (or tables), as follows:

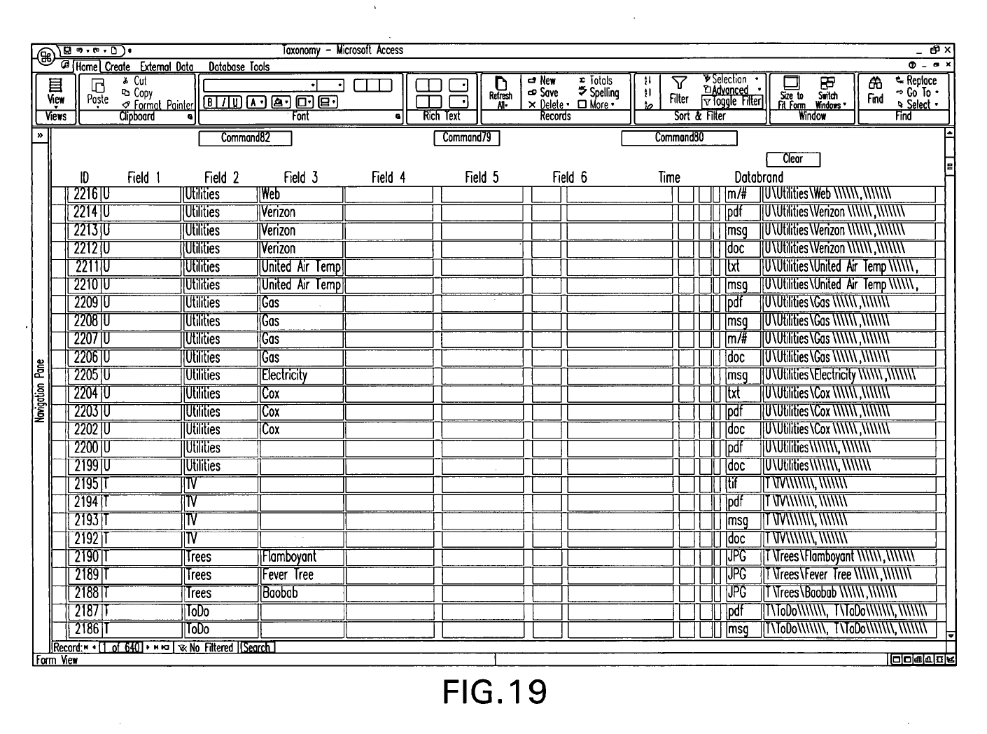

The first spreadsheet, which is referred to as the “Filter”, includes rows and columns to denote a particular folder hierarchy. Each row represents a folder in the folder hierarchy. Thus, one row can be, for example, for the folder “D\Dog\Hound\Irish Wolfhound” and another can be for “D\Dog\Retriever\Golden Retriever”. The columns denote different folder levels or tiers or fields. Thus, as in the example above, the first column can have the letter “D”, the second column can have the word “Dog”, etc. FIG. 19 illustrates an example of a Filter form. In FIG. 19, the Filter is labeled “Taxonomy”. In FIG. 19, the various folders are represented by rows. Although at first glance it can appear that the folders are repetitive (such as three versions of U\Utilities\Verizon), in actuality the folders are distinguished by their file extensions (pdf, msg, doc) as indicated in the column second from the right. Accordingly, the different rows they indicate separate folders. In an embodiment, the form illustrated in FIG. 19 is converted from a spreadsheet in the application.

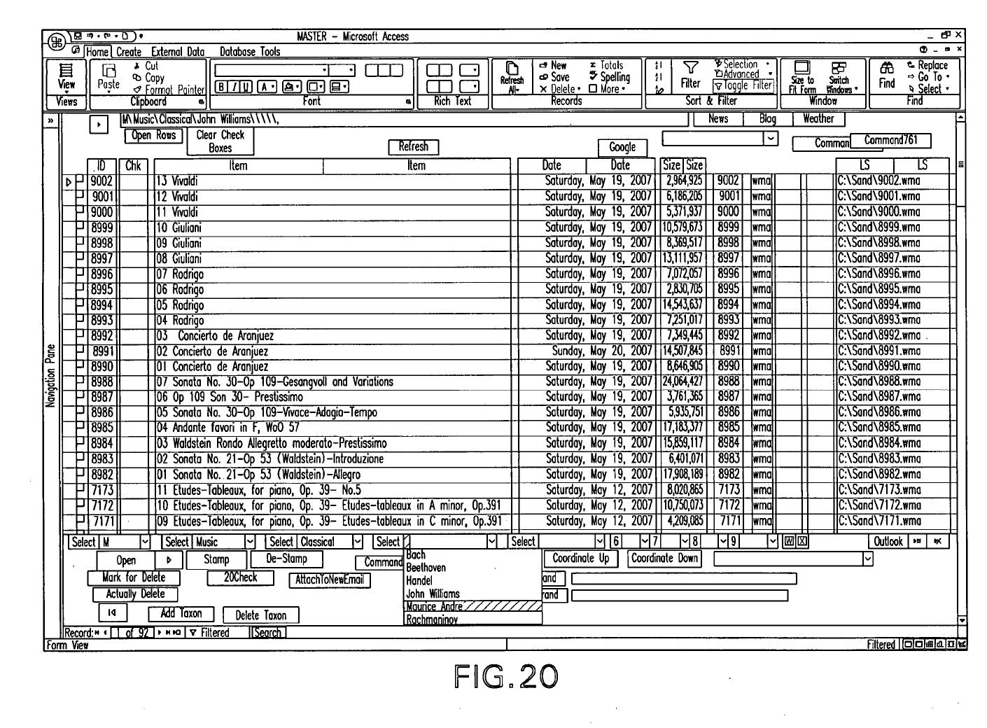

The second spreadsheet, which is referred to as the “Master”, includes rows and columns. Each row represents a file (or a webpage). The first column can, for example, hold a checkbox. Subsequent columns can hold other aspects of the file including the file path as a hyperlink to the file. The file path can appear, for example, in the column on the right. FIG. 20 illustrates an example of a Master form. The Master form in FIG. 20 includes a check box in the column second from the left and a hyperlink column at the right side. The Master Form also includes, for example, a text box near the top which identifies the hierarchy of the folder. Here, for example, “M\Music\Classical\John William\\\\\,”. In an embodiment, the form illustrated in FIG. 20 is converted from a spreadsheet in the application. This form can be converted back into a spreadsheet when the application is run.

In an embodiment, the two spreadsheets (or tables) can be generated from any computerized filing systems using folders or a website that organizes data in folders including, for example, GIS software.

In an embodiment, the application is written in Microsoft's VBA. In other embodiments, the application can be written in Visual Basic or any other computer language that enables the user to employ such spreadsheets to retrieve files (of many types) via e-mails in the following manner.

### “Relay”

The user, on his smartphone or on a laptop or any computer, sends an e-mail message to the computer, referred to here as the “server,” that holds the file or files he wants. In response, the server computer replies by sending its Filter spreadsheet, giving the folder hierarchy. This Filter spreadsheet is automatically downloaded upon retrieval by the user and converted into a table, which is the source table for a form, referred to here as the Filter form. The user then sends another e-mail to the server, requesting the second spreadsheet, the Master. It arrives and, like the Filter spreadsheet, is converted automatically into a table that forms the source for a Master form. The user then opens the Master form, which displays the set of the files (or web pages) in a continuous-page recordset. In the footer area of the Master form there is a row of dropdown combo boxes. These combo boxes are linked to the Filter form (which need not be opened), with, for example, the leftmost combo box displaying data in the first field when pressed—in the folder hierarchy of “D\Dog\Hound\Irish WolfHound”. For example, the leftmost button can display data the letter “D”. The second combo box from the left can display data in the second field, in the example above it can be “Dog”. And so on.

Using this series of combo boxes, the user can filter the Master recordset to retrieve particular rows based on the folder hierarchy he chooses by pressing a button that collects the field values, shown in the combo boxes, into a folder hierarchy string, as above, and then queries for rows that contain that string. The query returns with rows of the type selected—in effect, it returns items of a particular folder—all rows that contain “D\Dog\Hound\Irish WolfHound”, if he chooses the folder of the example above. To select a file or web page for retrieval, he finds, among the rows displayed, the row containing the file name of interest, and he clicks the check box for that row. When done clicking the checkboxes, he presses a button that runs a query against the recordset. This time the program selects only those rows with checked checkboxes. The resulting table is then converted into a spreadsheet and automatically e-mailed to the server. Upon arrival, the spreadsheet is converted back to a table, against which a query is run that uses the hyperlink field of each row to attach the linked file to an e-mail. The program then e-mails, back to the user, e-mails with the files attached to them.

The system above can also be made more efficient. Since users of folder filing systems sometimes move files from folder to folder, delete files, or add new files or new folders, the Master and Filter spreadsheets need to be regularly replaced in the user's computer to reflect the actual number and folder type of the files on the server. This can be done automatically, with the server sending out to the user regular updates of the Filter and the Master, which, upon receipt in the user's computer, automatically refresh the Filter and Master forms with the latest data. This means that the user does not have to manually call for the Filter or the Master. With updated Master and Filter processing on his computer, the user can select folder hierarchies, using the combo boxes in Filter, to return rows of files (or web pages) for the folder hierarchies of interest. He can then click the check boxes of the rows he chose and push a button to send back the request spreadsheet to the server (as mentioned in the above paragraph). Again, the server computer can reply by pulling up the files identified in rows by the user by their hyperlinks and then e-mailing them back to the user as attachments to e-mail messages.

If the software is added to websites, instead of sending e-mails to a server computer, requests can be made to websites for web pages in the same manner. Thus, this technology can be employed in requesting and receiving information from websites.

This technology allows the user not only to request files or webpages, but also to upload or post files and webpages from the user's computer to the server. He can also edit the names of files and webpages on the server, and delete or copy the files and webpages, if needed.

This embodiment enables users to retrieve or post/edit files and web pages remotely (wireless) or via cable/phone lines via e-mail messages by mimicking, on the user's screen, the same folder system that exists on the server, less the files themselves. Users no longer need to be “online” to make requests or to receive the resulting files. Together, these two attributes provide users with considerable freedom and new advantages. Some of the uses of this embodiment are as follows:

(1) The user, with software of this embodiment loaded on his home computer and office computer, can retrieve (or manipulate—delete, copy, replace, turn on (e.g., music files), turn off, display (e.g., photos)) files at one location while sitting at the other. In an embodiment in which this software is loaded on smartphones, users can retrieve or manipulate files on other computers or devices. Also, with this software, the user can send new files to be placed in folders on the server.

(2) A system in an embodiment of the invention is less vulnerable to viruses, because it connects online for only a relatively short period of time. The server can be activated to respond to particular phrases used by the user (in the subject line of the e-mail, for example). The response can be already coded into the server's software. Therefore, in the event that a potential intruder obtained the particular phrase the user uses to call for a particular action, this potential intruder, by sending the phrase to the server, prompts the server to respond in its programmed way, sending the response to the user instead of diverting it to the potential intruder.

(3) A system in an embodiment of the invention is safer, in that the user does not need to carry files in his laptop or smartphone while traveling, knowing that he is able to retrieve them by e-mail once he needs them. He can then delete files from the laptop or smartphone when not using them.

(4) Companies such as Borders, for example, can offer Filter and Master spreadsheets that, when imported by users, catalogue part of their folder system of interest, enabling the user to request book title files, music files, etc. In an embodiment, Borders can send regular updates to users. Lands End, for example, can send out its catalogue as a folder system of two spreadsheets to users, for their viewing and subsequent e-mail requests at leisure. The user can click the row of interest, the rows then are e-mailed back in a spreadsheet, the spreadsheet is converted into a table and then Borders or Lands End can respond by mailing (via postal mail) to the user the items selected.

(5) A system in an embodiment of the invention can automatically download attachments of received e-mails. Additionally, the downloaded attachments can be automatically opened for viewing or manipulated in some other way. Thus a newspaper can send each page as a separate attachment so that, upon arrival, every page is opened and displayed like a splayed deck of cards on the users screen—making it very easy for him to browse from page to page. Or, for example, the arriving attachments can be printed.

(6) A system in an embodiment of the invention can use several computers to work together by sending and receiving a succession of e-mails. Thus computer A can send a request e-mail, prompting computer B to send computer A the requested items, but in doing so computer B can also send along a request for computer A to carry out some action. This action can include, for example, having computer A send another e-mail to computer B (or to other computers), calling on computer B (or the other computer) to act or retrieve something. And so on.

(7) A system in an embodiment of the invention can use this application in conjunction with other software to set an alarm at home, turn on lights, etc. In another variant, software can be installed in a car alarm that, along with sending out an alarm, sends an e-mail alarm to the owner or to the police.

(8) A system in an embodiment of the invention can also be used to control drones using e-mails.

### “Monitor”

This application involves software placed on a server (the server can be a home or office computer left turned on) plus software on the user's computer or smartphone, laptop, etc. Software need not be placed on a web site, however.

The server software can call up web site pages based on e-mail requests from the user and e-mail them back to the user as files, singly or in groups, as attachments. In one embodiment, the server can call up a web site's home page, copy it as a file, and then, working from the file web page, go to each link and copy these web pages as files, too. In this fashion, the software can copy to the server the current web pages on the site. These pages or files, then, can be sent to the user as e-mail attachments. Then, by organizing the web sites' addresses in a table, upon making future calls to the web site, the software can copy to the server web pages from new web links that it found on the web page, and send these to the user periodically. Thus the user can receive the web pages from a certain site—say, for example, a blog or a news site, such as BBC—developed over time on the home web page, in this way monitoring the web site for changes.

One further application of this software involves “surfing the web by e-mail”. This is done as follows. Google sites are described in a regular manner as web path strings. Therefore, when the user sends an e-mail to the server, he can include a set of words for a Google search in the e-mail just as if he were online and using Google. The server, upon receiving the e-mail and the enclosed words, can then go to that requested Google website. The Google web page then can be copied by the server and then sent to the user.

Commercial applications include: news enthusiasts can monitor and receive, via e-mail as files (or web pages), new items posted on a web news site—CNN, BBC, etc. Companies that regularly monitor rival web sites can do so by directing the server to regularly send them web pages of new postings on the rival web sites. Blogs can be monitored in a similar manner.

Also, Google searches and web site monitoring can be accomplished passively, mostly offline. Advantageously, this can reduce costs for the online access. In poor areas in the Third World, users can employ “surfing the web by e-mail” to perform Google searches in a much cheaper manner. Although these searches can take more time, given the time for e-mail to travel on the web, the online charges can be reduced.

### “SynchMail”

In today's busy world, one common complaint is the difficulty of coordinating calendars on separate computers so that they share the same information. Another challenge is ensuring that contact lists on two or more computers (for example, a home computer, a work computer, and a Blackberry) are up to date by sharing the same contact information.

Making the information of calendars or contact lists identical among several computers without directly copying it is done via a process called “synching”. Currently this is accomplished by using software that requires an online connection, with one computer connected to one or more computers directly or remotely by WIFI, Bluetooth, or through an Internet site.

However, presented below is a different method of synching calendars and contact lists, along with passing selected calendar and contact information from one computer to another, using e-mail messages.

Calendars and contact lists built from tables can draw their tabular information from spreadsheets. In a situation in which a first calendar has all of the information needed for a second calendar, updating the second calendar with information contained in the first calendar can be accomplished by copying the spreadsheet source for the table of the first calendar into the spreadsheet source for the table for the second calendar, which essentially replaces the second calendar's spreadsheet. Similarly, one contact list can be updated from another by replacing the underlying spreadsheet of the former with that of the latter.

### SynchMail Method

After the user enters new information, edits, or deletes information in his calendar, he clicks an update button. This launches a program that makes a copy of the calendar's underlying spreadsheet and sends it as an e-mail attachment to the other computer(s). Upon arrival, the spreadsheet attachment is downloaded and replaces the spreadsheet of the calendar of the receiving computer(s), thereby producing an identical calendar on the receiving computer(s). A similar method is employed with a computer's contact list to update contact information on one or many other computers.

The method is one way to make identical versions of calendars and contact lists on other computers. The procedure can be made very secure because the spreadsheet attachments can be encrypted. And the updates can be sent automatically at pre-determined times.

On some occasions, however, rather than making entire copies of calendars or contact lists, the user can copy only selected information—certain appointments or several contacts—from one computer to another. For example, a professional can copy the information on one contact that he has on his office computer to his home computer or to his PDA.

Doing so via e-mail can require more complex procedures involving spreadsheet row indices. In the case of calendars, discrete time intervals (hours or half-hours, for example) can be indexed as unique rows or tuples in a spreadsheet, so certain appointments (which occur in discrete time intervals) can be identified and processed (edited, deleted, added, copied, etc) as needed. Additionally, if a contact list is linked to other data files (pictures, for example, of persons), these files can be listed as indexed row entries in a spreadsheet. In such cases, the file index (rather than the contact names) can be used for contact entries.

With this software, to copy an appointment or a contact entry, the user first selects it by checking a checkbox next to a particular appointment time or contact entry. To copy several dates or entries, a checkbox is checked for each desired date or entry. This done, he then clicks an update button. This launches a program by which the checked entries are copied as rows into an indexed spreadsheet, which is sent to the target computers, and upon arrival is appended to the target computer's indexed spreadsheet. Using the index as an identifier, the program then locates the original row entries in the target spreadsheet for the updated rows. (There are no original row entries in the target spreadsheet for those items not included in the target computer's calendar or contact list spreadsheet.) For those original row entries that are located, the program writes in a status column of each of these original row entries the word “inactive”. This ensures that when the user next views the calendar or contact list, he views the newly copied information and does not see old information, since the table he views can be generated from rows without the word “inactive” in the status column. The target spreadsheet (and hence the table built from it) now contains the copied rows and, when used, can display them and not the old ones.

Data files can be added to contact lists (and to calendars) as follows. One row per data file is added to the calendar or contact list spreadsheet, with each added row indexed. Each row contains a hyperlink column containing the path of the data file to link the row to the data file. The data files are in one directory or folder and carry as their file names the index code. This ensures that a row's hyperlink connects to its data file. Each row also contains a category column so that the row's category can be identified later on. Thus, in the case of data files linked to contacts, the respective category field for each data file row has a category stamped in the category column so that the row (and by extension, via the hyperlink, the data file) appears when the user requests a given category. He can, for example, select “Samuel Smith” as a requested category. In response, the program returns not only the contact entry for the contact “Samuel Smith”, but also, in a table in response to his query, rows containing links to other data files associated with “Samuel Smith” in the category field.

E-mail messages carry instructions (add, edit, copy, delete), spreadsheets, and data files as individual attachments. An e-mail message carrying a replacement spreadsheet to update an entire calendar or contact list can, for example carry two attachments: (1) a one-row spreadsheet with instruction terms in key columns, which the target computer receives and uses to act on the e-mail and (2) a second attachment spreadsheet containing a copy of the calendar or contact list. An e-mail message carrying a data file (a photograph of a contact, for example) to be added to the target computer's contact list can carry three attachments: (1) the instruction spreadsheet, (2) a spreadsheet with the row entry information for the data file, and (3) the data file itself. In this manner the message is less visible to potential intruders (because there is nothing to read in the body of the message). Additional protection can be realized by encrypting the attachments.

There are several practical advantages to using e-mail updates for “synching” information in calendars and contact lists rather than by a technique requiring an online connection. First, the method in this embodiment of the invention is more convenient and robust in that it is not necessary that the source calendar or contact list's computer be connected with the target device or devices. Thus, even if the target computer(s) are offline, the user can still send off an updated calendar or contact list e-mail message. The target computer(s), once back online, can receive the message attachments and the calendar or contact list can be updated afterwards. The user need not worry, therefore, in terms of getting the synching finished, whether the target computer(s) were online or not. He can “fire and forget”, and the work of updating can be done. Using synch software that required a constant connection, however, means that the user has to wait until a connection to the target is established. Additionally, if this connection fails in the midst of synching, he has to start all over again.

Moreover, the computer can be programmed to send out updates via e-mail at regular intervals.

Further, the method in this embodiment of the invention requires less bandwidth than the online method, since the spreadsheets and data files can be delivered in small packets. The online method, on the other hand, requires a larger bandwidth in order to run the synch software connecting both source and target while sending the information. This means that the updating or synching in this embodiment of the invention can occur in wireless areas used by cell phone users, in addition to WIFI hotspots.

Also, rather than eliminating information by deleting an entry for an appointment, contact or file, this software writes “inactive” in the status column of rows no longer used. Therefore, rows are not actually be deleted. Instead, in default viewing, “inactive” rows are not presented for viewing. This means that the data in such a row or linked to such a row later can be retrieved, if needed. The entry can be inactive but it is not gone.

Additionally, in an embodiment in which the software is loaded on Yahoo, Google, Hotmail, or Blackberry servers, the user can: (1) know that these target servers are awake and ready to process incoming messages, (2) store contacts or/and calendars and data files on these servers, and (3) retrieve, edit, or delete the information at any Internet café, in the event that the used does not have with him his desktop, laptop, personal digital assistant, or a smart phone.

### Universal Filing System

The following is a description of a Universal Filing System (UFS). Such a system is termed “universal” because it can be used as a filing system for shareable computer files on sets of computers.

Features of the Universal Filing System include:

(1) Computers (henceforth termed “servers”) functioning in a UFS network are running and configured to support e-mail. They do not, however, need to be “online”.

(2) The e-mail addresses in a UFS network are known as the addresses of “mailsites” (much like URLs are the addresses of websites). Mailsites hold e-mail addresses of other mailsites on the network so that they can communicate together.

(3) Files at each mailsite are filed using some variant of the “shell” filing system (see below). The files at the mailsite can be filed using stable (unchanging) and unique values reachable from a database (henceforth termed a “shellbase”) via hyperlinks. This can be a two-table database, which includes a catalog table and a filter table.

(4) Mailsite servers have “transponding” software. This is software that enables the mailsite server to respond to an incoming message by sending back files requested.

Operation of the Universal Filing System Network

By way of example and not limitation, the following explanation includes three mailsite servers and their files. (Alternatively, the Universal Filing System Network can be implemented on a single server that hosts different mailsites and their associated groups of files.) In this example, the e-mail addresses for the mailsites are:

1—a@mail.com

2—b@mail.com

3—c@mail.com

In this example, the files at each mailsite are in one folder (or directory) named “library” on the C drive. In this example, each mailsite has five files.

Using an integer version of the shell filing system for each mailsite, in this example, the UFS addresses (called hereafter “UFS coordinates” or “UFS coords”, or “coords”) for the files at the first mailsite are:

1—a@mail.com\c\library\1.ext

2—a@mail.com\c\library\2.ext

3—a@mail.com\c\library\3.ext

4—a@mail.com\c\library\4.ext

5—a@mail.com\c\library\5.ext

As used herein, the term “ext” is code for whatever file extension the computer automatically adds to the integer name of the file—doc, jpg, pdf, txt, msg, wma, and so on.

1—b@mail.com\c\library\1.ext

2—b@mail.com\c\library\2.ext

3—b@mail.com\c\library\3.ext

4—b@mail.com\c\library\4.ext

5—b@mail.com\c\library\5.ext

The UFS coords for the third mailsite's files are:

1—c@mail.com\c\library\1.ext

2—c@mail.com\c\library\2.ext

3—c@mail.com\c\library\3.ext

4—c@mail.com\c\library\4.ext

5—c@mail.com\c\library\5.ext

The UFS coords for the second mailsite's files are formed from combining the mailsite address and the files' C drive addresses (hereafter called “file addresses”). These coords are employed at one mailsite to call up files from the other two (and, in some versions of this invention, from one's own mailsite).

Coord values are stable and unique across a UFS network because it is a feature of the UFS network that mailsite addresses not change. Further, the e-mail address portion of a coord is unique because under the rules of the Internet, e-mail addresses are unique. The coord's file address is stable and unique because of the design logic of the shellbase. (The shellbase relies on a database design in which the identifier field is a unique and unvarying value for each record.)

Mailsite files are arranged by the shell method, as described above, with the files in one folder (or directory). The two database tables: (1) catalog and (2) categorize the group of files on the mailsite. The catalog table can be a recordset, with each record (called hereafter a “shell”) containing a unique identifier number in its identification field, a mailsite field that can hold the e-mail address of the mailsite, a category field (which can function much like a folder under the traditional folder system), fields describing the file (name, size, date, etc), and a hyperlink field that links the shell to the file in question. The category table (which is called the “filter”) can hold the categories used to group the files.

These separate items—files, records, tables, and a mailsite address—can function together in the following manner.

A file added to the mailsite can be represented by a shell in the recordset (which is termed a “shellset”) and then renamed with the shell identification number and filed under this name in the file directory.

In this example, the last file added to a@mail.com was a@mail.com\c\library\5.ext. So, the next file added has as its value the integer “6” in the shell's identity field, in its mailsite field “a@mail.com” and holds in its hyperlink field (if the file is, for example, a Word document) the file path of “c:\library\6.doc”. After adding this shell to the catalog table's shellset, the file can be renamed and filed in the library folder as “c:\library\6.doc”. If the next file added to the mailsite is, for example, a PDF file, it has a shell identity of “7”, a mailsite identity of “a@mail.com”, a hyperlink value of “c:\library\7.pdf”, and the filename “c:\library\7.pdf”. And so on, with additional files processed to produce an accompanying shell and renamed with the shell's identity field value. The coords for the two files above are “a@mail.com\c\library\6.doc” and “a@mail.com\c\library\7.pdf”.

The identity field holds non-duplicate numeric (usually an integer) values, with each new shell given a numeric value greater by a uniform amount than the latest shell's numeric value. Thus, the shellset for files added to a directory holding 10,000 files can have 10,000 shells, and if integers were used each can carry an integer value in the identity field and a similar integer value in the hyperlink field that can match the integer value of a particular file in the folder.

The original name of each file processed in this manner can be copied over to a field in its respective shell, referred to, for example, as the “item” field. In this way the file's name can be preserved. Users can refer to the file using its original name because its actual name, probably an integer value, is likely not of concern to users.

Mailsite owners, using this system, can build a catalog table with a one-to-one relationship with files in the file directory.

The second table, the filter table, can hold the categories developed by the mailsite user for grouping his shells. For example, he can group photo files of pictures taken while touring China with the category “p\photos\China” and he can have another category for pictures of his children such as “p\photos\children”. These categories can be placed in the category field of shells linked to photos he took while in China or of his children. If, for example, his children were with him on the China trip, he can have photo files whose shells held both “p\photos\China” and “p\photos\children” in their category fields.

Each of these categories can be listed as individual records in the filter table.

In addition, mailsite users can also add additional shells that contain the mailsite addresses and the names of their files that the mailsite user wants to reference at other mailsites. Thus, the shellset containing the shells can, in certain circumstances, have more shells than files in the mailsite's directory. As outlined above, this does not interfere with the one-to-one correspondence between the files and their shells.

File retrieval in such a system operates as follows. The user sends an e-mail plus an attachment from his mailsite to another to request a file or group of files. The attachment can be a spreadsheet, with particulars of each requested file in each row of the spreadsheet, including the coords of the file. When the request message arrives at the target mailsite, software there opens the attachment and works with the file address of the coord of the requested file to locate it on the server's C drive (or other location). The mailsite's e-mail program next attaches the found file to an outgoing message. The outgoing message, in turn, is given the earlier incoming request”s mailsite address for placement in its “send to” address field. The message is then sent. This procedure is then repeated for the next row(s) of the spreadsheet if a further file or files are sought.

The above process is called “transponding”. The programs that are used to transpond are part of this embodiment of the invention.

An application of an embodiment of the UFS network can be used by a library as a card catalogue.

Such a catalogue can be built using web crawler-like technology to jump from mailsite to mailsite via e-mail links and to record the file addresses for each file at each site.

Alternatively, catalogs can be sent on request. The transponding software can, in response to a particular type of incoming e-mail, cause the mailsite automatically to send out all or part of the mailsite's shellbase. Once the portion of the shellbase (called a “shellset” and sent as a spreadsheet) arrives at the requester's mailsite, software on the site converts the shellset to a table, which forms the resource source for a form. The form displays the file names and file categories, as described above. By checking boxes next to a file displayed in the shellset on the form, the user indicates a file he wants retrieved. He presses a button and the request goes out as a spreadsheet. The message with the spreadsheet attached arrives at the target mailsite. Programs there then work to locate the requested files on the mailsite server's C drive. The located files are then attached, one by one, and each individually mailed back to the requester's mailsite.

In an embodiment, a file's identity remains the same even if the file is changed. In another embodiment, the changed file can be handled as an additional file with a new identity. In an embodiment, a file selected to be deleted is actually deleted, but its number does not change. In another embodiment, a file selected to be deleted has code inserted into its shell indicating that the file has a “deleted” status and is not to be used.

In another embodiment, a UFS network can be used for websites if their files are arranged in a similar manner.

There are advantages to using a UFS.

First, existing files in a UFS network can be identified and their identities recorded, and then they can be categorized or indexed as needed. Once done, the categories or indices can be used to locate these files from that point onward, regardless of whether new files are added to the network. This means that users can quickly organize their own google-like indices and no longer rely on Google to find many files, if they want this freedom. Further, organizations can develop various indices and make these available to users to employ. In an embodiment, the UFS network can be categorized according to the Dewey Decimal System.

Another advantage to such a system is that favorite mailsites or websites can be downloaded to a user's mailsite to reduce the load time for viewing files. Furthermore, these can be regularly updated by automatic requests sent from the user's mailsite to such mailsites or websites for the latest files. For example, users can select several news sites, several blog sites, mailsites (perhaps of friends), commercial sites of interest (e.g., Amazon or Borders) and the system can download the files from these sites to replicate them on their own personal computer and then have their personal computer regularly re-access these sites for the latest information.

Further, casual e-mail users in a UFS network easily can set up a method of sharing files with others. For example, they can set their e-mail software to allow only certain persons the right to copy files from their mailsites by, for example, entering their names in a “share” field in the file's shell.

Additionally, because such a UFS network runs on discrete requests and discrete responses rather than over an online network, it uses fewer bytes per hour than online methods. Messages can be encrypted, viruses and spam can be controlled more easily, and delivery of information can be accomplished more reliably because of the robustness of the e-mail system versus online systems, which are subject to interruption.

### “Contours, Coordinates, and Transponding”

This innovative technology is based on at least three core features. The first feature is that files are represented by what is referred to here as “contours”, a term referred to above as “shells” and “silhouettes”. Contours are the metadata for the file, each arranged as a record in a database with columns serving as the descriptive fields for the file. Contours provide a much richer, more flexible method for grouping files. Contours are linked to their corresponding files by a hyperlink file address in the hyperlink field.

The second feature is what is termed the file's “coordinate”. It comprises of the e-mail address of the site hosting the file (either a website or what is referred to here as a “mailsite”—a website built using a user's personal e-mail address) and a unique identifying number that is identical to the unique identifying number in the identity field of the contour. Users at remote locations work with a contour list on their machines to select files that they want to request or otherwise manipulate. A file's coordinate is fixed; it never changes except by being deleted when the file is deleted. The importance of having a file's coordinate fixed is that from then on the file's contour serves users as the file's proxy in terms of manipulating the file—copying it, sending it, receiving it, printing it, and in many other ways. This is so because filing actions taken with the contour occur to the file via the hyperlink connection.

The third feature is the underlying “transponding” technology, which allows users to download or upload files from/to websites and mailsites from a computer, either near or far away.

Together, these three features allow users to control how and when and to whom files are sent or from whom files are received, and they allow users to do so remotely.

This innovative technology overcomes some of the concerns associated with conventional use of the Internet. First, conventional use of the Internet usually requires being online for relatively extended periods. Since Internet usage costs money in terms of the amount of time online, extended periods online can be costly, particularly over connections with broad bandwidth. Second, conventional users often are otherwise occupied at the computer while online—scrolling through pages, typing in information, etc. In this sense, online usage is also costly in that it can occupy a considerable amount of a user's time. Third, online usage typically takes place during normal waking hours, not during non-waking hours when the user's computer is likely to be idle. This concern means that conventional online systems are idle for eight hours of the day, when online charges are at their lowest.

This innovative technology reduces these concerns considerably, and provides a method for performing what amounts to as “offline browsing”. First, by using this innovative technology, users can replicate much of their conventional interacting with websites over the Internet at much lower costs. A user can put into his computer the website address of a website he typically views and then employ commands that automatically prompt the website to send him relevant files and any updates. As noted above, the website can be prompted for a catalog of its files; the user can scan the catalog and, using a contour list that he builds from the catalog or one provided to him by the website or by other vendors, select items that he wants. The files can then be sent and downloaded onto his computer and updates can be sent on a regular basis. When browsing files, the user can be offline, since most of the website's file information will already have been sent to his computer. This means that the browsing can be faster, since he can be browsing pages already loaded on his machine. He can interact in real time, too. For example, while browsing the website he can then send a quick message using his password and requesting to view his bank information. The website can then promptly respond by sending him the file, which can soon be displayed on his screen.

In an embodiment, an advertising company can gain access rights to a portion of the website's webpages, and the user then can see a new advertisement on the screen as he viewed his account. For example, the advertising company can be alerted when the user e-mailed the website for more information, and can automatically update the advertisement on the user's screen with other messages, as needed.

In another embodiment, filter tables, as described above and from which file categories are produced, for the contours can be provided from outside vendors.

As is shown, much is done without requiring the user's attention, freeing him from much of the time spent online. Further, in an embodiment, VBA software can be written so that file downloads occur at certain times, for example when the Internet is less used (e.g., after midnight) and online costs are less expensive. By controlling when downloads occur, money can be saved.

Additionally, personal e-mail addresses can be used along these lines in useful ways. For example, using his e-mail address as a website (referred to here as a “mailsite”), a user can mark, in a field of the file's contour, whom can view the file. As a result, a version of Facebook can be produced. To explain, the user can post to his mailsite certain files that he is willing to share with others, then send them a message that he has files to share, and then others send e-mail requests to his mailsite. The site's transponding command loads them into individual e-mails and sends them back. The user can modify the contours of files, as needed, to have them deleted from the mailsite or no longer viewable by others. The user can set up multiple versions of Facebook on his mailsite by indicating that some viewers can see one set of files and others can see another, and so on. In this manner, mailsites can be used as bulletin boards were used in the past. Additionally, viewers can be allowed to post messages on the mailsite, if desired, using the transponding command procedure.

An advantage of this innovative technology is that, because: (1) a copy of the master table is repeatedly saved, for example, as a spreadsheet file in the same file directory as the other files, (2) a copy of each filter table is also saved in this manner, for example, as a spreadsheet file; and (3) a copy of the database file, which contains the forms and associated programs for this technology, is likewise saved repeatedly in the file directory, it is highly improbable that contours or filter tables might become separated from their corresponding files or that the database file, which includes the processing forms and programs used to process the files, contours, and filters, might become separated from the files. Additionally, copies of database files used by other machines that work connected to or remotely with a main server or personal computer, are likewise stored in the file directory. Therefore, copies of the database files, the master contour table and filter tables (for example, as spreadsheets), and the other files reside in the same place. They then can be duplicated repeatedly and stored to ensure their retention in any secure storage system of the user's choosing.

### Retrieving a File of Machine-Readable Data

Overview

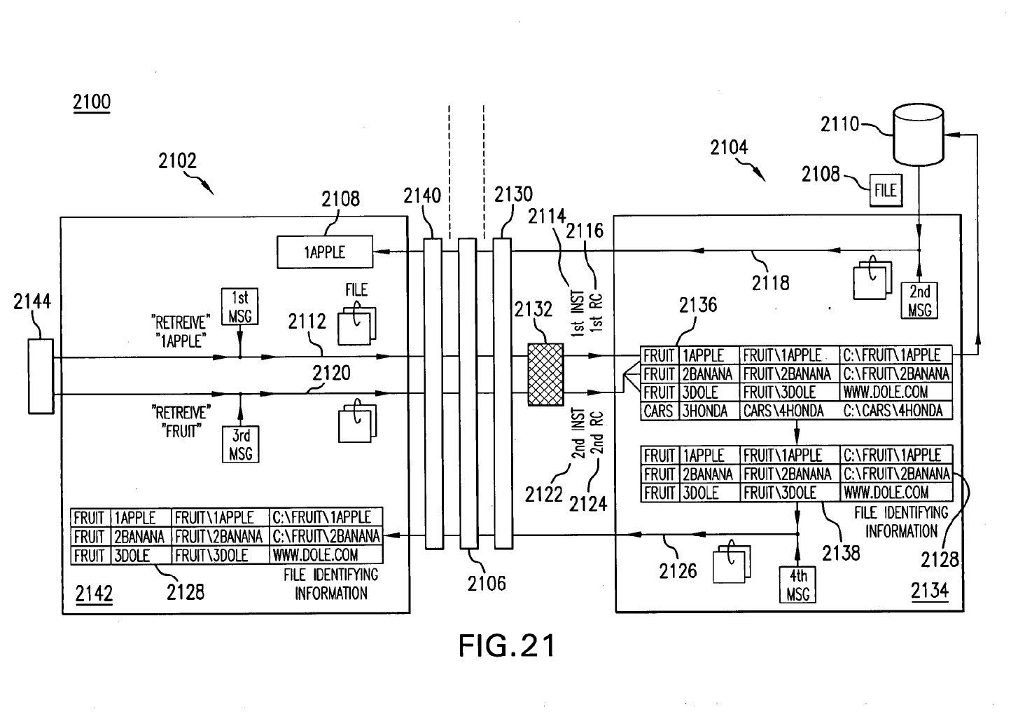

In an embodiment, the present invention comprises methods, systems, and computer program products for storing and retrieving a file of machine-readable data and for editing file identifying information. For example, FIG. 21 illustrates an embodiment of a system 2100 for retrieving a file from a remote machine-readable data storage device. System 2100 includes a local station 2102, a remote station 2104, and a packet switched network 2106. A user, wishing to retrieve a file 2108 of machine-readable data from a remote machine-readable data storage device 2110, transmits a first e-mail message 2112 from local station 2102 to remote station 2104 via packet switched network 2106. First e-mail message 2112 includes a first machine-readable instruction 2114 (for example, “retrieve”) and a first machine-readable retrieval criterion 2116 (for example, a name of file 2108, the name of file 2108 including a unique identifier for file 2108, such as “1apple” which has the unique identifier “1”). Remote station 2104 receives first e-mail message 2112 from packet switched network 2106. Remote station 2104 parses first e-mail message 2112 to determine if it includes, in the header or the body of first e-mail message 2112 or as an attachment of first e-mail message 2112, first machine-readable instruction 2114 and first machine-readable retrieval criterion 2116. Remote station 2104 executes first machine-readable instruction 2114 to transmit a second e-mail message 2118 from remote station 2104 to local station 2102. Second e-mail message 2118 includes file 2108 as an attachment. Local station 2102 receives second e-mail message 2118 from packet switched network 2106.

In an embodiment, the present invention recognizes that the user may, in order to retrieve file 2108 from remote machine-readable data storage device 2110, need to retrieve information that will assist the user in identifying file 2108. For example, the user may not recall the name of file 2108 (e.g., “1apple”), but recall that it is associated with a certain category (e.g., “fruit”). In this embodiment, the user begins by transmitting a third e-mail message 2120 from local station 2102 to remote station 2104 via packet switched network 2106. Third e-mail message 2120 includes a second machine-readable instruction 2122 (for example, “retrieve”) and a second machine-readable retrieval criterion 2124 (for example, a category named “fruit”). Remote station 2104 receives third e-mail message 2120 from packet switched network 2106. Remote station 2104 parses third e-mail message 2120 to determine if it includes, in the header or the body of third e-mail message 2120 or as an attachment of third e-mail message 2120, second machine-readable instruction 2122 and second machine-readable retrieval criterion 2124. Remote station 2104 executes second machine-readable instruction 2122 to transmit a fourth e-mail message 2126 from remote station 2104 to local station 2102. Fourth e-mail message includes, in the header or the body of fourth e-mail message 2126 or as an attachment of fourth e-mail message 2126, file identifying information 2128. File identifying information 2128 includes machine-readable data representative of a name of file 2108, the name of file 2108 including a unique identifier for file 2108, and at least one of a category associated with file 2108, a type of file 2108, a classification of file 2108, a size of file 2108, a date of an edit made to file 2108, an indication of a time when file 2108 is to be retrieved, an identity of an individual who is to receive file 2108, other retrieval criteria, or any combination of the foregoing. Local station 2102 receives fourth e-mail message 2126 from packet switched network 2106. Accessing file identifying information 2128, the user can identify file 2108 for retrieval and can transmit first e-mail message 2112 as described above.

In an embodiment, second e-mail message can include a third machine-readable instruction. Local station 2102 executes the third machine-readable instruction to store file 2108, to display file 2108, perform other actions with file 2108, or any combination of the foregoing.

In an embodiment, fourth e-mail message can include a fourth machine-readable instruction. Local station 2102 executes the fourth machine-readable instruction to store file identifying information 2128, to display file identifying information 2128, perform other actions with file identifying information 2128, or any combination of the foregoing.

In an embodiment, a user may wish to transmit file 2108 from local station 2102 to remote station 2108 to store file 2108 at remote machine-readable data storage device 2110. First e-mail message 2112 is transmitted from local station 2102 to remote station 2104 via packet switched network 2106. First e-mail message 2112 includes first machine-readable instruction 2114 (for example, “store”) and file 2108 as an attachment. Remote station 2104 receives first e-mail message 2112 from packet switched network 2106. Remote station 2104 parses first e-mail message 2112 to determine if it includes, in the header or the body of first e-mail message 2112 or as an attachment of first e-mail message 2112, first machine-readable instruction 2114. Remote station 2104 executes first machine-readable instruction 2114. First machine-readable instruction 2114 can cause file 2108 to be stored at remote machine-readable data storage device 2110. First machine-readable instruction can also cause file identifying information 2128 to be produced for file 2108, including a new name for file 2108, the new name including a new unique identifier for file 2108. First machine-readable instruction can also cause this file identifying information 2128, including the new name for file 2108, to be added to first table 2138.

In an embodiment, local station 2102 displays file identifying information 2128 in a user-friendly form so that a user can readily identify the name of file 2108 including the unique identifier for file 2108 (e.g., “1apple”) and select it via user interface 2144. For example, if the user-friendly form includes a table of records of files 2108, the user can select a particular file 2108, for example, by checking a box in a field of the record for particular file 2108). The user-friendly form can be configured to allow the user to select a particular file 2108 in a different manner.

In a variation of this embodiment, the user can edit file identifying information 2128, with the exception that the name for file 2108, the name including the unique identifier for file 2108, cannot be edited. For example, if the user-friendly form includes the table of records of files 2108, the user can edit some of the fields of the records of files 2108 (e.g., the category field for the “3Dole” record can be changed from “fruit” to “company”). In this variation, the user may wish to transmit edited file identifying information 2128 from local station 2102 to remote station 2108 to update first table 2138. First e-mail message 2112 is transmitted from local station 2102 to remote station 2104 via packet switched network 2106. First e-mail message 2112 includes first machine-readable instruction 2114 (for example, “update”) and edited file identifying information 2128 in the header or the body of first e-mail message 2112 or as an attachment of first e-mail message 2112. Remote station 2104 receives first e-mail message 2112 from packet switched network 2106. Remote station 2104 parses first e-mail message 2112 to determine if it includes, in the header or the body of first e-mail message 2112 or as an attachment of first e-mail message 2112, first machine-readable instruction 2114. Remote station 2104 executes first machine-readable instruction 2114. First machine-readable instruction 2114 can cause first table 2138 to be updated to include edited file identifying information 2128 (e.g., change the category field for the “3Dole” record from “fruit” to “company”).

For example, remote machine-readable data storage device 2110 can comprise, but is not limited to, an electronic data storage device (random access memory, read-only memory, USB data storage devices, Sony memory sticks, and the like), a magnetic data storage device (hard disks, floppy disks, ZIP disks, and the like), an optical data storage device (compact discs, digital video discs, and the like), or any combination of the foregoing. Remote machine-readable data storage device 2110 can be a component of remote station 2104, separate from remote station 2104, or a combination of the foregoing.

For example, at least one of first e-mail message 2112, second e-mail message 2118, third e-mail message 2120, and fourth e-mail message 2126 can be accessed by, but is not limited to, a client-based e-mail system such as Microsoft® Outlook®, Mozilla® Thunderbird™, Apple® Mail, Qualcomm® Eudora®, Novell® GroupWise®, IBM® Lotus Notes°, Microsoft® Entourage®, Netscape® Messenger®, and other client-based e-mail systems, or a web-based e-mail system such as Google™ Gmail™, Yahoo!® Mail, Microsoft® Windows Live™ Hotmail™, AOL® Mail, and other web-based e-mail systems. Additionally, at least one of first e-mail message 2112, second e-mail message 2118, third e-mail message 2120, and fourth e-mail message 2126 can be accessed by any combination of the foregoing.

For example, packet switched network 2106 can comprise, but is not limited to, the Internet, the World Wide Web, an intranet, a wide area network, a local area network, and other packet switched networks. Additionally, packet switched network 2106 can comprise any combination of the foregoing.

For example, first machine-readable instruction 2114 can be disposed in, but is not limited to the body of first e-mail message 2112, the header of first e-mail message 2112, or an attachment of first e-mail message 2112. Additionally, first machine-readable instruction 2114 can be disposed in any combination of the foregoing. For example, first machine-readable retrieval criterion 2116 can be disposed in, but is not limited to the body of first e-mail message 2112, the header of first e-mail message 2112, or an attachment of first e-mail message 2112. Additionally, first machine-readable retrieval criterion 2116 can be disposed in any combination of the foregoing. For example, second machine-readable instruction 2122 can be disposed in, but is not limited to the body of third e-mail message 2120, the header of third e-mail message 2120, or an attachment of third e-mail message 2120. Additionally, second machine-readable instruction 2122 can be disposed in any combination of the foregoing. For example, second machine-readable retrieval criterion 2124 can be disposed in, but is not limited to the body of third e-mail message 2120, the header of third e-mail message 2120, or an attachment of third e-mail message 2120. Additionally, second machine-readable retrieval criterion 2124 can be disposed in any combination of the foregoing.

For example, the visual product stored in the tangible medium or the audio product stored in the tangible medium can comprise, but is not limited to, an audio recording, a still picture, or a moving picture. Alternatively, for example, the visual product stored in the tangible medium or the audio product stored in the tangible medium can comprise, but is not limited to, a word processing file, a spreadsheet file, a presentation program file, or an e-mail message file. Additionally, the visual product stored in the tangible medium or the audio product stored in the tangible medium can comprise any combination of the foregoing.

In an embodiment, file 2108 can be a plurality of files 2108. In this embodiment, second e-mail message 2118 can include plurality of files 2108 as an attachment of second e-mail message 2118. Alternatively, in this embodiment, second e-mail message 2118 can be a plurality of second e-mail messages 2118. Each one of plurality of second e-mail messages 2118 is associated with a corresponding one of plurality of files 2108. Each one of plurality of second e-mail messages 2118 includes its corresponding one of plurality of files 2108 as an attachment of one of plurality of second e-mail messages 2118.

### Remote Station

System

In an embodiment, remote station 2104 comprises a remote packet switched network interface 2130, a filter 2132, and a remote electronic processor 2134. Remote packet switched network interface 2130 is configured to receive first e-mail message 2112 from packet switched network 2106 and to transmit second e-mail message 2118 to packet switched network 2106. Filter 2132 is configured to parse first e-mail message 2112 to determine if first e-mail message 2112 includes, in the header or the body of first e-mail message 2112 or as an attachment of first e-mail message 2112, first machine-readable instruction 2114 and first machine-readable retrieval criterion 2116. Remote electronic processor 2134 is configured to execute first machine-readable instruction 2114 to cause remote packet switched network interface 2130 to transmit second e-mail message 2118. Second e-mail message 2118 includes file 2108 as an attachment of second e-mail message 2118.

For example, remote electronic processor 2134 can comprise, but is not limited to, a commercially available microprocessor such as an ARM® processor, a Pentium® processor, an Intel386™ processor, an Athlon™ processor, a PowerPC™ processor, or other commercially available processors. Alternatively, for example, remote electronic processor 2134 can comprise an application-specific integrated circuit processor or a field-programmable gate array processor. Additionally, remote electronic processor 2134 can comprise any combination of the foregoing.

For example, remote electronic processor 2134 can be disposed in, but is not limited to, a server computer, a workstation computer, a personal computer, a laptop computer, a personal digital assistant, a wireless handheld device, or a smartphone. Remote electronic processor 2134 can also be disposed in other devices.

For example, remote electronic processor 2134 can be configured to operate with Microsoft® Windows®, Apple® Mac OS®, Unix® Operating System, Linux® Operating System, or other operating systems.

In an embodiment, at least one of first machine-readable instruction 2114 and first machine-readable retrieving criterion 2116 can be disposed in a spreadsheet file attached to first e-mail message 2112. In this embodiment, remote electronic processor 2134 is further configured to convert the spreadsheet file to a table file upon receipt of first e-mail message 2112. This can facilitate execution of first machine-readable instruction 2114 by remote electronic processor 2134.

In an embodiment, first machine-readable retrieving criterion 2116 can be data representative of a name of file 2108, the name of file 210 including a unique identifier for file 2108 (e.g., the unique identifier “1” in “1apple”). In this embodiment, remote electronic processor 2134 is further configured to find first machine-readable retrieval criterion 2116 in a table 2136 that cross-references first machine-readable retrieval criterion 2116 (e.g., “1apple” or “3Dole”) with a path to file 2108 (e.g., “C:\fruit\1apple”), a hyperlink to file 2108 (e.g., “www.dole.com”), or both. Remote electronic processor 2134 is also further configured to use the path to file 2108 or the hyperlink to file 2108 to retrieve file 2108 from remote machine-readable data storage device 2110, and to attach file 2108 to second e-mail message 2118.

In an embodiment, the present invention recognizes that a user may, in order to retrieve file 2108 from remote machine-readable data storage device 2110, need to retrieve information that will assist the user in identifying file 2108. In this embodiment, remote packet switched network interface 2130 is further configured to receive third e-mail message 2120 from packet switched network 2106 and to transmit fourth e-mail message 2126 to packet switched network 2106. Filter 2132 is further configured to parse third e-mail message 2120 to determine if third e-mail message 2120 includes, in the header or the body of third e-mail message 2120 or as an attachment of third e-mail message 2120, second machine-readable instruction 2122 and second machine-readable retrieval criterion 2124. Remote electronic processor 2134 is further configured to execute second machine-readable instruction 2122 to cause remote packet switched network interface 2130 to transmit fourth e-mail message 2126. Fourth e-mail message 2126 includes, in the header or the body of fourth e-mail message 2126 or as an attachment of fourth e-mail message 2126, file identifying information 2128.

In a variation of this embodiment, at least one of second machine-readable instruction 2122 and second machine-readable retrieval criterion 2124 can be disposed in a spreadsheet file attached to third e-mail message 2120. In this variation, remote electronic processor 2134 is further configured to convert the spreadsheet file to a table file upon receipt of third e-mail message 2120. This can facilitate execution of second machine-readable instruction 2122 by the remote electronic processor 2134.

In another variation of this embodiment, file identifying information 2128 can be disposed in a table file. In this variation, remote electronic processor 2134 is further configured to convert the table file to a spreadsheet file. This can be done so that file identifying information 2122 can be attached in a spreadsheet form to fourth e-mail message 2126.

In yet another variation of this embodiment, second machine-readable retrieval criterion 2124 can be data representative of the name of file 2108, the name of file 2108 including the unique identifier for file 2108, and at least one of a category associated with file 2108, a type of file 2108, a classification of file 2108, a size of file 2108, a date of an edit made to file 2108, an indication of a time when file 2108 is to be retrieved, an identity of an individual who is to receive file 2108, other retrieval criteria, or any combination of the foregoing (e.g., “fruit”). In this variation, remote electronic processor 2134 is further configured to find second machine-readable retrieval criterion 2124 in first table 2136, to use second machine-readable retrieval criterion 2124 to produce file identifying information 2128, and to include file identifying information 2128 in the header or the body of fourth e-mail message 2126 or as an attachment of fourth e-mail message 2126.

In an option of this variation, remote electronic processor 2134 is configured to find a match that is exact to second machine-readable retrieval criterion 2124.

In another option of this variation, remote electronic processor 2134 is configured to find a match that is similar to second machine-readable retrieval criterion 2124.

In yet another option of this variation, remote electronic processor 2134 is configured to parse a field of first table 2136 having a plurality of information (e.g., “fruit\1apple”, “fruit\2banana”, “fruit\3Dole”, and “cars\4Honda”) to define a set of the information (e.g., “fruit”, “cars”, “1apple”, “2banana”, “3Dole”, and “4Honda”) and to search the set of the information to find an object (e.g., “fruit”) of the set of the information that matches second machine-readable retrieval criterion 2124 (e.g., “fruit”).

In still another option of this variant, remote electronic processor 2134 is configured to produce a second table 2138. Second table 2138 is a subset of first table 2136. The subset includes at least one record from first table 2136 having a field that includes second machine-readable retrieval criterion 2124 (e.g., “fruit”). Alternatively, second table 2138 can be all of first table 2136.

### Method

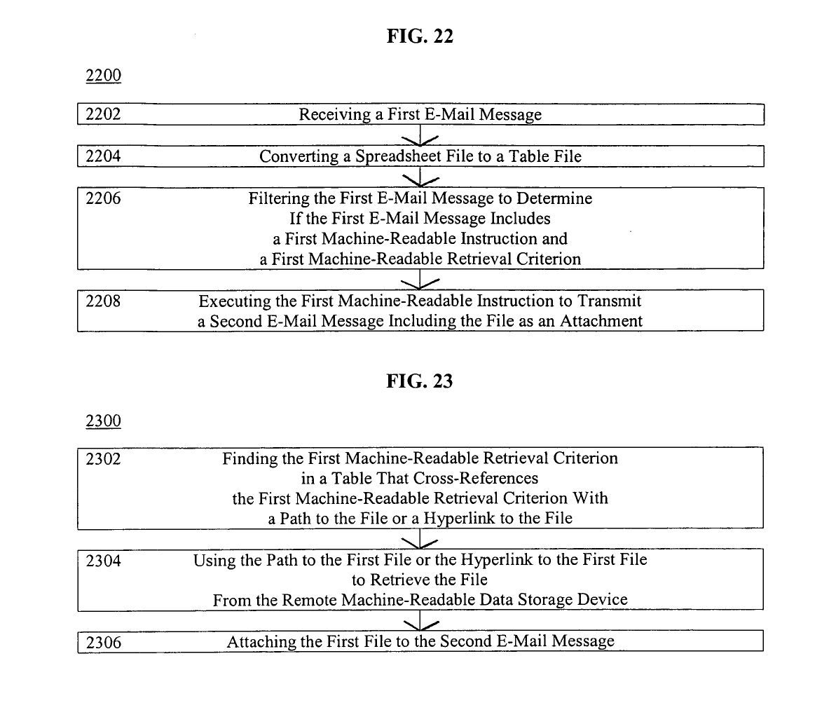

In another embodiment the present invention can be implemented as a method for retrieving a file from a remote machine-readable data storage device. For example, FIG. 22 illustrates a flow chart of an embodiment of a method 2200 for retrieving a file from a remote machine-readable data storage device. In method 2200, at a step 2202, a first e-mail message is received, at an electronic processor, from a packet switched network. Optionally, at a step 2204, if at least one of a first machine-readable instruction and a first machine-readable retrieval criterion is disposed in a spreadsheet file attached to the first e-mail message, the spreadsheet file can be converted, at the electronic processor, to a table file upon receipt of the first e-mail message. This can facilitate execution of the first machine-readable instruction by the electronic processor. At a step 2206, the first e-mail message is parsed, at the electronic processor, to determine if the first e-mail message includes, in the header or the body of the first e-mail message or as an attachment of the first e-mail message, the first machine-readable instruction and the first machine-readable retrieval criterion. At a step 2208, the first machine-readable instruction is executed, at the electronic processor, to transmit a second e-mail message to the packet switched network. The second e-mail message includes the file as an attachment of the second e-mail message.

For example, the electronic processor can comprise, but is not limited to, a commercially available microprocessor such as an ARM® processor, a Pentium® processor, an Intel386™ processor, an Athlon™ processor, a PowerPC™ processor, or other commercially available processors. Alternatively, for example, the electronic processor can comprise an application-specific integrated circuit processor or a field-programmable gate array processor. Additionally, the electronic processor can comprise any combination of the foregoing.

For example, the electronic processor can be disposed in, but is not limited to, a server computer, a workstation computer, a personal computer, a laptop computer, a personal digital assistant, a wireless handheld device, or a smartphone. The electronic processor can also be disposed in other devices.

For example, the electronic processor can be configured to operate with Microsoft°Windows®, Apple® Mac OS®, Unix® Operating System, Linux® Operating System, or other operating systems.

In an embodiment, the first machine-readable retrieving criterion can be data representative of a name of the file, the name of the file including a unique identifier for the file. In this embodiment, additional steps can be performed to retrieve the file and attach it to the second e-mail message. For example, FIG. 23 illustrates a flow chart of an embodiment of a method 2300 for retrieving a file from a remote machine-readable data storage device. In method 2300, at a step 2302, the first machine-readable retrieval criterion is found, by the electronic processor, in a table that cross-references the first machine-readable retrieval criterion with a path to the file, a hyperlink to the file, or both. At a step 2304, the path to the file or the hyperlink to the file is used, by the electronic processor, to retrieve the file from the remote machine-readable data storage device. At a step 2306, the file is attached, by the electronic processor, to the second e-mail message.

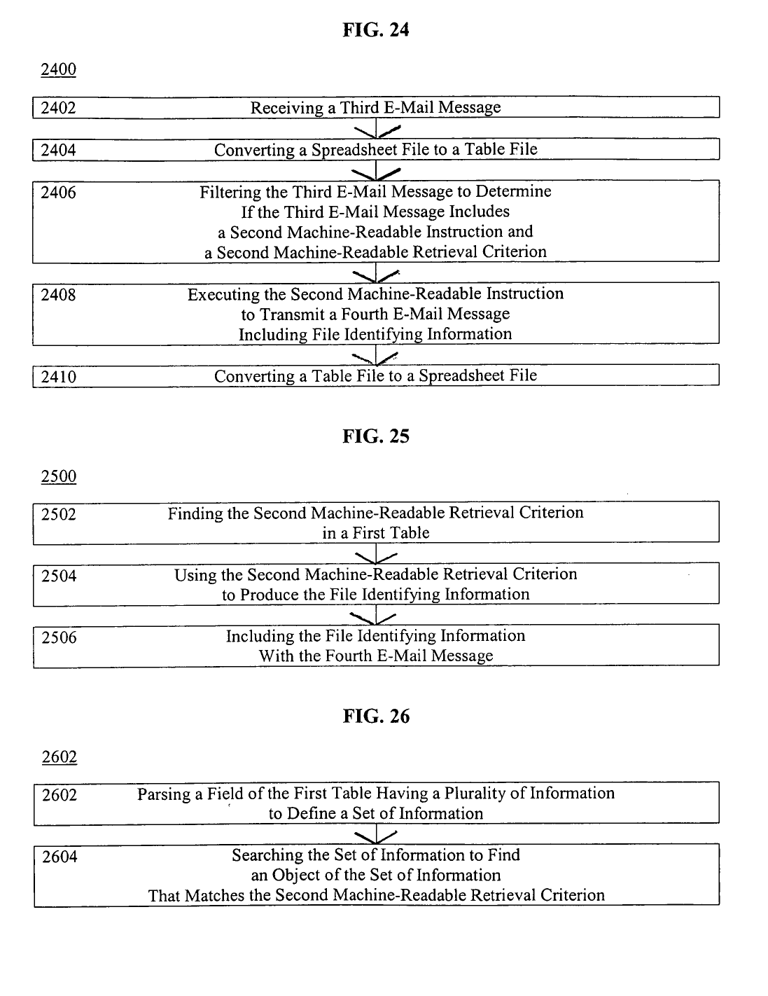

In an embodiment, the present invention recognizes that a user may, in order to retrieve the file from the remote machine-readable data storage device, need to retrieve information that will assist the user in identifying the file. In this embodiment, additional steps can be performed to retrieve file identifying information. For example, FIG. 24 illustrates a flow chart of an embodiment of a method 2400 for retrieving file identifying information. In method 2400, at a step 2402, a third e-mail message is received, at the electronic processor, from the packet switched network. Optionally, at a step 2404, if at least one of a second machine-readable instruction and a second machine-readable retrieval criterion can be disposed in a spreadsheet file attached to the third e-mail message, the spreadsheet file can be converted, at the electronic processor, to a table file upon receipt of the third e-mail message. This can facilitate execution of the second machine-readable instruction by the electronic processor. At a step 2406, the third e-mail message is parsed, at the electronic processor, to determine if the third e-mail message includes, in the header or the body of the third e-mail message or as an attachment of the third e-mail message, the second machine-readable instruction and the second machine-readable retrieval criterion. At a step 2408, the second machine-readable instruction is executed, at the electronic processor, to transmit a fourth e-mail message to the packet switched network. The fourth e-mail message includes, in the header or the body of the fourth e-mail message or as an attachment of the fourth e-mail message, file identifying information. Optionally, at a step 2410, if the file identifying information is disposed in a table file, the table file can be converted, at the electronic processor, to a spreadsheet file. This can be done so that the file identifying information can be attached in a spreadsheet form to the fourth e-mail message.

In an embodiment, the second machine-readable retrieval criterion can be data representative of the name of the file, the name of the file including the unique identifier for the file, and at least one of a category associated with the file, a type of the file, a classification of the file, a size of the file, a date of an edit made to the file, an indication of a time when the file is to be retrieved, an identity of an individual who is to receive the file, other retrieval criteria, or any combination of the foregoing. In this embodiment, additional steps can be performed to produce the file identifying information and include it with the fourth e-mail message. For example, FIG. 25 illustrates a flow chart of an embodiment of a method 2500 for producing the file identifying information. In method 2500, at a step 2502, the second machine-readable retrieval criterion is found, by the electronic processor, in a first table. At a step 2504, the second machine-readable retrieval criterion is used, by the electronic processor, to produce the file identifying information. At a step 2506, the file identifying information is included in the header or the body of the fourth e-mail message or as an attachment of the fourth e-mail message.

The information in the first table can be found to be a match that is exact to the second machine-readable retrieval criterion.

Alternatively, the information in the first table can be found to be a match that is similar to the second machine-readable retrieval criterion.

Alternatively, the information in the first table can be found by parsing a field of the first table. For example, FIG. 26 illustrates a flow chart of an embodiment of a method 2600 for parsing a field of the first table. In method 2600, at a first step 2602, a field of the first table having a plurality of information is parsed, by the electronic processor, to define a set of the information. At a step 2604, the set of the information is searched, by the electronic processor, to find an object of the set of the information that matches the second machine-readable retrieval criterion.

Alternatively, the second machine-readable retrieval criterion can be used, by the electronic processor, to produce a second table. The second table is a subset of the first table. The subset includes at least one record from the first table having a field that includes the second machine-readable retrieval criterion. Alternatively, the second table can be all of the first table.

### Computer Program Product

In another embodiment the present invention can be implemented as a computer-readable storage medium having stored thereon a computer program code for retrieving a file from a remote machine-readable data storage device. The computer program code comprises a first program code, a second program code, and a third program code. The first program code causes an electronic processor to receive a first e-mail message from a packet switched network. The second program code causes the electronic processor to parse the first e-mail message to determine if the first e-mail message includes, in the header or the body of the first e-mail message or as an attachment of the first e-mail message, a first machine-readable instruction and a first machine-readable retrieval criterion. The third program code causes the electronic processor to execute the first machine-readable instruction to transmit a second e-mail message to the packet switched network. The second e-mail message includes the file as an attachment of the second e-mail message.

The following code example shows how the first machine-readable instruction in the header of the first e-mail message can direct the electronic processor to parse the first machine-readable retrieval criterion from the body of the first e-mail message:

′ Now, the following cases carry commands in the body of the email message. ′
The code “Xbbx” tells the PC that instructions will depend on code in the
′ message body (and I use the “bberry” case below to indicate different
′ commands in the body.)
Case ″Xbbx″ ′ Command in the subject of the email

Select Case bberry ′ This indicates commands in body of email

Case “Lc”

′ This bberry case stands for “like contact.” After Lc there is a term which
′ is represented by variable VarJW3 in between two /'s. This is words(1) of
′ the words array. I use this as a search term for a particular contact.
′ For example, if I put “Lc/jones/” in the body of the message I send back to
′ the PC, upon arrival the PC understands that it should look for records
′ that have “contacts” (VarJW2 below) in the brand (or category) field and
′ that have “jones” (upper or lower case for the first letter) in the item
′ field.

words( ) = Split (Body, ″/″)
VarJW3 = words (1)
VarJW4 = words (2)
VarJW2 = ″contacts″
strSQLDELETE = ″DELETE * FROM tblRequest″
DoCmd.RunSQL strSQLDELETE
strSQL = ″INSERT INTO tblRequest SELECT * From tblMaster
WHERE tblMaster.Brand Like ′″ & ″*″ & VarJW2 & ″*″ & ″′ _{—}

AND tblMaster.Item Like ′″ & ″*″ & VarJW3 & ″*″ _{—}
& ″′ order by tblMaster.Item;″

DoCmd.RunSQL strSQL
DoCmd.Close acForm, ″frmSendFiles″
DoCmd.TransferSpreadsheet acExport, acSpreadsheetTypeExcel9,
″tblRequest″, _{—}

″C:\sand\master.xls″, True

VarJW8 = ″c:\sand\master.xls″
Set ol = CreateObject(″Outlook.Application″)
Set olns = ol.GetNamespace(″MAPI″)
olns.Logon
Set msg = ol.CreateItem(olMailItem)
With msg

.Attachments.Add VarJW8
.Recipients.Add sender
.Subject = VarJW3
.Send

End With
olns.Logoff
Set ol = CreateObject(″Outlook.Application″)
Set ns = ol.GetNamespace(″MAPI″)
ns.Logon
Set folder = ns.GetDefaultFolder(olFolderInbox)
Stoney157:

For Each msg In folder.Items

With msg

msg.Move
ns.GetDefaultFolder(olFolderInbox). _{—}

Folders(″Processed″)

End With

Next
If folder.Items.Count = 0 Then

GoTo Dakota157
Else: GoTo Stoney157

End If

Dakota157:

Set thisFile = FSys.GetFile(″c:\sand\master.xls″)
With thisFile

thisFile.Delete

End With

For example, the electronic processor can comprise, but is not limited to, a commercially available microprocessor such as an ARM® processor, a Pentium® processor, an Intel386™ processor, an Athlon™ processor, a PowerPC™ processor, or other commercially available processors. Alternatively, for example, the electronic processor can comprise an application-specific integrated circuit processor or a field-programmable gate array processor. Additionally, the electronic processor can comprise any combination of the foregoing.

For example, the electronic processor can be disposed in, but is not limited to, a server computer, a workstation computer, a personal computer, a laptop computer, a personal digital assistant, a wireless handheld device, or a smartphone. The electronic processor can also be disposed in other devices.

For example, the electronic processor can be configured to operate with Microsoft® Windows®, Apple® Mac OS®, Unix® Operating System, Linux® Operating System, or other operating systems.

In an embodiment, at least one of the first machine-readable instruction and the first machine-readable retrieving criterion can be disposed in a spreadsheet file attached to the first e-mail message. In this embodiment, the computer program code can further comprise a fourth program code. The fourth program code causes the electronic processor to convert the spreadsheet file to a table file upon receipt of the first e-mail message. This can facilitate execution of the first machine-readable instruction by the electronic processor in accordance with the third program code.

In an embodiment, the first machine-readable retrieving criterion can be data representative of a name of the file, the name of the file including a unique identifier for the file. In this embodiment, the third program code can further comprise a fourth program code, a fifth program code, and a sixth program code. The fourth program code causes the electronic processor to find the first machine-readable retrieval criterion in a table that cross-references the first machine-readable retrieval criterion with a path to the file, a hyperlink to the file, or both. The fifth program code causes the electronic processor to use the path to the file or the hyperlink to the file to retrieve the file from the remote machine-readable data storage device. The sixth program code causes the electronic processor to attach the file to the second e-mail message.

The following code example shows how the electronic processor can respond to the first machine-readable retrieval criterion “Albums” in the header of the first e-mail message. In this example, first machine-readable retrieving criterion is disposed in a spreadsheet file attached to the first e-mail message:

′ This “albums” case will produce a spreadsheet of all the music albums in
′ the database. The spreadsheet will be sent to the sender of the
′ message requesting it.
Case ″Albums″

VarJW3 = ″M\Music\″
strSQLDELETE = ″DELETE * FROM tblRequest″
DoCmd.RunSQL strSQLDELETE
strSQL = ″INSERT INTO tblRequest SELECT DISTINCT tblMaster.Brand From
tblMaster WHERE tblMaster.Brand Like ′″ & ″*″ & VarJW3 & ″*″ & ″′ _{—}

order by tblMaster.Brand;″

DoCmd.RunSQL strSQL
DoCmd.OpenForm ″frmRequest″, acNormal, , , , acWindowNormal
DoCmd.GoToRecord , , acNewRec
Forms(″frmRequest″)!Item.SetFocus
Forms(″frmRequest″)!Item = ″Slug″
DoCmd.GoToRecord , , acFirst
Do While Forms(″frmRequest″)!Brand <> ″″

Forms(″frmRequest″)!Brand.SetFocus
VarJW4 = Forms(″frmRequest″)!Brand.Text
VarJW5 = Replace(VarJW4, VarJW3, ″″, , , vbTextCompare)
Forms(″frmRequest″)!Brand = VarJW5
DoCmd.GoToRecord , , acNext

Loop
DoCmd.TransferSpreadsheet acExport, acSpreadsheetTypeExcel9,
″tblRequest″, ″C:\sand\master.xls″, True
VarJW8 = ″c:\sand\master.xls″
Set ol = CreateObject(″Outlook.Application″)
Set olns = ol.GetNamespace(″MAPI″)
olns.Logon
Set msg = ol.CreateItem(olMailItem)
With msg

.Attachments.Add VarJW8
.Recipients.Add sender
.Subject = ″Albums″
.Send

End With
olns.Logoff
Set ns = ol.GetNamespace(″MAPI″)
ns.Logon
Set folder = ns.GetDefaultFolder(olFolderInbox)
Stoney67:

For Each msg In folder.Items

With msg

msg.Move
ns.GetDefaultFolder(olFolderInbox).Folders(″Processed″)

End With

Next
If folder.Items.Count = 0 Then

GoTo Dakota67
Else: GoTo Stoney67

End If

Dakota67:

Set thisFile = FSys.GetFile(″c:\sand\master.xls″)
With thisFile

thisFile.Delete

End With
Set thisFile = Nothing
DoCmd.DoMenuItem acFormBar, acRecordsMenu, 5, , acMenuVer70

The following code example shows how the electronic processor can respond to the first machine-readable retrieval criteria disposed in a spreadsheet file, convert the spreadsheet file into a table file and, transmit one second e-mail message for each file identified by an ‘x’ in the spreadsheet file.

′ This case will send back to the sender all the files (or records) which
′ have been checked with an “x” in the incoming spreadsheet. The files are
′ sent as attachments, with one attachment per email message. The files can
′ be of any type - docs, txt, jpg, wma, etc. The files will carry the term
′ “sent” in the subject field.
Case ″Raw″

With Item

.Attachments(1).SaveAsFile ″c:\sand\request.xls″

DoCmd.SetWarnings False
strSQLDELETERequest = ″DELETE * FROM tblRequest″
DoCmd.RunSQL strSQLDELETERequest
DoCmd.SetWarnings False
DoCmd.TransferSpreadsheet acImport, acSpreadsheetTypeExcel9, _{—}

″tblRequest″, ″C:\sand\request.xls″, True

Set ol = CreateObject(″Outlook.Application″)
Set olns = ol.GetNamespace(″MAPI″)
olns.Logon
strSQLDELETE2 = ″DELETE * FROM tblRequest2″
DoCmd.RunSQL strSQLDELETE2
strSQLDELETE3 = ″DELETE * FROM tblRequest3″
DoCmd.RunSQL strSQLDELETE3
strSQL2 = ″INSERT INTO tblRequest2 SELECT ID, Item, Lodestar, _{—}

MailSender, MailReceiver, FDate, FName, FSize, FType, _{—}
Check, Brand, YesNo, Other FROM tblRequest WHERE _{—}
tblRequest.Check Like ′x′;″

DoCmd.SetWarnings False
DoCmd.RunSQL strSQL2
DoCmd.OpenForm ″frmRequest2″, acNormal, , , , acWindowNormal
DoCmd.GoToRecord , , acNewRec
Forms(″frmRequest2″)!Item.SetFocus
Forms(″frmRequest2″)!Item = ″Slug″
DoCmd.GoToRecord , , acFirst
Do While Forms(″frmRequest2″)!Lodestar <> ″″

Set msg = ol.CreateItem(olMailItem)

With msg

Forms (″frmRequest2″)!Lodestar.SetFocus
InputValue = Forms(″frmRequest2″)!Lodestar.Text
Forms(″frmRequest2″)!Item.SetFocus
VarJW3 = Forms(″frmRequest2″)!Item.Text
strSQL3 = ″INSERT INTO tblRequest3 SELECT _{—}
Item, FName, MailSender, MailReceiver, _{—}
Lodestar, FSize, FType, FDate, Brand, YesNo, _{—}
Other FROM tblRequest2 WHERE _{—}
tblRequest2.Lodestar Like ′″ & ″*″ & _{—}
InputValue & ″*″ & ″′;″
DoCmd.SetWarnings False
DoCmd.RunSQL strSQL3
DoCmd.TransferSpreadsheet acExport, _{—}
acSpreadsheetTypeExcel9, ″tblRequest3″, _{—}
″C:\sand\master.xls″, True
VarJW8 = ″c:\sand\master.xls″
.Attachments.Add InputValue
.Attachments.Add VarJW8
.Recipients.Add sender
.Subject = ″Sent″
.Send
DoCmd.SetWarnings False
DoCmd.RunSQL strSQLDELETE3

End With
DoCmd.GoToRecord , , acNext

Loop

DoCmd.Close acForm, ″frmRequest2″
Set thisFile = FSys.GetFile(″c:\sand\request.xls″)
With thisFile

thisFile.Delete

End With
Set thisFile = FSys.GetFile(″c:\sand\master.xls″)
With thisFile

thisFile.Delete

End With
DoCmd.Close acForm, ″frmSendFiles″
olns.Logoff

Set ol = CreateObject(″Outlook.Application″)
Set ns = ol.GetNamespace(″MAPI″)
ns.Logon
Set folder = ns.GetDefaultFolder(olFolderInbox)
Stoney640:

For Each msg In folder.Items

With msg

msg.Move
ns.GetDefaultFolder(olFolderInbox).Folders(″Processed″)

End With

Next
If folder.Items.Count = 0 Then

GoTo Dakota640
Else: GoTo Stoney640

End If

Dakota640:

Set thisFile = FSys.GetFile(″c:\sand\master.xls″)
With thisFile

thisFile.Delete

End With
Set thisFile = Nothing

End With
DoCmd.DoMenuItem acFormBar, acRecordsMenu, 5, , acMenuVer70

In an embodiment, the present invention recognizes that a user may, in order to retrieve the file from the remote machine-readable data storage device, need to retrieve information that will assist the user in identifying the file. In this embodiment, the computer program code can further comprise a fourth program code, a fifth program code, and a sixth program code. The fourth program code causes the electronic processor to receive a third e-mail message from the packet switched network. The fifth program code causes the electronic processor to parse the third e-mail message to determine if the third e-mail message includes, in the header of the body of the third e-mail message or as an attachment of the third e-mail message, a second machine-readable instruction and a second machine-readable retrieval criterion. The sixth program code causes the electronic processor to execute the second machine-readable instruction to transmit a fourth e-mail message to the packet switched network. The fourth e-mail message includes, in the header or the body of the fourth e-mail message or as an attachment of the fourth e-mail message, file identifying information.

In a variation of this embodiment, at least one of the second machine-readable instruction and the second machine-readable retrieval criterion can be disposed in a spreadsheet file attached to the third e-mail message. In this variation, the computer program code can further comprise a seventh program code. The seventh program code causes the electronic processor to convert the spreadsheet file to a table file upon receipt of the third e-mail message. This can facilitate execution of the second machine-readable instruction by the electronic processor in accordance with the sixth program code.

In another variation of this embodiment, the file identifying information can be disposed in a table file. In this variation, the computer program code can further comprise a seventh program code. The seventh program code causes the electronic processor to convert the table file to a spreadsheet file. This can be done so that the file identifying information can be attached in a spreadsheet form to the fourth e-mail message.

In yet another variation of this embodiment, the second machine-readable retrieval criterion can be data representative of the name of the file, the name of the file including the unique identifier for the file, and at least one of a category associated with the file, a type of the file, a classification of the file, a size of the file, a date of an edit made to the file, an indication of a time when the file is to be retrieved, an identity of an individual who is to receive the file, other retrieval criteria, or any combination of the foregoing. In this variation, the sixth program code can further comprise a seventh program code, an eighth program code, and a ninth program code. The seventh program code causes the electronic processor to find the second machine-readable retrieval criterion in a first table. The eighth program code causes the electronic processor to use the second machine-readable retrieval criterion to produce the file identifying information. The ninth program code causes the electronic processor to include the file identifying information in the header or the body of the fourth e-mail message or as an attachment of the fourth e-mail message.

In an option of this variation, the seventh program code can cause the electronic processor to find a match that is exact to the second machine-readable retrieval criterion.

In another option of this variation, the seventh program code can cause the electronic processor to find a match that is similar to the second machine-readable retrieval criterion.

In yet another option of this variation, the seventh program code can further comprise a tenth program code and an eleventh program code. The tenth program code causes the electronic processor to parse a field of the first table having a plurality of information to define a set of the information. The eleventh program code causes the electronic processor to search the set of the information to find an object of the set of the information that matches the second machine-readable retrieval criterion.

In still another option of this variant, the eighth program code can cause the electronic processor to produce a second table. The second table is a subset of the first table. The subset includes at least one record from the first table having a field that includes the second machine-readable retrieval criterion. Alternatively, the second table can be all of the first table.

### Local Station

System

In an embodiment, local station 2102 comprises a local packet switched network interface 2140, a local electronic processor 2142, an a user interface 2144. Local packet switched network interface 2140 is configured to transmit first e-mail message 2112 to remote electronic processor 2134 via packet switched network 2106 and to receive second e-mail message 2118 from packet switched network 2106. Local electronic processor 2142 is configured to include first machine-readable instruction 2114 and first machine-readable retrieval criterion 2116 in first e-mail message 2112. First machine-readable instruction 2114 is configured to be executed by remote electronic processor 2134 to transmit second e-mail message 2118 including file 2108 as an attachment of second e-mail message 2118. User interface 2144 is configured to convey first machine-readable instruction 2114 and first machine-readable retrieval criterion 2116 to local electronic processor 2142.

For example, local electronic processor 2142 can comprise, but is not limited to, a commercially available microprocessor such as an ARM® processor, a Pentium® processor, an Intel386™ processor, an Athlon™ processor, a PowerPC™ processor, or other commercially available processors. Alternatively, for example, local electronic processor 2142 can comprise an application-specific integrated circuit processor or a field-programmable gate array processor. Additionally, local electronic processor 2142 can comprise any combination of the foregoing.

For example, local electronic processor 2142 can be disposed in, but is not limited to, a server computer, a workstation computer, a personal computer, a laptop computer, a personal digital assistant, a wireless handheld device, or a smartphone. Local electronic processor 2142 can also be disposed in other devices.

For example, local electronic processor 2142 can be configured to operate with Microsoft® Windows®, Apple® Mac OS®, Unix® Operating System, Linux® Operating System, or other operating systems.

In an embodiment, local electronic processor 2142 is further configured to cause first machine-readable instruction 2114, first machine-readable retrieval criterion 2116, or both to be disposed in a spreadsheet file. This can be done so that the spreadsheet file can be attached to first e-mail message 2112.

In an embodiment, the present invention recognizes that a user may, in order to retrieve file 2108 from remote machine-readable data storage device 2110, need to retrieve information that will assist the user in identifying file 2108. In this embodiment, local packet switched network interface 2140 is further configured to transmit third e-mail message 2120 to remote electronic processor 2134 via packet switched network 2106 and to receive fourth e-mail message 2126 from packet switched network 2106. Local electronic processor 2142 is further configured to include second machine-readable instruction 2122 and second machine-readable retrieval criterion 2124 in third e-mail message 2120. Second machine-readable instruction 2122 is configured to be executed by remote electronic processor 2134 to transmit fourth e-mail message 2126. Fourth e-mail message 2126 includes, in the header or the body of fourth e-mail message 2126 or as an attachment of fourth e-mail message 2126, file identifying information 2128. User interface 2144 is further configured to convey second machine-readable instruction 2122 and second machine-readable retrieval criterion 2124 to local electronic processor 2142.

In a variation of this embodiment, local electronic processor 2142 is further configured to cause second machine-readable instruction 2122, second machine-readable retrieval criterion 2124, or both to be disposed in a spreadsheet file. This can be done so that the spreadsheet file can be attached to third e-mail message 2120.

In another variation of this embodiment, file identifying information 2128 can be disposed in a spreadsheet file. In this variation, local electronic processor 2142 is further configured to convert the spreadsheet file to a table file upon receipt of fourth e-mail message 2126. This can be done so that file identifying information 2128 can be presented to the user in a more user-friendly manner.

### Method

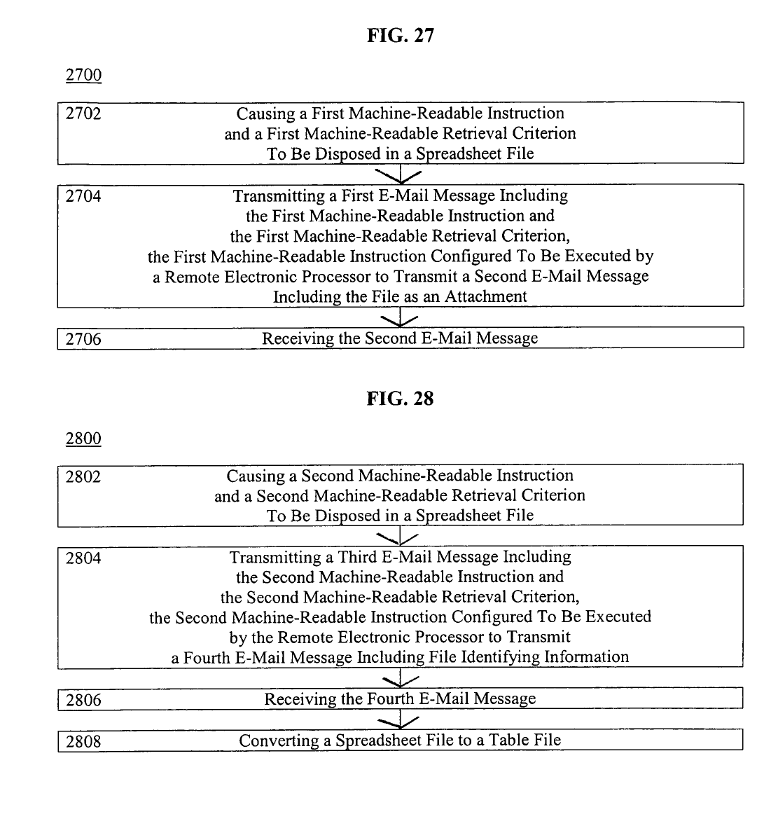

In another embodiment the present invention can be implemented as a method for retrieving a file from a remote machine-readable data storage device. For example, FIG. 27 illustrates a flow chart of an embodiment of a method 2700 for retrieving a file from a remote machine-readable data storage device. In method 2700, optionally at a step 2702, a first machine-readable instruction, a first machine-readable retrieval criterion, or both can be caused to be disposed in a spreadsheet file. This can be done so that the spreadsheet file can be attached to a first e-mail message. At a step 2704, the first e-mail message is transmitted, from a local electronic processor, to a remote electronic processor via a packet switched network. The first e-mail message includes a first machine-readable instruction and a first machine-readable retrieval criterion. The first machine-readable instruction is configured to be executed by the remote electronic processor to transmit a second e-mail message including the file as an attachment of the second e-mail message. At a step 2706, the second e-mail message is received, at the local electronic processor, from the packet switched network.

For example, the electronic processor can comprise, but is not limited to, a commercially available microprocessor such as an ARM® processor, a Pentium® processor, an Intel386™ processor, an Athlon™ processor, a PowerPC™ processor, or other commercially available processors. Alternatively, for example, the electronic processor can comprise an application-specific integrated circuit processor or a field-programmable gate array processor. Additionally, the electronic processor can comprise any combination of the foregoing.

For example, the electronic processor can be disposed in, but is not limited to, a server computer, a workstation computer, a personal computer, a laptop computer, a personal digital assistant, a wireless handheld device, or a smartphone. The electronic processor can also be disposed in other devices.

For example, the electronic processor can be configured to operate with Microsoft®Windows®, Apple® Mac OS®, Unix® Operating System, Linux® Operating System, or other operating systems.

In an embodiment, the present invention recognizes that a user may, in order to retrieve the file from the remote machine-readable data storage device, need to retrieve information that will assist the user in identifying the file. In this embodiment, additional steps can be performed to retrieve file identifying information. For example, FIG. 28 illustrates a flow chart of an embodiment of a method 2800 for retrieving file identifying information. In method 2800, optionally at a step 2802, a second machine-readable instruction, a second machine-readable retrieval criterion, or both can be caused to be disposed in a spreadsheet file. This can be done so that the spreadsheet file can be attached to a third e-mail message. At a step 2804, the third e-mail message is transmitted, from the local electronic processor, to the remote electronic processor via the packet switched network. The third e-mail message includes a second machine-readable instruction and a second machine-readable retrieval criterion. The second machine-readable instruction is configured to be executed by the remote electronic processor to transmit a fourth e-mail message including, in the header or the body of the fourth e-mail message or as an attachment of the fourth e-mail message, file identifying information. At a step 2806, the fourth e-mail message is received, at the local electronic processor, from the packet switched network. Optionally, at a step 2808, if the file identifying information is disposed in a spreadsheet file, the spreadsheet file can be converted, at the electronic processor, to a table file upon receipt of the fourth e-mail message. This can be done so that the file identifying information can be presented to the user in a more user-friendly manner.

### Computer Program Product

In another embodiment, the present invention can be implemented as a computer-readable storage medium having stored thereon a computer program code for retrieving a file from a remote machine-readable data storage device. The computer program code comprises a first program code and a second program code. The first program code causes a local electronic processor to transmit a first e-mail message to a remote electronic processor via a packet switched network. The first e-mail message includes a first machine-readable instruction and a first machine-readable retrieval criterion. The first machine-readable instruction is configured to be executed by the remote electronic processor to transmit a second e-mail message including the file as an attachment of the second e-mail message. The second program code causes the local electronic processor to receive the second e-mail message from the packet switched network.

For example, the electronic processor can comprise, but is not limited to, a commercially available microprocessor such as an ARM® processor, a Pentium® processor, an Intel386™ processor, an Athlon™ processor, a PowerPC™ processor, or other commercially available processors. Alternatively, for example, the electronic processor can comprise an application-specific integrated circuit processor or a field-programmable gate array processor. Additionally, the electronic processor can comprise any combination of the foregoing.

For example, the electronic processor can be disposed in, but is not limited to, a server computer, a workstation computer, a personal computer, a laptop computer, a personal digital assistant, a wireless handheld device, or a smartphone. The electronic processor can also be disposed in other devices.

For example, the electronic processor can be configured to operate with Microsoft®Windows®, Apple® Mac OS®, Unix® Operating System, Linux® Operating System, or other operating systems.

In an embodiment, the computer program code can further comprise a third program code. The third program code causes the local electronic processor to cause the first machine-readable instruction, the first machine-readable retrieval criterion, or both to be disposed in a spreadsheet file. This can be done so that the spreadsheet file can be attached to the first e-mail message.

The following example code shows how each file attached to a corresponding received second e-mail message can be automatically stored at the local station. In this example, the program code parses the header of the received second e-mail message and determines that the file is to be automatically stored:

′ This case adds a shell for each attachment to the client's
′ shellset and saves each attachment into the client's file
′ directory.
Case “Sent” ′ “Sent” in Subject of Email

With Item

.Attachments(2).SaveAsFile “c:\sand\alpha.xls”
DoCmd.SetWarnings False
strSQLDELETE = “DELETE * FROM tblLast”
DoCmd.RunSQL strSQLDELETE
DoCmd.Close acForm, “frmMaster”
DoCmd.OpenForm “frmMaster”, acNormal, , , , _{—}

acWindowNormal

DoCmd.TransferSpreadsheet acImport, _{—}

acSpreadsheetTypeExcel9, “tblLast”, _{—}
“C:\sand\alpha.xls”, True

DoCmd.Close acTable, “tblLast”
DoCmd.OpenTable “tblLast”
strSQL = “INSERT INTO tblMaster SELECT Item, Brand, _{—}

FDate, MailSender, MailReceiver, FType, _{—}
FSize, Lodestar From tblLast;”

DoCmd.RunSQL strSQL
DoCmd.Close acForm, “frmMaster”
DoCmd.OpenForm “frmMaster”, acNormal, , , , _{—}

acWindowNormal

DoCmd.GoToRecord , , acFirst
Forms(“frmMaster”)!Check = “Loaded”
′VarJW1 = Forms(“frmMaster”)!ID
′VarJW2 = Forms(“frmMaster”)!FType
VarJW10 = Forms(“frmMaster”)!Lodestar
′ Forms(“frmMaster”)!Lodestar.SetFocus
′ Forms(“frmMaster”)!Lodestar = VarJW10
.Attachments(1).SaveAsFile (VarJW10)
DoCmd.Close acForm, “frmMaster”
DoCmd.OpenForm “frmMaster”, acNormal, , , , _{—}

acWindowNormal

Forms(“frmMaster”)!ID.SetFocus

End With

In an embodiment, the present invention recognizes that a user may, in order to retrieve the file from the remote machine-readable data storage device, need to retrieve information that will assist the user in identifying the file. In this embodiment, the computer program code can further comprise a third program code and a fourth program code. The third program code causes the local electronic processor to transmit a third e-mail message to the remote electronic processor via the packet switched network. The third e-mail message includes a second machine-readable instruction and a second machine-readable retrieval criterion. The second machine-readable instruction is configured to be executed by the remote electronic processor to transmit a fourth e-mail message including, in the header or the body of the fourth e-mail message or as an attachment of the fourth e-mail message, file identifying information. The fourth program code causes the local electronic processor to receive the fourth e-mail message from the packet switched network.

In a variation of this embodiment, the computer program code can further comprise a fifth program code. The fifth program code causes the local electronic processor to cause the second machine-readable instruction, the second machine-readable retrieval criterion, or both to be disposed in a spreadsheet file. This can be done so that the spreadsheet file can be attached to the third e-mail message.

In another variation of this embodiment, the file identifying information can be disposed in a spreadsheet file. In this variation, the computer program code can further comprise a fifth program code. The fifth program code causes the local electronic processor to convert the spreadsheet file to a table file upon receipt of the fourth e-mail message. This can be done so that the file identifying information can be presented to the user in a more user-friendly manner.

The following example code shows how the local electronic processor can convert a spreadsheet file to a table file for presentation of file identifying information in a user-friendly manner:

′ The “xtempsx” case value is used to append incoming shells to
′ the client's Master Table, so that they can then use them (with
′ check marks) to retrieve actual records.

Case “xtempx” ′ “xtempx” in Subject of Email

With Item

.Attachments(1).SaveAsFile “c:\sand\alpha.xls”
DoCmd.SetWarnings False
strSQLDELETE = “DELETE * FROM tblLast”
DoCmd.RunSQL strSQLDELETE
DoCmd.Close acForm, “frmMaster”
DoCmd.OpenForm “frmMaster”, acNormal, , , _{—}

, acWindowNormal

DoCmd.TransferSpreadsheet acImport, _{—}

acSpreadsheetTypeExcel9, “tblLast”, _{—}
“C:\sand\alpha.xls”, True

DoCmd.Close acTable, “tblLast”
DoCmd.OpenTable “tblLast”
strSQL = “INSERT INTO tblMaster SELECT _{—}

Item, Brand, FDate, MailSender, _{—}
MailReceiver, FType, FSize, _{—}
Lodestar From tblLast;”

DoCmd.RunSQL strSQL
DoCmd.Close acForm, “frmMaster”
DoCmd.OpenForm “frmMaster”, acNormal, , , , _{—}

acWindowNormal

Forms(“frmMaster”)!ID.SetFocus

End With

### Example Computer System

In one embodiment, the invention is directed toward one or more computer systems capable of carrying out the functionality described herein. An example of a computer system 2900 is shown in FIG. 29.

The computer system 2900 includes one or more processors, such as processor 2904. The processor 2904 is connected to a communication infrastructure 2906 (e.g., a communications bus, cross over bar, or network). Various software embodiments are described in terms of this exemplary computer system. After reading this description, it will become apparent to a person skilled in the relevant art(s) how to implement the invention using other computer systems and/or architectures.

Computer system 2900 can include a display interface 2902 that forwards graphics, text, and other data from the communication infrastructure 2906 (or from a frame buffer not shown) for display on the display unit 2930.

Computer system 2900 also includes a main memory 2908, preferably random access memory (RAM), and can also include a secondary memory 2910. The secondary memory 2910 can include, for example, a hard disk drive 2912 and/or a removable storage drive 2914, representing a floppy disk drive, a magnetic tape drive, an optical disk drive, etc. The removable storage drive 2914 reads from and/or writes to a removable storage unit 2918 in a well known manner. Removable storage unit 2918 represents a floppy disk, magnetic tape, optical disk, etc. which is read by and written to by removable storage drive 2914. As will be appreciated, the removable storage unit 2918 includes a computer usable storage medium having stored therein computer software and/or data.

In alternative embodiments, secondary memory 2910 can include other similar devices for allowing computer programs or other instructions to be loaded into computer system 2900. Such devices can include, for example, a removable storage unit 2918 and an interface 2920. Examples of such can include a program cartridge and cartridge interface (such as that found in video game devices), a removable memory chip (such as an erasable programmable read only memory (EPROM), or programmable read only memory (PROM)) and associated socket, and other removable storage units 2918 and interfaces 2920, which allow software and data to be transferred from the removable storage unit 2918 to computer system 2900.

Computer system 2900 can also include a communications interface 2924. Communications interface 2924 allows software and data to be transferred between computer system 2900 and external devices. Examples of communications interface 2924 can include a modem, a network interface (such as an Ethernet card), a communications port, a Personal Computer Memory Card International Association (PCMCIA) slot and card, etc. Software and data transferred via communications interface 2924 are in the form of signals 2928 which can be electronic, electromagnetic, optical or other signals capable of being received by communications interface 2924. These signals 2928 are provided to communications interface 2924 via a communications path (e.g., channel) 2926. This channel 2926 carries signals 2928 and can be implemented using wire or cable, fiber optics, a telephone line, a cellular link, a radio frequency (RF) link and other communications channels.

In this document, the terms “computer program medium” and “computer usable medium” are used to generally refer to media such as removable storage drive 2914, a hard disk installed in hard disk drive 2912, and signals 2928. These computer program products provide software to computer system 2900. The invention is directed to such computer program products.

Computer programs (also referred to as computer control logic) are stored in main memory 2908 and/or secondary memory 2910. Computer programs can also be received via communications interface 2924. Such computer programs, when executed, enable the computer system 2900 to perform the features of the present invention, as discussed herein. In particular, the computer programs, when executed, enable the processor 2904 to perform the features of the present invention. Accordingly, such computer programs represent controllers of the computer system 2900.

In an embodiment where the invention is implemented using software, the software can be stored in a computer program product and loaded into computer system 2900 using removable storage drive 2914, hard drive 2912 or communications interface 2924. The control logic (software), when executed by the processor 2904, causes the processor 2904 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### CONCLUSION

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A computer-readable storage medium, having stored thereon a computer program code for retrieving a file from a remote machine-readable data storage device, the computer program code comprising:
a first program code for causing an electronic processor to receive a first e-mail message from a packet switched network;
a second program code for causing the electronic processor to parse the first e-mail message to determine if the first e-mail message includes a first machine-readable instruction and a first machine-readable retrieval criterion; and
a third program code for causing the electronic processor to execute the first machine-readable instruction to transmit a second e-mail message to the packet switched network, the second e-mail message including the file as an attachment of the second e-mail message, the file including machine-readable data representative of at least one of a visual product stored in a tangible medium and an audio product stored in the tangible medium.

2. The computer-readable storage medium of claim 1, wherein the remote machine-readable data storage device comprises at least one of an electronic data storage device, a magnetic data storage device, and an optical data storage device.

3. The computer-readable storage medium of claim 1, wherein the electronic processor comprises at least one of an ARM® processor, a Pentium® processor, an Intel386™ processor, an Athlon™ processor, and a PowerPC™ processor.

4. The computer-readable storage medium of claim 1, wherein the electronic processor comprises at least one of an application-specific integrated circuit processor and a field-programmable gate array processor.

5. The computer-readable storage medium of claim 1, wherein the electronic processor is disposed in one of a server computer, a workstation computer, a personal computer, a laptop computer, a personal digital assistant, a wireless handheld device, and a smartphone.

6. The computer-readable storage medium of claim 1, wherein at least one of the first e-mail message and the second e-mail message is accessed via at least one of Microsoft® Outlook®, Mozilla® Thunderbird™, Apple® Mail, Qualcomm® Eudora®, Novell® GroupWise®, IBM® Lotus Notes®, Microsoft® Entourage®, Netscape® Messenger®, Google™ Gmail™, Yahoo!® Mail, Microsoft® Windows Live™ Hotmail™, and AOL® Mail.

7. The computer-readable storage medium of claim 1, wherein the packet switched network comprises at least one of the Internet, the World Wide Web, an intranet, a wide area network, and a local area network.

8. The computer-readable storage medium of claim 1, wherein at least one of the first machine-readable instruction and the first machine-readable retrieval criterion is disposed in at least one of a body of the first e-mail message, a header of the first e-mail message, and an attachment of the first e-mail message.

9. The computer-readable storage medium of claim 1, wherein the at least one of the visual product stored in the tangible medium and the audio product stored in the tangible medium comprises at least one of an audio recording, a still picture, and a moving picture.

10. The computer-readable storage medium of claim 1, wherein the at least one of the visual product stored in the tangible medium and the audio product stored in the tangible medium comprises at least one of a word processing file, a spreadsheet file, a presentation program file, and an e-mail message file.

11. The computer-readable storage medium of claim 1, wherein at least one of the first machine-readable instruction and the first machine-readable retrieval criterion is disposed in a spreadsheet file attached to the first e-mail message and further comprising:
a fourth program code for causing the electronic processor to convert the spreadsheet file to a table file upon receipt of the first e-mail message.

12. The computer-readable storage medium of claim 1, wherein the file is a plurality of files.

13. The computer-readable storage medium of claim 12, wherein the second e-mail message is a plurality of second e-mail messages, each one of the plurality of second e-mail messages associated with a corresponding one of the plurality of files, the one of the plurality of second e-mail messages including the corresponding one of the plurality of files as an attachment of the one of the plurality of second e-mail messages.

14. The computer-readable storage medium of claim 1, wherein the first machine-readable retrieval criterion comprises data representative of a name of the file, the name of the file including a unique identifier for the file, and the third program code further comprises:
a fourth program code for causing the electronic processor to find the first machine-readable retrieval criterion in a table that cross-references the first machine-readable retrieval criterion with at least one of a path to the file and a hyperlink to the file;
a fifth program code for causing the electronic processor to use the at least one of the path to the file and the hyperlink to the file to retrieve the file from the remote machine-readable data storage device; and
a sixth program code for causing the electronic processor to attach the file to the second e-mail message.

15. The computer-readable storage medium of claim 1, further comprising:
a fourth program code for causing the electronic processor to receive a third e-mail message from the packet switched network;
a fifth program code for causing the electronic processor to parse the third e-mail message to determine if the third e-mail message includes a second machine-readable instruction and a second machine-readable retrieval criterion; and
a sixth program code for causing the electronic processor to execute the second machine-readable instruction to transmit a fourth e-mail message to the packet switched network, the fourth e-mail message including, in at least one of a body of the fourth e-mail message and an attachment of the fourth e-mail message, file identifying information.

16. The computer-readable storage medium of claim 15, wherein at least one of the second machine-readable instruction and the second machine-readable retrieval criterion is disposed in a spreadsheet file attached to the third e-mail message and further comprising:
a seventh program code for causing the electronic processor to convert the spreadsheet file to a table file upon receipt of the third e-mail message.

17. The computer-readable storage medium of claim 15, wherein the file identifying information is disposed in a table file and further comprising:
a seventh program code for causing the electronic processor to convert the table file to a spreadsheet file.

18. The computer-readable storage medium of claim 15, wherein the second machine-readable retrieval criterion comprises data representative of the name of the file, the name of the file including the unique identifier for the file, and at least one of a category associated with the file, a type of the file, a classification of the file, a size of the file, a date of an edit made to the file, an indication of a time when the file is to be retrieved, and an identity of an individual who is to receive the file, the sixth program code further comprising:
a seventh program code for causing the electronic processor to find the second machine-readable retrieval criterion in a first table;
an eighth program code for causing the electronic processor to use the second machine-readable retrieval criterion to produce the file identifying information; and
a ninth program code for causing the electronic processor to include, in at least one of the body of the fourth e-mail message and the attachment of the fourth e-mail message, the file identifying information.

19. The computer-readable storage medium of claim 18, wherein the seventh program code is configured to cause the electronic processor to find a match that is exact to the second machine-readable retrieval criterion.

20. The computer-readable storage medium of claim 18, wherein the seventh program code is configured to cause the electronic processor to find a match that is similar to the second machine-readable retrieval criterion.

21. The computer-readable storage medium of claim 18, wherein the seventh program code further comprises:
a tenth program code for causing the electronic processor to parse a field of the first table having a plurality of information to define a set of the information; and
an eleventh program code for causing the electronic processor to search the set of the information to find an object of the set of the information that matches the second machine-readable retrieval criterion.

22. The computer-readable storage medium of claim 18, wherein the eighth program code is configured to cause the electronic processor to use the second machine-readable retrieval criterion to produce a second table, the second table being a subset of the first table, the subset including at least one record from the first table having a field that includes the second machine-readable retrieval criterion.

23. A computer-readable storage medium, having stored thereon a computer program code for retrieving a file from a remote machine-readable data storage device, the computer program code comprising:
a first program code for causing a local electronic processor to transmit a first e-mail message to a remote electronic processor via a packet switched network, the first e-mail message including a first machine-readable instruction and a first machine-readable retrieval criterion, the first machine-readable instruction configured to be executed by the remote electronic processor to transmit a second e-mail message including the file as an attachment of the second e-mail message, the file including machine-readable data representative of at least one of a visual product stored in a tangible medium and an audio product stored in the tangible medium; and
a second program code for causing the local electronic processor to receive the second e-mail message from the packet switched network.

24. The computer-readable storage medium of claim 23, wherein the local electronic processor comprises at least one of an ARM® processor, a Pentium® processor, an Intel386™ processor, an Athlon™ processor, and a PowerPC™ processor.

25. The computer-readable storage medium of claim 23, wherein the local electronic processor comprises at least one of an application-specific integrated circuit processor and a field-programmable gate array processor.

26. The computer-readable storage medium of claim 23, wherein the local electronic processor is disposed in one of a server computer, a workstation computer, a personal computer, a laptop computer, a personal digital assistant, a wireless handheld device, and a smartphone.

27. The computer-readable storage medium of claim 23, further comprising:
a third program code for causing the local electronic processor to cause at least one of the first machine-readable instruction and the first machine-readable retrieval criterion to be disposed in a spreadsheet file.

28. The computer-readable storage medium of claim 23, further comprising:
a third program code for causing the local electronic processor to transmit a third e-mail message to the remote electronic processor via the packet switched network, the third e-mail message including a second machine-readable instruction and a second machine-readable retrieval criterion, the second machine-readable instruction configured to be executed by the remote electronic processor to transmit a fourth e-mail message including, in at least one of a header of the fourth e-mail message, a body of the fourth e-mail message, and an attachment of the fourth e-mail message, file identifying information; and
a fourth program code for causing the local electronic processor to receive the fourth e-mail message from the packet switched network.

29. The computer-readable storage medium of claim 28, further comprising:
a fifth program code for causing the local electronic processor to cause at least one of the second machine-readable instruction and the second machine-readable retrieval criterion to be disposed in a spreadsheet file.

30. The computer-readable storage medium of claim 28, wherein the file identifying information is disposed in a spreadsheet file and further comprising:
a fifth program code for causing the local electronic processor to convert the spreadsheet file to a table file upon receipt of the fourth e-mail message.

31. A method for retrieving a file from a remote machine-readable data storage device, comprising:
receiving, at an electronic processor, a first e-mail message from a packet switched network;
parsing, at the electronic processor, the first e-mail message to determine if the first e-mail message includes a first machine-readable instruction and a first machine-readable retrieval criterion; and
executing, at the electronic processor, the first machine-readable instruction to transmit a second e-mail message to the packet switched network, the second e-mail message including the file as an attachment of the second e-mail message, the file including machine-readable data representative of at least one of a visual product stored in a tangible medium and an audio product stored in the tangible medium.

32. A method for retrieving a file from a remote machine-readable data storage device, comprising:
transmitting, from a local electronic processor, a first e-mail message to a remote electronic processor via a packet switched network, the first e-mail message including a first machine-readable instruction and a first machine-readable retrieval criterion, the first machine-readable instruction configured to be executed by the remote electronic processor to transmit a second e-mail message including the file as an attachment of the second e-mail message, the file including machine-readable data representative of at least one of a visual product stored in a tangible medium and an audio product stored in the tangible medium; and
receiving, at the local electronic processor, the second e-mail message from the packet switched network.

33. A system for retrieving a file from a remote machine-readable data storage device, comprising:
a packet switched network interface configured to receive a first e-mail message from a packet switched network and to transmit a second e-mail message to the packet switched network;
a filter configured to parse the first e-mail message to determine if the first e-mail message includes a first machine-readable instruction and a first machine-readable retrieval criterion;
an electronic processor configured to execute the first machine-readable instruction to cause the packet switched network interface to transmit the second e-mail message, the second e-mail message including the file as an attachment of the second e-mail message, the file including machine-readable data representative of at least one of a visual product stored in a tangible medium and an audio product stored in the tangible medium.

34. A system for retrieving a file from a remote machine-readable data storage device, comprising:
a packet switched network interface configured to transmit a first e-mail message to a remote electronic processor via a packet switched network and to receive a second e-mail message from the packet switched network;
a local electronic processor configured to include a first machine-readable instruction and a first machine-readable retrieval criterion in the first e-mail message, the first machine-readable instruction configured to be executed by the remote electronic processor to transmit a second e-mail message including the file as an attachment of the second e-mail message, the file including machine-readable data representative of at least one of a visual product stored in a tangible medium and an audio product stored in the tangible medium; and
a user interface configured to convey the first machine-readable instruction and the first machine-readable retrieval criterion to the local electronic processor.
